(19) United States
(12) Patent Application Publication
(10) Pub. No.: US 2025/0321450 A1
(43) Pub. Date: Oct. 16, 2025

(54) OPTICALLY-ANISOTROPIC LAYER, LAMINATE, LIGHT GUIDE ELEMENT, AND AR DISPLAY DEVICE

(71) Applicant: FUJIFILM Corporation, Tokyo (JP)

(72) Inventors: Keisuke KODAMA, Minamiashigara-shi (JP); Keisuke NAKANISHI, Minamiashigara-shi (JP); Masaaki SUZUKI, Minamiashigara-shi (JP); Hiroshi SATO, Minamiashigara-shi (JP)

(73) Assignee: FUJIFILM Corporation, Tokyo (JP)

(21) Appl. No.: 19/245,462

(22) Filed: Jun. 23, 2025

Related U.S. Application Data
(63) Continuation of application No. PCT/JP2023/046614, filed on Dec. 26, 2023.

(30) Foreign Application Priority Data
Dec. 28, 2022 (JP) 2022-212211
Feb. 8, 2023 (JP) 2023-017765
Jun. 28, 2023 (JP) 2023-105863
Sep. 26, 2023 (JP) 2023-163998
Dec. 1, 2023 (JP) 2023-203912
Dec. 11, 2023 (JP) 2023-208791

(51) Int. Cl. G02F 1/1337; G02B 27/01; G02B 27/28; G02F 1/1335

(52) U.S. Cl. CPC G02F 1/133769; G02B 27/0172; G02B 27/286; G02F 1/133543; G02F 1/133746

(57) ABSTRACT

An optically-anisotropic layer that is an optically-anisotropic layer formed of a composition containing a liquid crystal compound, the optically-anisotropic layer including a region A having a liquid crystal alignment pattern in which an orientation of an optical axis derived from the liquid crystal compound changes while continuously rotating in at least one in-plane direction, a region B having a liquid crystal alignment pattern in which an orientation of an optical axis derived from the liquid crystal compound changes while continuously rotating in at least one in-plane direction, and a region not having the liquid crystal alignment pattern, in which the region A, the region B, and the region not having the liquid crystal alignment pattern are provided in the same in-plane direction of the optically-anisotropic layer.

### CROSS-REFERENCE TO RELATED APPLICATIONS

This application is a Continuation of PCT International Application No. PCT/JP2023/046614, filed on Dec. 26, 2023, which claims priority under 35 U.S.C. § 119(a) to Japanese Patent Application No. 2022-212211, filed on Dec. 28, 2022, Japanese Patent Application No. 2023-017765, filed on Feb. 8, 2023, Japanese Patent Application No. 2023-105863, filed on Jun. 28, 2023, Japanese Patent Application No. 2023-163998, filed on Sep. 26, 2023, Japanese Patent Application No. 2023-203912, filed on Dec. 1, 2023, and Japanese Patent Application No. 2023-208791, filed on Dec. 11, 2023. The above applications are hereby expressly incorporated by reference, in their entirety, into the present application.

### BACKGROUND OF THE INVENTION

### 1. Field of the Invention

The present invention relates to an optically-anisotropic layer which diffracts incident light, a laminate, a light guide element using the optically-anisotropic layer, and an AR display device.

### 2. Description of the Related Art

In recent years, as described in Bernard C. Kress et al., Towards the Ultimate Mixed Reality Experience: HoloLens Display Architecture Choices, SID 2017 DIGEST, pp. 127-131, augmented reality (AR) glasses which display a virtual image, various information, or the like to be superimposed on a scene which is actually being seen have been put into practice. The AR glasses are also referred to as, for example, smart glasses or a head mounted display (HMD).

As described in Bernard C. Kress et al., Towards the Ultimate Mixed Reality Experience: HoloLens Display Architecture Choices, SID 2017 DIGEST, pp. 127-131, in the AR glasses, for example, an image displayed by a display (optical engine) is incident into one end of a light guide plate, propagates in the light guide plate, and is emitted from the other end of the light guide plate such that a virtual image is displayed to be superimposed on a scene that a user actually sees. In the AR glasses, light (projection light) projected from the display is diffracted (refracted) using a diffraction element to be incident into one end part of the light guide plate. As a result, the light is introduced into the light guide plate with an angle and propagates up to the other end part of the light guide plate while being reflected from an interface (surface) of the light guide plate. The light propagated in the light guide plate is also diffracted by the diffraction element in the other end part of the light guide plate, and is emitted from the light guide plate to an observation position by the user.

As such a diffraction element, a diffraction grating formed of liquid crystal has been known. For example, JP2017-522601A discloses an optical element including a plurality of stacked birefringent sublayers configured to alter a direction of propagation of light transmitting therethrough according to a Bragg condition, in which the stacked birefringent sublayers respectively comprise local optical axes that vary along respective interfaces between adjacent ones of the stacked birefringent sublayers to define respective grating periods. The optical element disclosed in JP2017-522601A diffracts transmitted light. JP2017-522601A discloses that light incident into a substrate (light guide plate) is diffracted by an optical element such that the light is incident at an angle at which the light is totally reflected in the substrate and is guided in a direction substantially perpendicular to an incidence direction of the light in the substrate (refer to FIG. 8 of JP2017-522601A).

JP5276847B discloses a polarization diffraction grating including: a polarization sensitive photo-alignment layer; and at least first and second liquid crystal compositions which include a polymerizable mesogen and are arranged on the photo-alignment layer, in which an anisotropic alignment pattern corresponding to a polarization hologram is arranged in the photo-alignment layer, the first liquid crystal composition is arranged on and aligned by the alignment layer and at least partly polymerized, the second liquid crystal composition is arranged on and aligned by the first liquid crystal composition, and both the first and second liquid crystal compositions have a thickness d of a layer, determined by an expression of d≤dmax=Λ/2, where d represents the thickness of the layer and Λ represents a pitch of the polarization diffraction grating.

WO2016/194961A discloses a reflective structure including: a plurality of helical structures each extending in a predetermined direction; a first incident surface which intersects the predetermined direction and into which light is incident; and a reflecting surface which intersects the predetermined direction and reflects the light incident from the first incident surface, in which the first incident surface includes one of end parts in each of the plurality of helical structures, each of the plurality of helical structures includes a plurality of structural units which lie in the predetermined direction, each of the plurality of structural units includes a plurality of elements which are helically turned and stacked, each of the plurality of structural units includes a first end part and a second end part, the second end part of one structural unit among structural units adjacent to each other in the predetermined direction forms the first end part of the other structural unit, alignment directions of the elements positioned in the plurality of first end parts included in the plurality of helical structures are aligned, the reflecting surface includes at least one first end part included in each of the plurality of helical structures, and the reflecting surface is not parallel to the first incident surface.

Here, in the AR glasses, in a case where the light propagated in the light guide plate is diffracted by the diffraction element after adjusting a diffraction efficiency of the diffraction element, it has been known that a viewing zone is expanded (exit pupil expansion) with a configuration in which a part of the light is diffracted at a plurality of positions to be emitted to the outside of the light guide plate.

For example, WO2017/180403A discloses an optical waveguide including an input-coupler (diffraction element) which couples light corresponding to an image having a corresponding field of view (FOV) into the optical waveguide, splits the FOV of the image coupled into the optical waveguide into first and second portions, and diffracts a portion of the light corresponding to the image in a second direction toward a second-intermediate component; and an intermediate coupler (diffraction element) and an output-coupler (diffraction element) performs exit pupil expansion.

### SUMMARY OF THE INVENTION

In a case where a liquid crystal diffraction element is used as the diffraction element of the light guide element used in the AR glasses, for the purpose of expanding the viewing zone (exit pupil expansion) of the AR glasses, the liquid crystal diffraction element diffracts a part of light at a plurality of positions to be emitted to the outside of the light guide plate, and thus there is a problem that clearness of the image is not sufficient.

An object of the present invention is to solve the above-described problems of the related art, and to provide an optically-anisotropic layer which can emit light having high clearness from a light guide plate, a laminate, a light guide element using the optically-anisotropic layer, and an AR display device.
[1] An optically-anisotropic layer formed of a composition containing a liquid crystal compound, the optically-anisotropic layer comprising:
a region A having a liquid crystal alignment pattern in which an orientation of an optical axis derived from the liquid crystal compound changes while continuously rotating in at least one in-plane direction;
a region B having a liquid crystal alignment pattern in which an orientation of an optical axis derived from the liquid crystal compound changes while continuously rotating in at least one in-plane direction; and
a region not having the liquid crystal alignment pattern,
in which the region A, the region B, and the region not having the liquid crystal alignment pattern are provided in the same in-plane direction of the optically-anisotropic layer.
[2] The optically-anisotropic layer according to [1], further comprising:
a region C having a liquid crystal alignment pattern in which an orientation of an optical axis derived from the liquid crystal compound changes while continuously rotating in at least one in-plane direction,
in which the region C is also provided in the same in-plane direction of the optically-anisotropic layer.
[3] The optically-anisotropic layer according to [1] or [2],
in which the region not having the liquid crystal alignment pattern is provided between the region A having the liquid crystal alignment pattern and the region B having the liquid crystal alignment pattern, in the same in-plane direction of the optically-anisotropic layer.
[4] The optically-anisotropic layer according to any one of [1] to [3],
in which at least one region of the region A or the region B has a region in which a diffraction efficiency varies in the in-plane direction.
[5] The optically-anisotropic layer according to [4],
in which at least one region of the region A or the region B has a region in which a diffraction efficiency gradually increases in the in-plane direction.
[6] The optically-anisotropic layer according to any one of [1] to [5],
in which a rotation direction of the optical axis derived from the liquid crystal compound in the one direction of the liquid crystal alignment pattern in the region A is different from a rotation direction of the optical axis derived from the liquid crystal compound in the one direction of the liquid crystal alignment pattern in the region B.
[7] The optically-anisotropic layer according to any one of [1] to [6],
in which the one direction of the liquid crystal alignment pattern in the region A is different from the one direction of the liquid crystal alignment pattern in the region B.
[8] The optically-anisotropic layer according to any one of [1] to [7],
in which a length over which the orientation of the optical axis derived from the liquid crystal compound rotates by 180° in a plane of the liquid crystal alignment pattern in the region A is different from a length over which the orientation of the optical axis derived from the liquid crystal compound rotates by 180° in a plane of the liquid crystal alignment pattern in the region B.
[9] The optically-anisotropic layer according to any one of [1] to [8],
in which at least one region of the region A or the region B is a cholesteric liquid crystal layer in which the liquid crystal compound is cholesterically aligned.
[10] The optically-anisotropic layer according to [9],
in which the region A and the region B are the cholesteric liquid crystal layer, and
a region in which a length of a helical pitch of the cholesteric liquid crystal layer in the region A is different from a length of a helical pitch of the cholesteric liquid crystal layer in the region B is provided.
[11] The optically-anisotropic layer according to [9] or [10],
in which the region A and the region B are the cholesteric liquid crystal layer, and
a helical turning direction of a cholesteric alignment in the region A is different from a helical turning direction of a cholesteric alignment in the region B.
[12] The optically-anisotropic layer according to any one of [9] to [11],
in which, in at least one region of the region A or the region B, a region in which a length of a helical pitch of the cholesteric liquid crystal layer varies in the in-plane direction of the region is provided.
[13] The optically-anisotropic layer according to any one of [9] to [12],
in which, in at least one region of the region A or the region B, a region in which a length of a helical pitch of the cholesteric liquid crystal layer changes in a thickness direction of the optically-anisotropic layer is provided.
[14] The optically-anisotropic layer according to any one of [1] to [13],
in which at least a part in a plane of the region not having the liquid crystal alignment pattern is optically isotropic.
[15] The optically-anisotropic layer according to any one of [1] to [13],
in which, in at least a part in a plane of the region not having the liquid crystal alignment pattern, the liquid crystal compound is aligned in one direction in the same plane.
[16] The optically-anisotropic layer according to any one of [1] to [13],
in which at least a part in a plane of the region not having the liquid crystal alignment pattern is a retardation plate in which the liquid crystal compound is uniaxially aligned or twistedly aligned.
[17] The optically-anisotropic layer according to any one of [1] to [16],
in which an entire layer is smooth and has no uneven structure.
[18] The optically-anisotropic layer according to [4],
in which, in at least one region of the region A or the region B, a region in which the diffraction efficiency varies due to a different thickness-direction retardation Rth in the in-plane direction.
[19] A laminate comprising:
two or more of the optically-anisotropic layers according to any one of [1] to [18].
[20] The laminate according to [19],
in which the laminate includes two optically-anisotropic layers of a first optically-anisotropic layer and a second optically-anisotropic layer, and
the first optically-anisotropic layer and the second optically-anisotropic layer are disposed such that
   the region A of the first optically-anisotropic layer and the region A of the second optically-anisotropic layer overlap with each other,
   the region not having the liquid crystal alignment pattern of the first optically-anisotropic layer and the region not having the liquid crystal alignment pattern of the second optically-anisotropic layer overlap with each other, and
   the region B of the first optically-anisotropic layer and the region B of the second optically-anisotropic layer overlap with each other.
[21] The laminate according to [20],
in which the laminate satisfies at least one of
   a requirement that a length of a single period in the region A of the first optically-anisotropic layer, over which the orientation of the optical axis derived from the liquid crystal compound rotates 180° in a plane, is different from a length of a single period in the region A of the second optically-anisotropic layer, or
   a requirement that a length of a single period in the region B of the first optically-anisotropic layer, over which the orientation of the optical axis derived from the liquid crystal compound rotates 180° in a plane, is different from a length of a single period in the region B of the second optically-anisotropic layer.
[22] The laminate according to or [21],
in which the laminate satisfies at least one of
   a requirement that the one direction of the liquid crystal alignment pattern in the region A of the first optically-anisotropic layer is different from the one direction of the liquid crystal alignment pattern in the region A of the second optically-anisotropic layer, or
   a requirement that the one direction of the liquid crystal alignment pattern in the region B of the first optically-anisotropic layer is different from the one direction of the liquid crystal alignment pattern in the region B of the second optically-anisotropic layer.
[23] The laminate according to any one of to [22],
in which the laminate satisfies at least one of
   a requirement that the region A of the first optically-anisotropic layer and the region A of the second optically-anisotropic layer are cholesteric liquid crystal layers, and a length of a helical pitch of the cholesteric liquid crystal layer in the region A of the first optically-anisotropic layer is different from a length of a helical pitch of the cholesteric liquid crystal layer in the region A of the second optically-anisotropic layer, or
   a requirement that the region B of the first optically-anisotropic layer and the region B of the second optically-anisotropic layer are cholesteric liquid crystal layers, and a length of a helical pitch of the cholesteric liquid crystal layer in the region B of the first optically-anisotropic layer is different from a length of a helical pitch of the cholesteric liquid crystal layer in the region B of the second optically-anisotropic layer.
[24] The laminate according to any one of to [23],
in which the laminate satisfies at least one of
   a requirement that the region A of the first optically-anisotropic layer and the region A of the second optically-anisotropic layer are cholesteric liquid crystal layers, and a helical rotation direction of the cholesteric liquid crystal layer in the region A of the first optically-anisotropic layer is different from a helical rotation direction of the cholesteric liquid crystal layer in the region A of the second optically-anisotropic layer, or
   a requirement that the region B of the first optically-anisotropic layer and the region B of the second optically-anisotropic layer are cholesteric liquid crystal layers, and a helical rotation direction of the cholesteric liquid crystal layer in the region B of the first optically-anisotropic layer is different from a helical rotation direction of the cholesteric liquid crystal layer in the region B of the second optically-anisotropic layer.
[25] A light guide element comprising:
a light guide plate; and
the optically-anisotropic layer according to any one of [1] to [18], which is disposed on a surface of the light guide plate.
[26] The light guide element according to [25], further comprising:
a retardation layer.
[27] An AR display device comprising:
the light guide element according to or [26]; and
an image display device.
[28] The AR display device according to [27],
in which emitted light of the image display device is polarized light.
[29] The AR display device according to or [28],
in which the image display device is a laser beam scanning type image display device.

According to the present invention, it is possible to provide an optically-anisotropic layer which can emit light having high clearness from a light guide plate, a laminate, a light guide element using the optically-anisotropic layer, and an AR display device.

### BRIEF DESCRIPTION OF THE DRAWINGS

FIG. 1 is a conceptual view showing an example of a region A and a region B in an optically-anisotropic layer according to the embodiment of the present invention.

FIG. 2 is a top view of FIG. 1.

FIG. 3 is a conceptual view showing an example of an exposure device which exposes an alignment film.

FIG. 4 is a view showing action of the region A and/or the region B of the optically-anisotropic layer of FIG. 1.

FIG. 5 is a graph conceptually showing an example of a relationship between a position and a diffraction efficiency in the region A and/or the region B of the optically-anisotropic layer.

FIG. 6 is a graph conceptually showing another example of the relationship between the position and the diffraction efficiency in the region A and/or the region B of the optically-anisotropic layer.

FIG. 7 is a conceptual view showing another example of the region A and the region B in the optically-anisotropic layer according to the embodiment of the present invention.

FIG. 8 is a top view of FIG. 7.

FIG. 9 is a view showing action of the region A and/or the region B of the optically-anisotropic layer of FIG. 7.

FIG. 10 is a view showing action of the region A and/or the region B of the optically-anisotropic layer of FIG. 7.

FIG. 11 is a view schematically showing an example of an AR display device including the optically-anisotropic layer according to the embodiment of the present invention.

FIG. 12 is a graph conceptually showing a relationship a position and emitted light in the AR display device.

FIG. 13 is a view for explaining a measuring method of an emitted light intensity in Examples.

FIG. 14 is a schematic view for explaining a measuring method of a diffraction efficiency.

FIG. 15 is a view for explaining an example of a method of forming a region in which a diffraction efficiency gradually changes in an in-plane direction of the optically-anisotropic layer.

FIG. 16 is a view for explaining another example of the method of forming a region in which a diffraction efficiency gradually changes in an in-plane direction of the optically-anisotropic layer.

FIG. 17 is a diagram showing an irradiation amount of light depending on a position of the optically-anisotropic layer.

FIG. 18 is a diagram showing a diffraction efficiency depending on the position of the optically-anisotropic layer.

FIG. 19 is a diagram showing a retardation value depending on the position of the optically-anisotropic layer.

FIG. 20 is a diagram showing an irradiation amount of light depending on a position of the optically-anisotropic layer.

FIG. 21 is a diagram showing a diffraction efficiency depending on the position of the optically-anisotropic layer.

FIG. 22 is a diagram showing a retardation value depending on the position of the optically-anisotropic layer.

FIG. 23 is a diagram showing a diffraction efficiency depending on the position of the optically-anisotropic layer.

FIG. 24 is a view schematically showing an example of an AR display device including a liquid crystal diffraction element in the related art.

FIG. 25 is a diagram showing an example of an in-plane distribution of the diffraction efficiency using shading.

FIG. 26 is a view schematically showing a cross section of an X-Z plane of the region A and/or the region B of the optically-anisotropic layer.

FIG. 27 is a view schematically showing the cross section of the X-Z plane of the region A and/or the region B of the optically-anisotropic layer.

FIG. 28 is a diagram schematically showing the cross section of the X-Z plane of the region A and/or the region B of the optically-anisotropic layer.

FIG. 29 is a view conceptually showing an example of the optically-anisotropic layer according to the embodiment of the present invention.

FIG. 30 is a top view of FIG. 29.

FIG. 31 is a view conceptually showing another example of the optically-anisotropic layer according to the embodiment of the present invention.

FIG. 32 is a view conceptually showing an example of a laminate including a plurality of the optically-anisotropic layers according to the embodiment of the present invention.

### DESCRIPTION OF THE PREFERRED EMBODIMENTS

Hereinafter, the optically-anisotropic layer, the laminate, the light guide element, and the AR display device according to the embodiment of the present invention will be described in detail based on suitable examples shown in the accompanying drawings.

In the present specification, a numerical range represented by “to” means a range including numerical values before and after “to” as a lower limit value and an upper limit value. In the present specification, “(meth)acrylate” is used to mean “either or both of acrylate and methacrylate”. In the present specification, “same” includes an error range generally accepted in the technical field. In addition, in the present specification, the meaning of “all”, “entire”, or “entire surface” includes not only 100% but also a case in which an error range is generally allowable in the technical field, for example, 99% or more, 95% or more, or 90% or more. In addition, “orthogonal” or “parallel” regarding an angle represents a range of an exact angle±5°, and “the same” regarding the angle represents that a difference from the exact angle is less than 5 degrees, unless specified otherwise. The difference from the exact angle is preferably less than 4 degrees and more preferably less than 3 degrees.

In the present specification, among electromagnetic waves, visible light is light having a wavelength which can be seen by human eyes, and refers to light in a wavelength range of 380 to 780 nm. Non-visible light refers to light in a wavelength range of less than 380 nm or in a wavelength range of more than 780 nm. In addition, although not limited thereto, among the visible light, light in a wavelength range of 420 to 490 nm is blue light, light in a wavelength range of 495 to 570 nm is green light, and light in a wavelength range of 620 to 750 nm is red light.

In the present specification, a selective reflection center wavelength refers to an average value of two wavelengths at which, in a case where a maximal value of a transmittance of a target object (member) is represented by Tmin (%), a half-value transmittance: T½(%) represented by the following expression is exhibited.

T½=100−[(100−Tmin)]÷2 Expression for acquiring half-value transmittance:

In addition, the fact that selective reflection center wavelengths of a plurality of layers are “equal” does not mean that the selective reflection center wavelengths are exactly equal, and error is allowed in a range in which there are no optical effects. Specifically, the fact that selective reflection center wavelengths of a plurality of objects are “equal” means that a difference between the selective reflection center wavelengths of the respective objects is 20 nm or less, preferably 15 nm or less and more preferably 10 nm or less.

A retardation value is measured using “Axoscan” (manufactured by Axometrics, Inc.). A measurement wavelength is set to 750 nm. A phase difference with respect to incidence ray from a normal direction of a sample surface is measured, and then a phase difference is measured from directions having incidence angles of −40° and 40° in each of a slow axis plane and a fast axis plane which has been detected, and an average value of the measured values in the four directions is obtained as an oblique-direction retardation Re(40).

### [Optically-Anisotropic Layer]

The optically-anisotropic layer according to the embodiment of the present invention is an optically-anisotropic layer formed of a composition containing a liquid crystal compound, the optically-anisotropic layer including a region A having a liquid crystal alignment pattern in which an orientation of an optical axis derived from the liquid crystal compound changes while continuously rotating in at least one in-plane direction, a region B having a liquid crystal alignment pattern in which an orientation of an optical axis derived from the liquid crystal compound changes while continuously rotating in at least one in-plane direction, and a region not having the liquid crystal alignment pattern. As will be described later, the region A and the region B having the liquid crystal alignment pattern act as a so-called liquid crystal diffraction element which diffracts incident light. Accordingly, it can be said that the optically-anisotropic layer according to the embodiment of the present invention has a configuration in which two liquid crystal diffraction elements and a liquid crystal layer not having a diffraction action are integrally formed. Since the optically-anisotropic layer according to the embodiment of the present invention has such a structure, the optically-anisotropic layer according to the embodiment of the present invention can be laminated on a light guide plate to emit light having high clearness from the light guide plate. In addition, in at least one of the region A or the region B, it is preferable that a diffraction efficiency increases from one side to the other side in the one direction of the liquid crystal alignment pattern. By having such a structure, in a case where light propagated in the light guide plate is diffracted by the liquid crystal diffraction element (the region A or the region B) and emitted from the light guide plate, brightness of the emitted light can be made uniform.

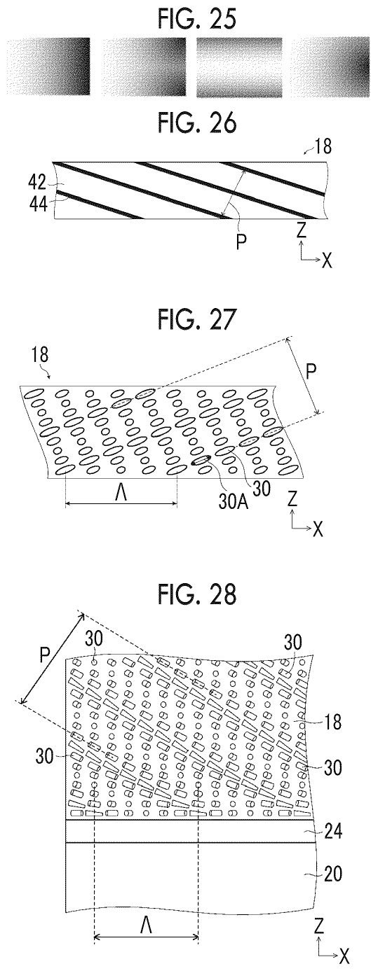

A change in diffraction efficiency may be that the diffraction efficiency is high in a plurality of in-plane directions. FIG. 25 shows an example of an in-plane distribution of the diffraction efficiency. In FIG. 25, a region where the black color is darker is a region where the diffraction efficiency is higher. However, the present invention is not limited thereto, and various liquid crystal diffraction elements can be adopted according to the design of the light guide plate.

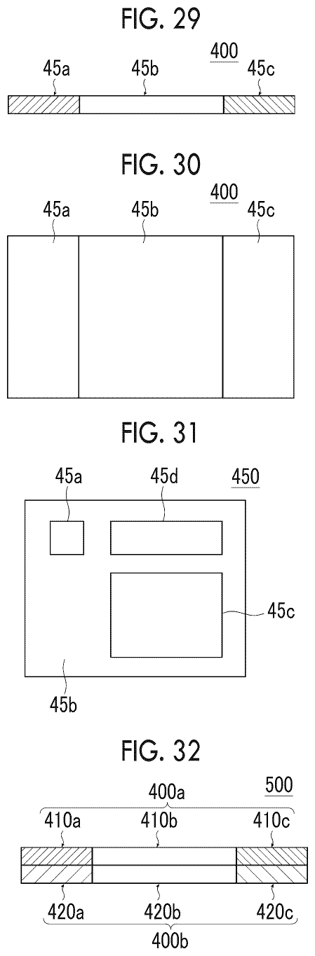

FIG. 29 is a view conceptually showing an example of the optically-anisotropic layer according to the embodiment of the present invention. FIG. 30 is a top view of FIG. 29.

An optically-anisotropic layer 400 shown in FIGS. 29 and 30 is formed of a composition containing a liquid crystal compound, and in an in-plane direction, an alignment state of the liquid crystal compound is made different to form a region A45a, a region 45b not having a liquid crystal alignment pattern (hereinafter, also referred to as a non-diffraction region), and a region B45c. The non-diffraction region 45b is disposed between the region A45a and the region B45c. In the following description, the region A45a and the region B45c are also referred to as a diffraction region.

The region A45a and the region B45c each have a liquid crystal alignment pattern in which an orientation of an optical axis derived from the liquid crystal compound changes while continuously rotating in at least one in-plane direction, and acts as a liquid crystal diffraction element which diffracts incident light. The liquid crystal alignment pattern of the region A45a and the liquid crystal alignment pattern of the region B45c may be the same or different from each other.

In addition, the region A45a, the non-diffraction region 45b, and the region B45c have substantially the same thickness, and both main surfaces of the optically-anisotropic layer 400 are smooth flat surfaces having no uneven structure.

### [Region A and Region B]

Embodiments of the liquid crystal diffraction element including a cholesteric liquid crystal layer, which can be used as the region A and the region B, in the optically-anisotropic layer according to the embodiment of the present invention will be described.

### First Embodiment

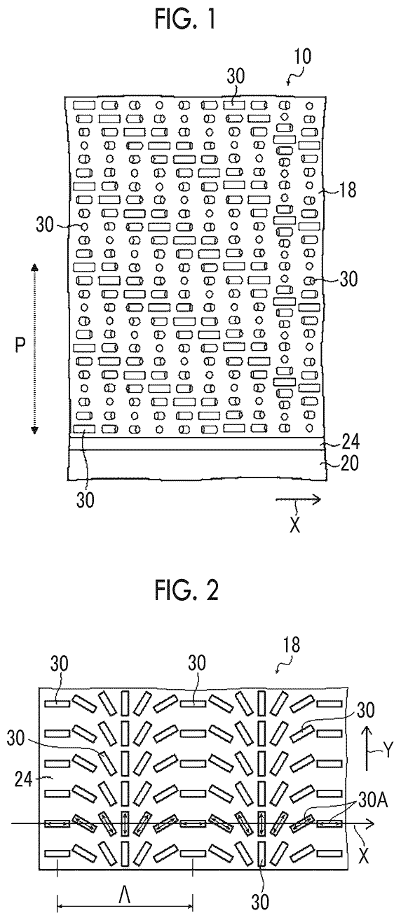

FIG. 1 conceptually shows an example of a first embodiment of the liquid crystal diffraction element.

A liquid crystal diffraction element 10 shown in FIG. 1 is a liquid crystal diffraction element which selectively reflects light having a specific wavelength and diffracts reflected light.

The liquid crystal diffraction element 10 shown in FIG. 1 has a configuration in which a support 20, an alignment film 24, and a cholesteric liquid crystal layer 18 are laminated in this order.

The liquid crystal diffraction element 10 shown in FIG. 1 includes the support 20 and the alignment film 24, but the liquid crystal diffraction element may have a configuration in which the support 20 or the support 20 and the alignment film 24 are not provided.

For example, the liquid crystal diffraction element may have a configuration in which the support 20 is peeled off from the above-described configuration, and only the alignment film 24 and the cholesteric liquid crystal layer 18 are provided. Alternatively, the liquid crystal diffraction element may have a configuration in which the support 20 and the alignment film 24 are peeled off and only the cholesteric liquid crystal layer 18 is provided.

That is, the optically-anisotropic layer according to the embodiment of the present invention may be configured to be laminated on the support and the alignment film, may be configured to be laminated on the alignment film, or may be configured to be used alone.

That is, as long as the liquid crystal diffraction element has the liquid crystal alignment pattern in which the orientation of the optical axis derived from the liquid crystal compound changes while continuously rotating in at least one in-plane direction, various layer configurations can be used. Regarding the above-described point, the same applies to the liquid crystal diffraction elements of the respective aspects described below.

### <Support>

The support 20 is a film-like material (sheet-like material or plate-like material) which supports the alignment film 24 and the cholesteric liquid crystal layer 18. In addition, a transmittance of the support 20 with respect to light diffracted by the cholesteric liquid crystal layer 18 is preferably 50% or more, more preferably 70% or more, and still more preferably 85% or more.

A thickness of the support 20 is not particularly limited, and may be appropriately set depending on the use of the liquid crystal diffraction element 10, a material for forming the support 20, and the like in a range in which the alignment film 24 and the cholesteric liquid crystal layer 18 can be supported. The thickness of the support 20 is preferably 1 to 1000 μm, more preferably 3 to 250 μm, and still more preferably 5 to 150 μm.

The support 20 may have a single-layer structure or a multi-layer structure. As a material of the support 20 having the single-layer structure, various materials used as a material of a support in an optical element can be used. Specific examples of the material of the support 20 include glass, triacetyl cellulose (TAC), polyethylene terephthalate (PET), polycarbonates, polyvinyl chloride, acryl, and polyolefin. In a case where the support 20 has a multi-layer structure, examples thereof include a support including one of the above-described supports having a single-layer structure, which is provided as a substrate, and another layer which is provided on a surface of the substrate.

### <Alignment Film>

The alignment film 24 is formed on the surface of the support 20. The alignment film 24 is an alignment film for aligning a liquid crystal compound 30 to a predetermined liquid crystal alignment pattern during the formation of the cholesteric liquid crystal layer 18.

As will be described later, in the liquid crystal diffraction element 10, the cholesteric liquid crystal layer 18 has a liquid crystal alignment pattern in which an orientation of an optical axis 30A (refer to FIG. 2) derived from the liquid crystal compound 30 changes while continuously rotating in one in-plane direction. In the present invention, in a case where a length over which the orientation of the optical axis 30A rotates by 180° in the one direction in which the orientation of the optical axis 30A changes while continuously rotating in the liquid crystal alignment pattern is set as a single period (symbol A in FIG. 2; also simply referred to as “rotation period of the optical axis”).

In the following description, the “orientation of the optical axis 30A rotates” will also be simply referred to as “optical axis 30A rotates”.

As the alignment film, various known films can be used. Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as @-tricosanoic acid, dioctadecylmethylammonium chloride, or methyl stearate.

The alignment film formed by a rubbing treatment can be formed by rubbing a surface of a polymer layer with paper or fabric in a given direction multiple times. As the material used for the alignment film, a material for forming polyimide, polyvinyl alcohol, a polymer having a polymerizable group described in JP1997-152509A (JP-H9-152509A), or an alignment film and the like described in JP2005-097377A, JP2005-099228A, and JP2005-128503A is preferable.

In the liquid crystal diffraction element 10, for example, the alignment film can be suitably used as a so-called photo-alignment film obtained by irradiating a photo-alignment material with polarized light or non-polarized light. That is, in the liquid crystal diffraction element 10, a photo-alignment film which is formed by applying a photo-alignment material onto the support 20 is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the photo-alignment film which can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A. Among these, an azo compound, a photocrosslinking polyimide, a photocrosslinking polyamide, a photocrosslinking polyester, a cinnamate compound, or a chalcone compound is suitability used.

A thickness of the alignment film is not particularly limited. The thickness with which a required alignment function can be obtained may be appropriately set depending on the material for forming the alignment film. The thickness of the alignment film is preferably 0.01 to 5 μm and more preferably 0.05 to 2 μm.

A method for forming the alignment film is not limited, and various known methods can be used depending on the material for forming the alignment film. Examples thereof include a method including: applying the alignment film to a surface of the support 20; drying the applied alignment film; and exposing the alignment film to laser light to form an alignment pattern.

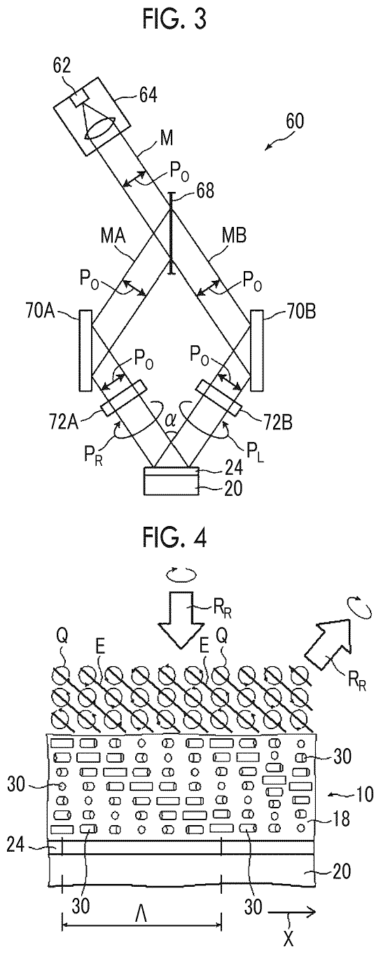

FIG. 3 conceptually shows an example of an exposure device which exposes the alignment film to form an alignment pattern. An exposure device 60 shown in FIG. 3 includes a light source 64 which includes a laser 62 and a λ/2 plate (not shown), a beam splitter 68 which splits laser light M emitted from the light source 64 into two beams MA and MB, mirrors 70A and 70B which are disposed on optical paths of the splitted two beams MA and MB, and λ/4 plates 72A and 72B. Although not shown in the drawing, the light source 64 includes the λ/2 plate, and the λ/2 plate changes a polarization direction of the laser light M emitted from the laser 62 to emit linearly polarized light Pₒ. The λ/4 plates 72A and 72B have optical axes parallel to each other. The λ/4 plate 72A converts the linearly polarized light Pₒ (ray MA) into dextrorotatory circularly polarized light P_{R}, and the λ/4 plate 72B converts the linearly polarized light Pₒ (ray MB) into levorotatory circularly polarized light PL.

The support 20 including the alignment film 24 on which the alignment pattern is not yet formed is disposed at an exposed portion, the two rays MA and MB intersect and interfere each other on the alignment film 24, and the alignment film 24 is irradiated with and exposed to the interference light. Due to the interference at this time, the polarization state of light with which the alignment film 24 is irradiated periodically changes according to interference fringes. As a result, in the alignment film 24, an alignment pattern in which the alignment state periodically changes can be obtained. In the exposure device 60, by changing an intersecting angle α between the two rays MA and MB, a period of the alignment pattern can be adjusted. That is, by adjusting the intersecting angle α in the exposure device 60, in the alignment pattern in which the optical axis 30A derived from the liquid crystal compound 30 continuously rotates in the one direction, it is possible to adjust a length of the single period over which the optical axis 30A rotates 180° in the one direction that the optical axis 30A rotates. By forming the cholesteric liquid crystal layer on the alignment film having the alignment pattern in which the alignment state periodically changes, as described below, the cholesteric liquid crystal layer 18 having the liquid crystal alignment pattern in which the optical axis 30A derived from the liquid crystal compound 30 continuously rotates in the one direction can be formed. In addition, by rotating the optical axes of the λ/4 plates 72A and 72B by 90°, respectively, the rotation direction of the optical axis 30A can be reversed.

In the liquid crystal diffraction element, the alignment film is provided as a preferred aspect, and is not an essential configuration requirement. For example, the following configuration can also be adopted, in which, by forming the alignment pattern on the support 20 using a method of rubbing the support 20, a method of processing the support 20 with laser light or the like, or the like, the cholesteric liquid crystal layer has the liquid crystal alignment pattern in which the orientation of the optical axis 30A derived from the liquid crystal compound 30 changes while continuously rotating in at least one in-plane direction.

### <Cholesteric Liquid Crystal Layer>

The cholesteric liquid crystal layer 18 is formed on the surface of the alignment film 24. The cholesteric liquid crystal layer 18 is a layer which is formed of a composition containing a liquid crystal compound, and has a liquid crystal alignment pattern in which an orientation of an optical axis derived from the liquid crystal compound continuously rotates in at least one in-plane direction.

In the example shown in FIG. 1, the cholesteric liquid crystal layer 18 has a configuration in which the liquid crystal compound is cholesterically aligned. That is, the cholesteric liquid crystal layer 18 is a layer obtained by immobilizing a cholesteric liquid crystalline phase, and has a cholesteric liquid crystal structure in which the liquid crystal compound is helically twisted and aligned along a helical axis parallel to a thickness direction. In the cholesteric liquid crystal layer 18, a configuration in which the liquid crystal compound 30 is helically rotated once (rotated by 360) and stacked is set as one helical pitch, and plural pitches of the helically turned liquid crystal compound 30 are stacked.

The cholesteric liquid crystal layer 18 having the cholesteric liquid crystal structure has wavelength-selective reflectivity. For example, in a case where the cholesteric liquid crystal layer 18 has a selective reflection center wavelength in a green wavelength range, the cholesteric liquid crystal layer 18 reflects dextrorotatory circularly polarized green light GR and transmits the other light. Here, since the liquid crystal compound 30 rotates to be aligned in the plane direction, the cholesteric liquid crystal layer 18 diffracts (refracts) incident circularly polarized light to be reflected in a direction in which the orientation (azimuth direction) of the optical axis continuously rotates. At this time, the diffraction azimuth direction varies depending on a turning direction of the incident circularly polarized light. That is, the cholesteric liquid crystal layer 18 reflects dextrorotatory circularly polarized light or levorotatory circularly polarized light, having a selective reflection wavelength, and diffracts the reflected light. In addition, the cholesteric liquid crystal layer 18 changes a turning direction of the reflected circularly polarized light to an opposite direction.

### <<Cholesteric Liquid Crystalline Phase>>

The cholesteric liquid crystalline phase exhibits selective reflectivity with respect to left-handed or right-handed circular polarization at a specific wavelength. A central wavelength (selective reflection center wavelength) λ of selective reflection depends on a pitch P (=helical period) of a helical structure in the cholesteric liquid crystalline phase and satisfies a relationship of λ=n×P with an average refractive index n of the cholesteric liquid crystalline phase. Therefore, the selective reflection center wavelength can be adjusted by adjusting the pitch of the helical structure. The pitch of the cholesteric liquid crystalline phase depends on the type of chiral agent used together with the liquid crystal compound, or the concentration thereof added in a case of forming the optically-anisotropic layer, a desired pitch can be obtained by adjusting these. Regarding the adjustment of the pitch, detailed description can be referred to FUJIFILM Research Report No. 50 (2005), pp. 60 to 63. Regarding a method for measuring the helical sense and the pitch of the helix, it is possible to use the method described on page 46 of “Liquid Crystal Chemical Experiment Introduction” edited by Japan Liquid Crystal Society, published by Sigma Corporation in 2007, and page 196 of “Liquid Crystal Handbook” Liquid Crystal Handbook Editing Committee, Maruzen Publishing Co., Ltd.

Whether or not the reflected light from the cholesteric liquid crystalline phase is dextrorotatory circularly polarized light or levorotatory circularly polarized light is determined depending on a helical twisted direction (sense) of the cholesteric liquid crystalline phase. Regarding the selective reflection of the circular polarization by the cholesteric liquid crystalline phase, in a case where the helically twisted direction of the cholesteric liquid crystalline phase is right, dextrorotatory circularly polarized light is reflected, and in a case where the helically twisted direction of the cholesteric liquid crystalline phase is left, levorotatory circularly polarized light is reflected.

In the liquid crystal diffraction element 10 of FIG. 1, the cholesteric liquid crystal layer 18 is a layer formed by immobilizing a right-twisted cholesteric liquid crystalline phase. The direction of the revolution of the cholesteric liquid crystalline phase can be adjusted by the type of liquid crystal compound forming the optically-anisotropic layer and/or the type of a chiral agent to be added.

In addition, a half-width Δλ (nm) of a selective reflection range (circular polarization reflection range) where selective reflection is exhibited depends on Δn of the cholesteric liquid crystalline phase and the helical pitch P and complies with a relationship of Δλ=Δn×P. Therefore, the width of the selective reflection range can be controlled by adjusting Δn. Δn can be adjusted by adjusting the type of the liquid crystal compound for forming the optically-anisotropic layer and a mixing ratio thereof, and a temperature during aligned immobilization. The half-width of the reflection wavelength range is adjusted depending on the use of the liquid crystal diffraction element 10, and may be, for example, 10 to 500 nm, preferably 20 to 300 nm and more preferably 30 to 100 nm.

### <<Method of Forming Cholesteric Liquid Crystal Layer Having Cholesteric Liquid Crystal Structure>>

The cholesteric liquid crystal layer (the region A and/or the region B in the optically-anisotropic layer) having the cholesteric liquid crystal structure can be formed by immobilizing the cholesteric liquid crystalline phase in a layer shape. A structure in which the cholesteric liquid crystalline phase is immobilized may be any structure as long as the alignment of the liquid crystal compound in the cholesteric liquid crystalline phase is maintained, and typically, the structure is preferably a structure in which a polymerizable liquid crystal compound is brought into the alignment state of the cholesteric liquid crystalline phase and is polymerized and cured by ultraviolet irradiation, heating, and the like to form a layer without fluidity, and simultaneously, the layer changes to a state that an external field or an external force does not cause a change in alignment. A method of forming the optically-anisotropic layer having the region A and/or the region B as the cholesteric liquid crystal layer and the non-diffraction region will be described later.

The structure in which the cholesteric liquid crystalline phase is immobilized is not particularly limited as long as the optical characteristics of the cholesteric liquid crystalline phase are maintained, and the liquid crystal compound 30 in the cholesteric liquid crystal layer does not necessarily exhibit liquid crystallinity. For example, the polymerizable liquid crystal compound may lose its liquid crystal property by increasing its molecular weight by a curing reaction.

Examples of a material used for forming the cholesteric liquid crystal layer obtained by immobilizing the cholesteric liquid crystalline phase include a liquid crystal composition containing a liquid crystal compound. It is preferable that the liquid crystal compound is a polymerizable liquid crystal compound. In addition, the liquid crystal composition used for forming the cholesteric liquid crystal layer may further contain a surfactant and a chiral agent.

### ——Polymerizable Liquid Crystal Compound——

The polymerizable liquid crystal compound may be a rod-like liquid crystal compound or a disk-like liquid crystal compound.

Examples of the rod-like polymerizable liquid crystal compound forming the cholesteric liquid crystalline phase include a rod-like nematic liquid crystal compound. As the rod-like nematic liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, alkenylcyclohexylbenzonitriles, and the like are preferably used. High-molecular-weight liquid crystal compounds can also be used as well as low-molecular-weight liquid crystal compounds.

The polymerizable liquid crystal compound is obtained by introducing a polymerizable group into the liquid crystal compound. Examples of the polymerizable group include an unsaturated polymerizable group, an epoxy group, an oxetanyl group, and an aziridinyl group; and an unsaturated polymerizable group is preferable, and an ethylenically unsaturated polymerizable group is more preferable. The polymerizable group can be introduced into the molecule of the liquid crystal compound by various methods. The number of polymerizable groups in the polymerizable liquid crystal compound is preferably 1 to 6 and more preferably 1 to 3.

Examples of the polymerizable liquid crystal compound include compounds described in “Makromol. Chem., vol. 190, p. 2255 (1989), Advanced Materials, vol. 5, p. 107 (1993)”, U.S. Pat. Nos. 4,683,327A, 5,622,648A, 5,770,107A, WO1995/22586A, WO1995/24455A, WO1997/00600A, WO1998/23580A, WO1998/52905A, JP1989-272551A (JP-H1-272551A), JP1994-016616A (JP-H6-016616A), JP1995-110469A (JP-H7-110469A), JP1999-080081A (JP-H11-080081A), JP2001-328973A, and the like. Furthermore, as the rod-like liquid crystal compound, for example, compounds described in JP1999-513019A (JP-H11-513019A) and JP2007-279688A can also be preferably used. Two or more kinds of polymerizable liquid crystal compounds may be used in combination. In a case where two or more kinds of polymerizable liquid crystal compounds are used in combination, an alignment temperature can be decreased.

In addition, as a polymerizable liquid crystal compound other than the above, a cyclic organopolysiloxane compound having a cholesteric phase, as described in JP1982-165480A (JP-S57-165480A), or the like can be used. Furthermore, as the above-described high-molecular-weight liquid crystal compound, a polymer in which a mesogen group exhibiting liquid crystal are introduced into the main chain, the side chain, or both main chain and side chain, a polymeric cholesteric liquid crystal in which a cholesteryl group is introduced into the side chain, a liquid crystalline polymer as described in JP1997-133810A (JP-H9-133810A), a liquid crystalline polymer as described in JP1999-293252A (JP-H11-293252A), and the like can be used.

### ——Disk-Like Liquid Crystal Compound——

As the disk-like liquid crystal compound, for example, compounds described in JP2007-108732A or JP2010-244038A can be preferably used.

In addition, an amount of the polymerizable liquid crystal compound added to the liquid crystal composition is preferably 75% to 99.9% by mass, more preferably 80% to 99% by mass, and still more preferably 85% to 90% by mass with respect to the mass of solid content of the liquid crystal composition (mass excluding a solvent).

From the viewpoint that the effect of the present invention is more excellent and viewpoint that diffracted light having a high diffraction efficiency can be obtained at a large diffraction angle, the maximum value of the birefringence index Δn of the liquid crystal compound inside the cholesteric liquid crystal layer is preferably 0.15 or more, more preferably 0.20 or more, still more preferably 0.25 or more, even more preferably 0.30 or more, and most preferably 0.35 or more. The upper limit thereof is not particularly limited, but is usually 1.00 or less.

The liquid crystal compound exhibiting such high refractive index anisotropy is usually a compound having a positive dispersibility in which a birefringence index Δn450 with respect to incident light having a wavelength of 450 nm is larger than a birefringence index Δn550 with respect to incident light having a wavelength of 550 nm. The value of Δn450/Δn550 is not particularly limited, but is, for example, 0.5 to 2.0, and is usually 1.0 to 1.5. In the case of the compound having a positive dispersibility, the diffraction efficiency at each wavelength can be kept constant by adjusting the selective reflection band exhibiting the above-described selective reflection, the alignment degree described later, the thickness, and the like.

For example, by forming a layer having a selective reflection band for diffracting incident light of 450 nm to be thin and forming a layer having a selective reflection band for diffracting incident light of 550 nm to be thick, the diffraction efficiency at each wavelength can be kept constant.

From the viewpoint that the effect of the present invention is more excellent and viewpoint that AR display with a large viewing angle can be obtained, the maximum value of an extraordinary refractive index of the liquid crystal compound inside the optically-anisotropic layer is preferably 1.8 or more, more preferably 1.9 or more, and still more preferably 2.0 or more. In addition, an ordinary refractive index of the liquid crystal compound inside the optically-anisotropic layer is preferably 1.4 or more, more preferably 1.5 or more, and still more preferably 1.6 or more.

It is preferable that the birefringence index Δn and the refractive index satisfy the above-described preferred ranges over a range of 380 to 780 nm. In particular, it is preferable that the above-described preferred ranges are satisfied over a range of 400 to 650 nm.

From the viewpoint that the effect of the present invention is more excellent and viewpoint that AR display having excellent transparency and high light utilization efficiency can be obtained, an absorbance of the optically-anisotropic layer at 450 nm is preferably 1% or less, more preferably 0.1% or less, and still more preferably 0.01% or less. In addition, a molar absorption coefficient of the liquid crystal compound used in the optically-anisotropic layer at 450 nm is preferably 100 (mol·cm)⁻¹ or less, more preferably 10 (mol·cm)⁻¹ or less, and still more preferably 1 (mol·cm)⁻¹ or less.

It is preferable that the absorbance and the molar absorption coefficient satisfy the above-described preferred ranges over a range of 380 to 780 nm. In particular, it is preferable that the above-described preferred ranges are satisfied over a range of 400 to 650 nm.

The minimum value of the birefringence index Δn of the liquid crystal compound inside the cholesteric liquid crystal layer is preferably 0.00 to 0.40, more preferably 0.00 to 0.30, and still more preferably 0.00 to 0.20.

Specific examples of the polymerizable liquid crystal compound having a large refractive index anisotropy include compounds described in JP2009-102245A, JP4655348B, JP4524827B, JP4720200B, JP2004-091380A, JP3972430B, JP4517416B, JP2002-128742A, JP4810750B, JP5888544B, JP2014-019654A, JP6241654B, JP6372060B, JP6323144B, JP2005-015406A, JP2007-230968A, JP6761484B, JP6681992B, WO2019/182129A, CN1134217A, KR101069555B, KR101690767B, CN20120229730A, JP4053782B, JP2009-249406A, JP4121075B, JP2005-528416A, U.S. Pat. No. 6,514,578B, WO2006/006819A, JP2011-184417A, JP2013-095685A, JP2013-103897A, JP2002-088008A, JP2002-226412A, JP2012-167214A, JP2012-167068A, JP2018-084511A, JP2003-055317A, JP2001-329264A, JP2002-030016A, JP2003-055664A, JP2018-070889A, CN102557896B, US2015369982A, JP2020-105264A, JP2014-224237A, JP2012-051862A, JP2010-106274A, JP2005-179557A, JP2005-035985A, JP2002-012579A, JP2002-003845A, JP2001-233837A, JP2019-532167A, JP2016-509247A, JP2010-503733A, JP2003-533557A, WO2019/098115A, WO2018/034216A, WO2018/221236A, WO2018/123396A, WO2018/003482A, WO2017/086143A, WO2014/192655A, WO2013/161669A, and WO2009/104468A.

In addition, examples of the polymerizable liquid crystal compound also include compounds shown below.

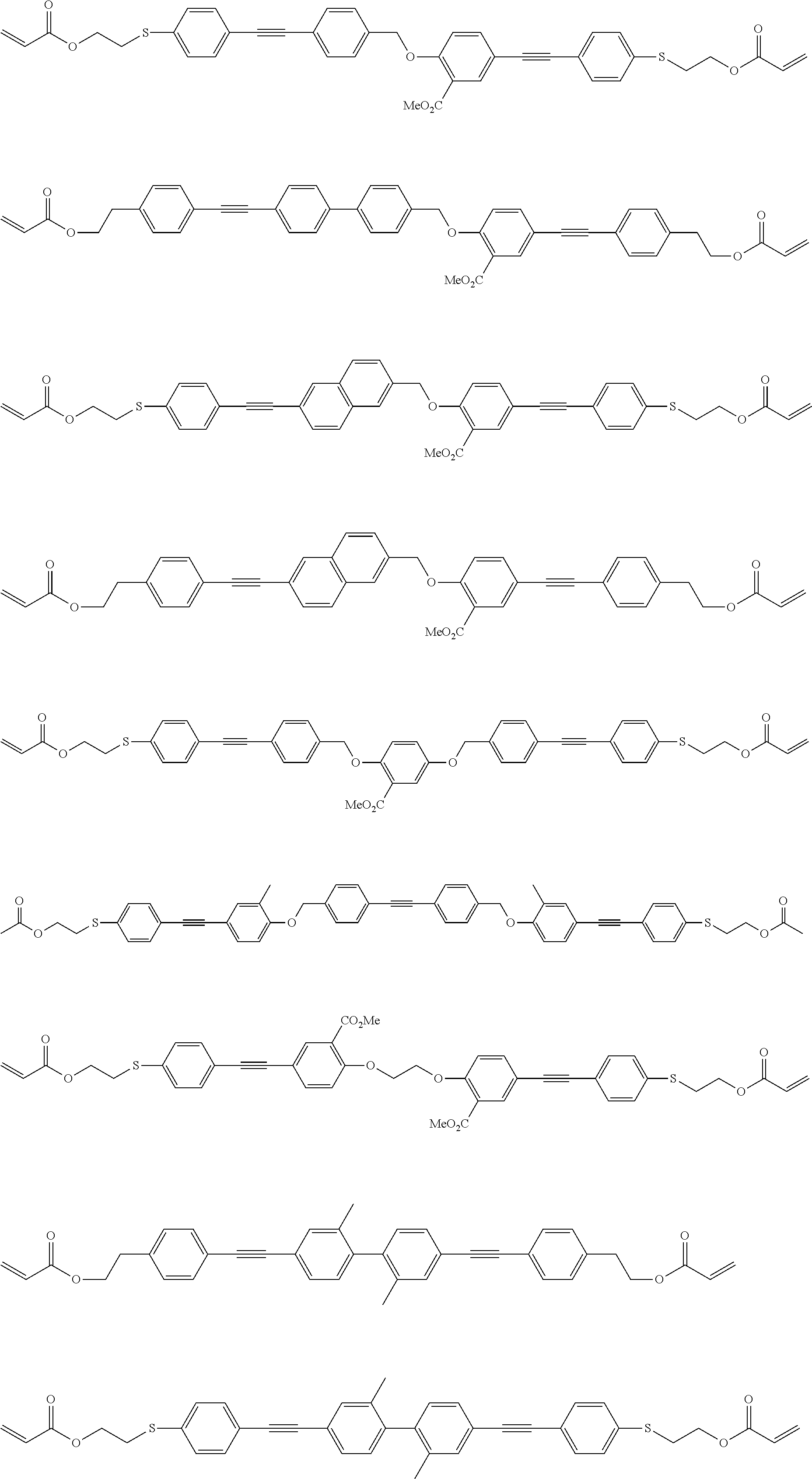

### ——Surfactant——

The liquid crystal composition used in forming the cholesteric liquid crystal layer may contain a surfactant. It is preferable that the surfactant is a compound which can function as an alignment control agent contributing to stable or rapid formation of the cholesteric liquid crystalline phase with planar alignment. Examples of the surfactant include a silicone-based surfactant and a fluorine-based surfactant, and preferred examples thereof include a fluorine-based surfactant.

Specific examples of the surfactant include compounds described in paragraphs [0082] to [0090] of JP2014-119605A, compounds described in paragraphs [0031] to [0034] of JP2012-203237A, compounds exemplified in paragraphs [0092] and [0093] of JP2005-99248A, compounds exemplified in paragraphs [0076] to [0078] and paragraphs [0082] to [0085] of JP2002-129162A, and fluorine (meth)acrylate polymers described in paragraphs [0018] to [0043] and the like of JP2007-272185A. The surfactant may be used alone or in combination of two or more kinds thereof.

As the fluorine-based surfactant, the compounds described in paragraphs [0082] to [0090] of JP2014-119605A are preferable.

An amount of the surfactant added to the liquid crystal composition is preferably 0.01% to 10% by mass, more preferably 0.01% to 5% by mass, and still more preferably 0.02% to 1% by mass with respect to the total mass of the liquid crystal compound.

### ——Chiral Agent (Optically Active Compound)——

The chiral agent has a function of inducing the helical structure of the cholesteric liquid crystalline phase. The chiral agent may be selected according to the purpose because a helical twisted direction or a helical pitch of the induced helix varies depending on the compound. The chiral agent is not particularly limited, and a known compound (for example, described in “Liquid Crystal Device Handbook”, Chapter 3, Section 4-3, chiral agent for twisted nematic (TN) and super-twisted nematic (STN), p. 199, Japan Society for the Promotion of Science edited by the 142nd committee, 1989), a derivative of isosorbide, isomannide, and the like can be used. The chiral agent generally includes an asymmetric carbon atom, but an axially asymmetric compound or a planar asymmetric compound, including no asymmetric carbon atom, can also be used as the chiral agent. Examples of the axially asymmetric compound or the planar asymmetric compound include binaphthyl, helicene, paracyclophane, and derivatives thereof. The chiral agent may also have a polymerizable group. In a case where both the chiral agent and the liquid crystal compound have a polymerizable group, a polymer having a repeating unit induced from the polymerizable liquid crystal compound and a repeating unit induced from the chiral agent can be formed by a polymerization reaction between the polymerizable chiral agent and the polymerizable liquid crystal compound. In this aspect, the polymerizable group in the polymerizable chiral agent is preferably the same group as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent has a photoisomerization group, a pattern having a desired reflection wavelength corresponding to a luminescence wavelength can be formed by irradiation with actinic ray or the like through a photo mask after coating and alignment, which is preferable. As the photoisomerization group, an isomerization site of a compound exhibiting photochromic properties, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, JP2003-313292A, and the like.

### —Photoreactive Chiral Agent—

A photoreactive chiral agent contains, for example, a compound represented by General Formula (I), and has properties capable of controlling an aligned structure of the liquid crystal compound and changing a helical pitch of liquid crystal, that is, a helical twisting power (HTP) of a helical structure during light irradiation. That is, the photoreactive chiral agent is a compound which causes a helical twisting power of a helical structure derived from a liquid crystal compound, preferably, a nematic liquid crystal compound to change during light irradiation (ultraviolet rays to visible rays to infrared rays), and includes a chiral portion and a portion in which a structural change occurs during the light irradiation as required portions (molecular structural units). Moreover, the photoreactive chiral agent represented by General Formula (I) can significantly change the HTP of liquid crystal molecules.

The above-described HTP represents a helical twisting power of a helical structure of liquid crystals, that is, HTP=1/(Pitch×Concentration of chiral agent [mass fraction]). For example, the HTP can be obtained by measuring a helical pitch (single period of the helical structure; μm) of a liquid crystal molecule at a certain temperature and converting the measured value into a value [μm⁻¹] in terms of the concentration of the chiral agent. In a case where a selective reflection color is formed by irradiation of light by use of the photoreactive chiral agent, a rate of change in HTP (=HTP before irradiation/HTP after irradiation) is preferably 1.5 or more and more preferably 2.5 or more in a case where the HTP decreases after the irradiation, and is preferably 0.7 or less and more preferably 0.4 or less in a case where the HTP increases after the irradiation.

Next, the compound represented by General Formula (I) will be described.

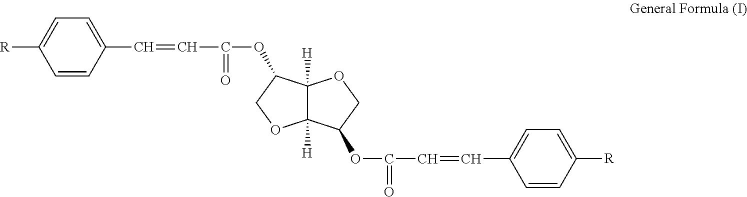

In the formula, R represents a hydrogen atom, an alkoxy group having 1 to 15 carbon atoms, an acryloyloxyalkyloxy group having 3 to 15 carbon atoms in total, or a methacryloyloxyalkyloxy group having 4 to 15 carbon atoms in total. Examples of the above-described alkoxy group having 1 to 15 carbon atoms include a methoxy group, an ethoxy group, a propoxy group, a butoxy group, a hexyloxy group, and a dodecyloxy group; and among these, an alkoxy group having 1 to 12 carbon atoms is preferable, and an alkoxy group having 1 to 8 carbon atoms is more preferable.

Examples of the above-described acryloyloxyalkyloxy group having 3 to 15 carbon atoms in total include an acryloyloxyethyloxy group, an acryloyloxybutyloxy group, and an acryloyloxydecyloxy group; and among these, an acryloyloxyalkyloxy group having 5 to 13 carbon atoms is preferable, and an acryloyloxyalkyloxy group having 5 to 11 carbon atoms is more preferable.

Examples of the above-described methacryloyloxyalkyloxy group having 4 to 15 carbon atoms in total include a methacryloyloxyethyloxy group, a methacryloyloxybutyloxy group, and a methacryloyloxydecyloxy group; and among these, a methacryloyloxyalkyloxy group having 6 to 14 carbon atoms is preferable, and a methacryloyloxyalkyloxy group having 6 to 12 carbon atoms is more preferable.

A molecular weight of the photoreactive chiral agent represented by General Formula (I) is preferably 300 or more. In addition, a photoreactive chiral agent having high solubility in the liquid crystal compound described later is preferable, and a photoreactive chiral agent having a solubility parameter SP value close to that of the liquid crystal compound is more preferable.

Hereinafter, specific examples (exemplary compounds (1) to (15)) of the compound represented by General Formula (I) are shown below, but the present invention is not limited thereto.

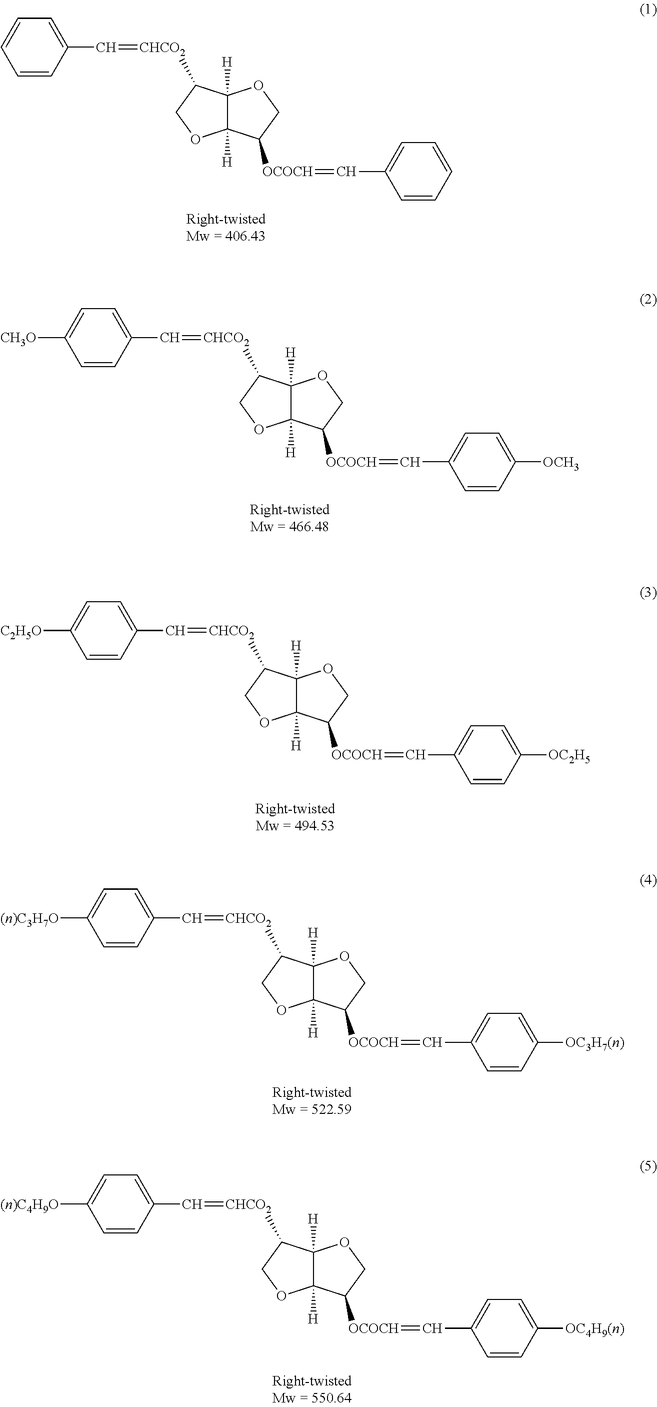

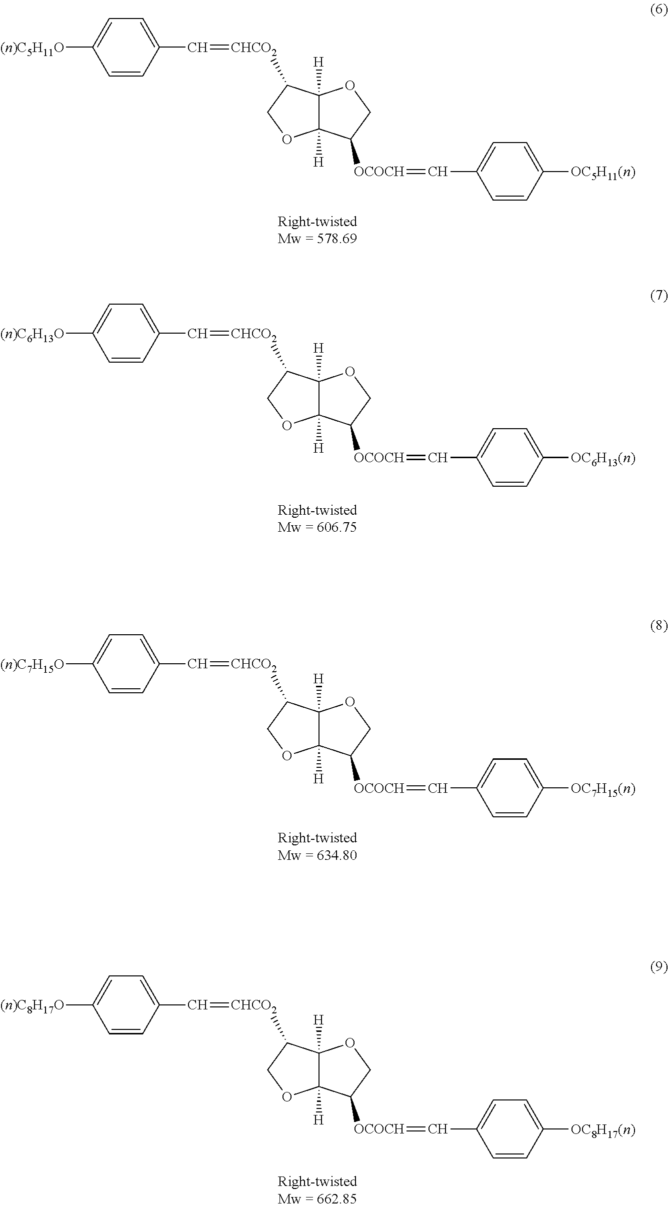

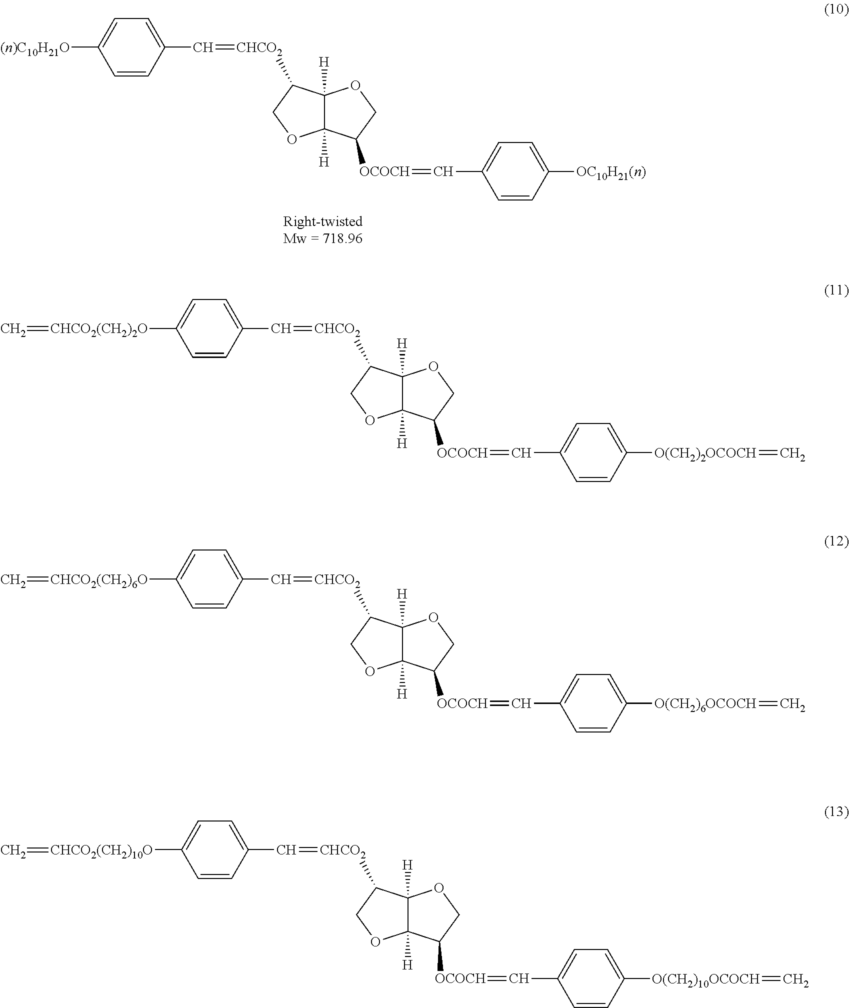

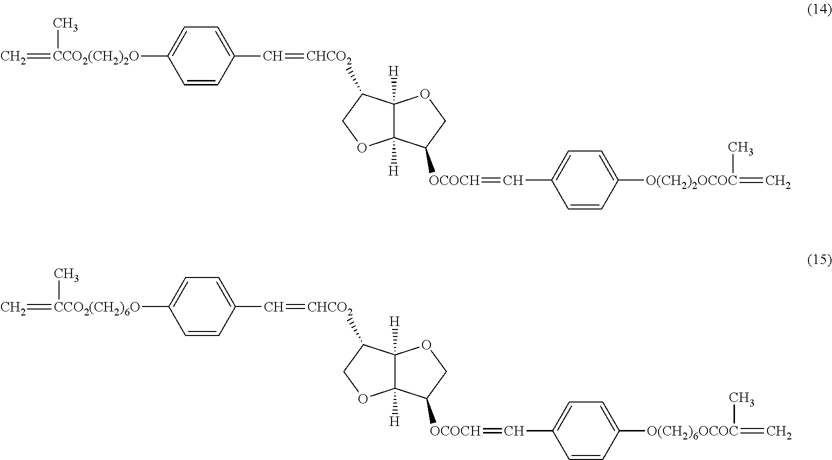

As the photoreactive chiral agent, for example, a compound represented by General Formula (II) is also used.

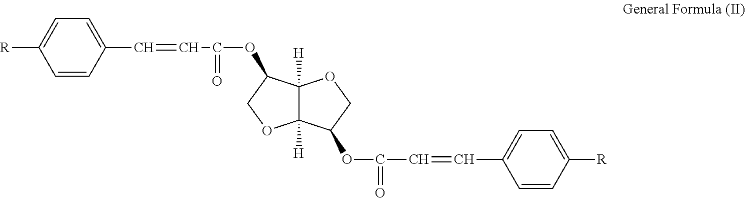

In the formula, R represents a hydrogen atom, an alkoxy group having 1 to 15 carbon atoms, an acryloyloxyalkyloxy group having 3 to 15 carbon atoms in total, or a methacryloyloxyalkyloxy group having 4 to 15 carbon atoms in total. Examples of the above-described alkoxy group having 1 to 15 carbon atoms include a methoxy group, an ethoxy group, a propoxy group, a butoxy group, a hexyloxy group, an octyloxy group, and a dodecyloxy group; and among these, an alkoxy group having 1 to 10 carbon atoms is preferable, and an alkoxy group having 1 to 8 carbon atoms is more preferable.

Examples of the above-described acryloyloxyalkyloxy group having 3 to 15 carbon atoms in total include an acryloyloxy group, an acryloyloxyethyloxy group, an acryloyloxypropyloxy group, an acryloyloxyhexyloxy group, an acryloyloxybutyloxy group, and an acryloyloxydecyloxy group; and among these, an acryloyloxyalkyloxy group having 3 to 13 carbon atoms is preferable, and an acryloyloxyalkyloxy group having 3 to 11 carbon atoms is more preferable.

Examples of the above-described methacryloyloxyalkyloxy group having 4 to 15 carbon atoms in total include a methacryloyloxy group, a methacryloyloxyethyloxy group, and a methacryloyloxyhexyloxy group; and among these, a methacryloyloxyalkyloxy group having 4 to 14 carbon atoms is preferable, and a methacryloyloxyalkyloxy group having 4 to 12 carbon atoms is more preferable.

A molecular weight of the photoreactive chiral agent represented by General Formula (II) is preferably 300 or more. In addition, a photoreactive optically active compound having high solubility in the liquid crystal compound described later is preferable, and a photoreactive optically active compound having a solubility parameter SP value close to that of the liquid crystal compound is more preferable.

Hereinafter, specific examples (exemplary compounds (21) to (32)) of the photoreactive chiral agent represented by General Formula (II) are shown below, but the present invention is not limited thereto.

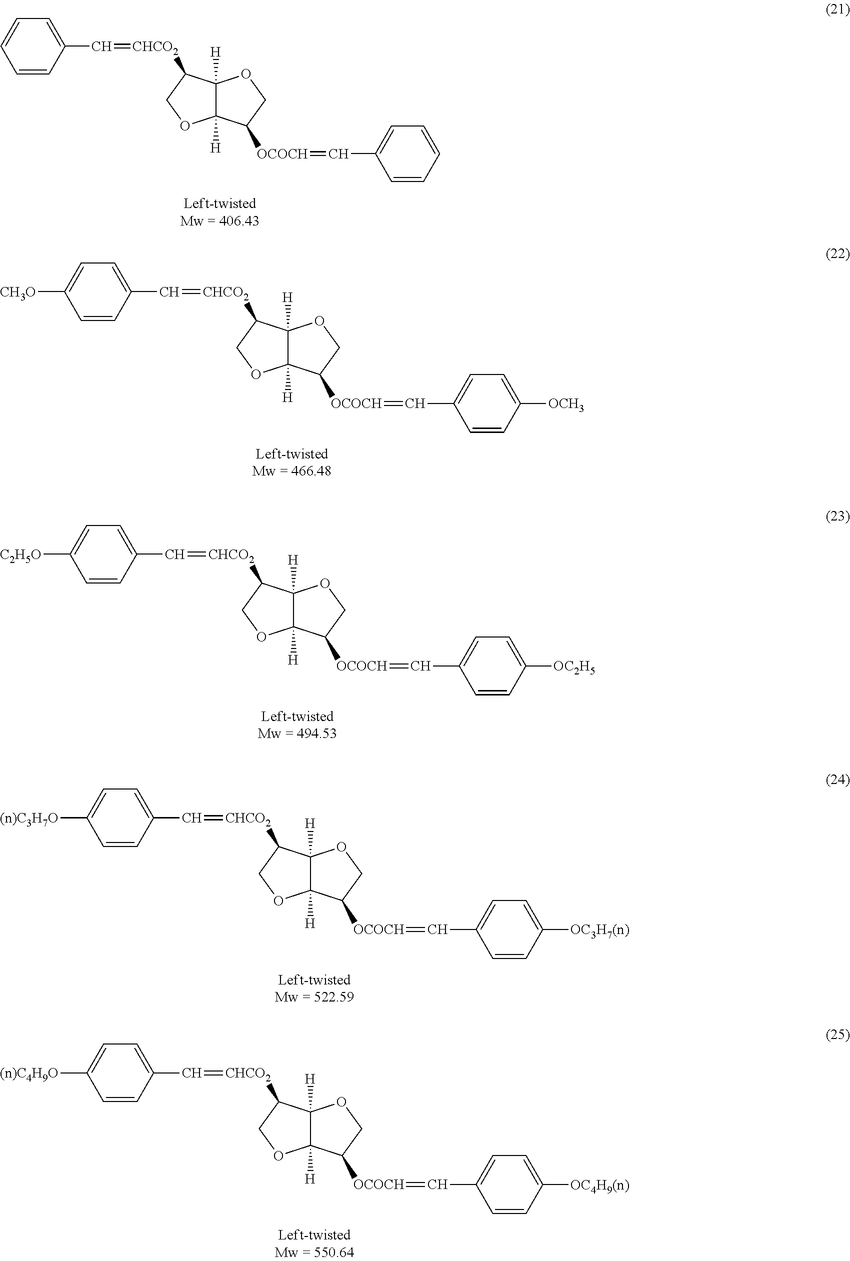

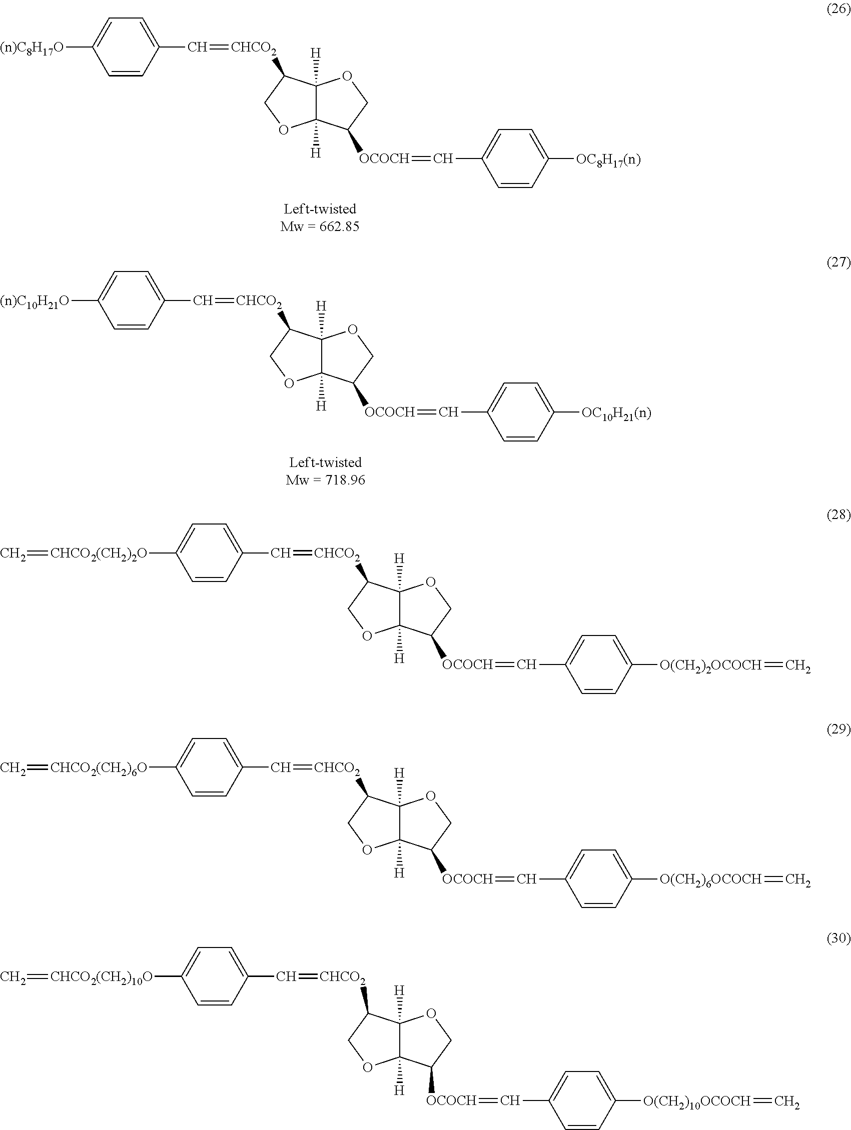

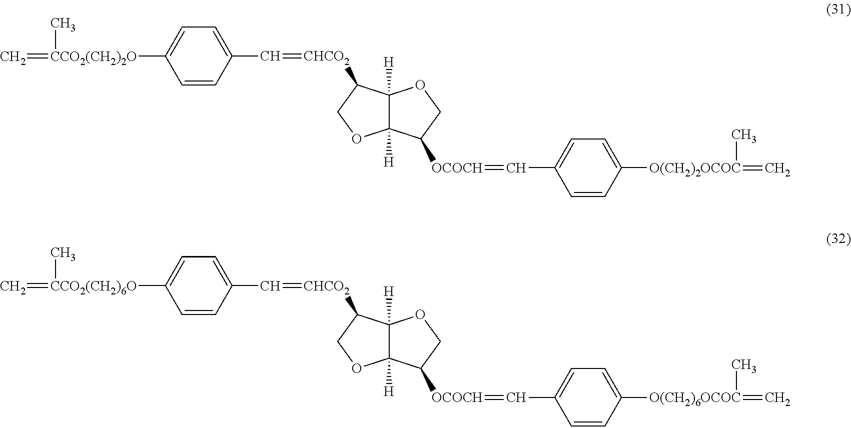

In addition, the photoreactive chiral agent can also be used in combination with a chiral agent having no photoreactivity, such as a chiral compound having a large temperature dependence of the helical twisting power. Examples of known chiral agents having no photoreactivity include chiral agents described in JP2000-44451A, JP1998-509726A (JP-H10-509726A), WO98/00428A, JP2000-506873A, JP1997-506088A (JP-H9-506088A), Liquid Crystals (1996, 21, 327), Liquid Crystals (1998, 24, 219), and the like.

A content of the chiral agent in the liquid crystal composition is preferably 0.01 to 200 mol % and more preferably 1 to 30 mol % with respect to the contained molar amount of the liquid crystal compound.

### ——Polymerization Initiator——

In a case where the liquid crystal composition contains a polymerizable compound, it is preferable that the liquid crystal composition contains a polymerization initiator. In an aspect in which the polymerization reaction proceeds by ultraviolet irradiation, the polymerization initiator to be used is preferably a photopolymerization initiator capable of initiating a polymerization reaction by irradiation with ultraviolet rays. Examples of the photopolymerization initiator include α-carbonyl compounds (described in U.S. Pat. Nos. 2,367,661A and 2,367,670A), acyloin ether (described in U.S. Pat. No. 2,448,828A), α-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine compounds and phenazine compounds (described in JP1985-105667A (JP-S60-105667A) and U.S. Pat. No. 4,239,850A), and oxadiazole compounds (described in U.S. Pat. No. 4,212,970A). A content of the photopolymerization initiator in the liquid crystal composition is preferably 0.1% to 20% by mass, and more preferably 0.5% to 12% by mass with respect to the content of the liquid crystal compound.

### ——Crosslinking Agent——

The liquid crystal composition may optionally contain a crosslinking agent in order to improve film hardness and durability after curing. As the crosslinking agent, a crosslinking agent which cures the liquid crystal composition with ultraviolet rays, heat, humidity, and the like can be suitably used. The crosslinking agent is not particularly limited and can be appropriately selected according to the purpose, and examples thereof include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol-tris [3-(1-aziridinyl) propionate] and 4,4-bis(ethyleneiminocarbonylamino); isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a known catalyst can be used depending on reactivity of the crosslinking agent, and in addition to improving the film hardness and durability, productivity can be improved.

These may be used alone or in combination of two or more kinds thereof. A content of the crosslinking agent is preferably 3% to 20% by mass, and more preferably 5% to 15% by mass with respect to the mass of solid content of the liquid crystal composition. In a case where the content of the crosslinking agent is within the above-described range, an effect of improving crosslinking density can be easily obtained, and stability of the cholesteric liquid crystalline phase is further improved.

### ——Other Additives——

As necessary, a polymerization inhibitor, an antioxidant, an ultraviolet absorber, a light stabilizer, a coloring material, metal oxide fine particles, and the like can be further added to the liquid crystal composition as long as the optical performance or the like is not degraded. From the viewpoint of increasing the viewing angle of AR display, high refractive index nanoparticles such as zirconia oxide nanoparticles and titanium oxide nanoparticles can be further added.

The liquid crystal composition is preferably used as a liquid in forming the cholesteric liquid crystal layer. The liquid crystal composition may contain a solvent. The solvent is not limited and can be appropriately selected according to the purpose, but an organic solvent is preferable. The organic solvent is not limited and may be appropriately selected according to the purpose, and examples thereof include ketones, alkyl halides, amides, sulfoxides, heterocyclic compounds, hydrocarbons, esters, and ethers.

These may be used alone or in combination of two or more kinds thereof. Among these, in consideration of environmental load, ketones are preferable.

In a case of forming the cholesteric liquid crystal layer, it is preferable that the cholesteric liquid crystal layer is formed by applying the liquid crystal composition to a surface where the cholesteric liquid crystal layer is to be formed, aligning the liquid crystal compound to a state of the cholesteric liquid crystalline phase, and then curing the liquid crystal compound. That is, in a case where the cholesteric liquid crystal layer is formed on the alignment film, it is preferable that the liquid crystal composition is applied onto the alignment film, the liquid crystal compound is aligned in a state of the cholesteric liquid crystalline phase, and then the liquid crystal compound is cured to form the cholesteric liquid crystal layer in which the cholesteric liquid crystalline phase is immobilized. For the application of the liquid crystal composition, any known method capable of uniformly applying a liquid onto a sheet-like material, such as printing methods such as ink jet and scroll printing, spin coating, bar coating, and spray coating, can be used.

The applied liquid crystal composition is dried and/or heated as necessary, and then is cured to form the cholesteric liquid crystal layer. In the drying and/or heating step, the liquid crystal compound in the liquid crystal composition may be aligned to the cholesteric liquid crystalline phase. In a case of heating, a heating temperature is preferably 200° C. or lower, and more preferably 130° C. or lower.

The aligned liquid crystal compound is further polymerized as necessary. The polymerization may be thermal polymerization or photopolymerization by light irradiation, but photopolymerization is preferable. It is preferable to use ultraviolet rays for the light irradiation. An irradiation energy is preferably 20 mJ/cm² to 50 J/cm² and more preferably 50 to 1,500 mJ/cm². In order to promote the photopolymerization reaction, the light irradiation may be performed under heating conditions or in a nitrogen atmosphere. A wavelength of the ultraviolet rays to be emitted is preferably 250 to 430 nm.

A thickness of the cholesteric liquid crystal layer is not particularly limited, and the thickness with which a required light reflectivity can be obtained may be appropriately set depending on the use of the liquid crystal diffraction element 10, the light reflectivity required for the optically-anisotropic layer, the material for forming the optically-anisotropic layer, and the like.

### <<Liquid Crystal Alignment Pattern of Cholesteric Liquid Crystal Layer>>

As described above, in the liquid crystal diffraction element 10, the cholesteric liquid crystal layer has a liquid crystal alignment pattern in which the orientation of the optical axis 30A derived from the liquid crystal compound 30 changes while continuously rotating in one in-plane direction of the cholesteric liquid crystal layer. In the example shown in FIG. 1, the cholesteric liquid crystal layer has a liquid crystal alignment pattern in which the orientation of the optical axis 30A derived from the liquid crystal compound 30 forming the cholesteric liquid crystalline phase changes while continuously rotating in one in-plane direction of the cholesteric liquid crystal layer. The optical axis 30A derived from the liquid crystal compound 30 is an axis having the highest refractive index in the liquid crystal compound 30, that is, a so-called slow axis. For example, in a case where the liquid crystal compound 30 is a rod-like liquid crystal compound, the optical axis 30A is along a major axis direction of the rod shape. In the following description, the optical axis 30A derived from the liquid crystal compound 30 will also be referred to as “optical axis 30A of the liquid crystal compound 30” or “optical axis 30A”.

FIG. 2 conceptually shows a plan view of the cholesteric liquid crystal layer 18 shown in FIG. 1. The plan view is a view in a case where the liquid crystal diffraction element 10 is seen from the top in FIG. 1, that is, a view in a case where the liquid crystal diffraction element 10 is seen from the thickness direction (laminating direction of the respective layers (films)).

In addition, in FIG. 2, in order to clarify the configuration of the cholesteric liquid crystal layer 18, only a liquid crystal compound 30 on a surface of the alignment film 24 is shown with regard to the liquid crystal compound 30.

As shown in FIG. 2, on the surface of the alignment film 24, the liquid crystal compound 30 forming the cholesteric liquid crystal layer 18 is two-dimensionally arranged according to the alignment pattern formed on the alignment film 24 as a lower layer, in a predetermined one direction indicated by an arrow X and a direction orthogonal to the one direction (arrow X direction). In the following description, a direction orthogonal to the arrow X direction will be referred to as a Y direction, for convenience of description.

That is, in FIGS. 1 and 4, and FIGS. 7, 9, and 10 described later, the Y direction is a direction perpendicular to the paper plane. In addition, the liquid crystal compound 30 forming the cholesteric liquid crystal layer 18 has the liquid crystal alignment pattern in which the orientation of the optical axis 30A changes while continuously rotating in the arrow X direction in a plane of the cholesteric liquid crystal layer 18. In the example shown in FIGS. 1 and 2, the liquid crystal compound 30 has the liquid crystal alignment pattern in which the optical axis 30A of the liquid crystal compound 30 changes while continuously rotating clockwise in the arrow X direction.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or to θ−180° in the arrow X direction.

A difference between the angles of the optical axes 30A of the liquid crystal compounds 30 adjacent to each other in the arrow X direction is preferably 45° or less, more preferably 15° or less, and still more preferably less than 15°.

On the other hand, in the liquid crystal compound 30 forming the cholesteric liquid crystal layer 18, orientations of the optical axes 30A are the same in the Y direction orthogonal to the arrow X direction, that is, the Y direction orthogonal to the one direction in which the optical axis 30A continuously rotates. In other words, in the liquid crystal compound 30 forming the cholesteric liquid crystal layer 18, angles between the optical axes 30A of the liquid crystal compound 30 and the arrow X direction are the same in the Y direction.

In such a liquid crystal alignment pattern of the liquid crystal compound 30 according to the present invention, a length (distance) over which the optical axis 30A of the liquid crystal compound 30 rotates 180° in the arrow X direction, in which the optical axis 30A changes while continuously rotating in a plane, is defined as a length A of the single period in the liquid crystal alignment pattern. That is, in the arrow X direction, a distance between centers of two liquid crystal compounds 30 having the same angle with respect to the arrow X direction is set as the length A of the single period. Specifically, as shown in FIG. 2, the distance between the centers of two liquid crystal compounds 30 in which the arrow X direction and the direction of the optical axis 30A coincide with each other in the arrow X direction is set as the length A of the single period. In the description below, the length A of the single period is also referred to as “single period A”. In the liquid crystal alignment pattern of the cholesteric liquid crystal layer 18 in the liquid crystal diffraction element 10, the single period A is repeated in the arrow X direction, that is, in the one direction in which the orientation of the optical axis 30A changes while continuously rotating.

In a case where an X-Z plane of the cholesteric liquid crystal layer 18 having the liquid crystal alignment pattern in which the orientation of the optical axis 30A derived from the liquid crystal compound 30 changes while continuously rotating as in the liquid crystal diffraction element 10 shown in FIG. 1 is observed with a scanning electron microscope (SEM), a stripe pattern that an arrangement direction in which bright portions 42 and dark portions 44 are alternately arranged as conceptually shown in FIG. 26 is tilted at a predetermined angle with respect to the main surface (X-Y plane) is observed.

In the following description, the cholesteric liquid crystal layer 18 will also be referred to as a liquid crystal layer 18.

In the SEM cross section, an interval of lines between the bright portions 42 adjacent to each other or lines between the dark portions 44 adjacent to each other in a normal direction corresponds to a ½ slope pitch. In a case where the optical axis 30A of the liquid crystal compound 30 is aligned to be parallel to the main surface (X-Y plane) of the liquid crystal layer 18, as described above, one helical pitch is the pitch P shown in FIG. 1. On the other hand, in a case where the liquid crystal compound 30 is tilted with respect to the main surface of the liquid crystal layer 18, in particular, in a case where a tilt angle of the liquid crystal compound 30 with respect to the main surface of the liquid crystal layer 18 is equal to the angle between the line formed by the bright portions 42 or the dark portions 44 and the main surface of the liquid crystal layer 18, as shown by P in FIG. 26, the bright portions 42 and the dark portions 44 correspond to one helical pitch (one turn of the helix) of two bright portions 42 and two dark portions 44.

Here, the example shown in FIG. 1 shows the configuration in which, in the X-Z plane of the liquid crystal layer 18, the optical axis 30A of the liquid crystal compound 30 is aligned to be parallel to the main surface (X-Y plane). However, the present invention is not limited to the configuration. For example, as shown in FIG. 27, a configuration in which, in the X-Z plane of the liquid crystal layer 18, the optical axis 30A of the liquid crystal compound 30 is aligned to be tilted with respect to the main surface (X-Y plane) may be adopted.

In addition, the example shown in FIG. 27 shows the configuration in which, in the X-Z plane of the liquid crystal layer 18, the inclined angle (tilt angle) of the liquid crystal compound 30 with respect to the main surface (X-Y plane) is uniform in the thickness direction (Z direction). However, the present invention is not limited to the configuration. In the liquid crystal layer 18, a region in which the tilt angle of the liquid crystal compound 30 varies in the thickness direction may be provided.

For example, in an example shown in FIG. 28, the optical axis 30A of the liquid crystal compound 30 at an interface of the liquid crystal layer 18 on the alignment film 24 side is parallel to the main surface (a pretilt angle is) 0°, the tilt angle of the liquid crystal compound 30 increases in a direction away from the interface on the alignment film 24 side to the thickness direction, and the liquid crystal compound 30 is aligned at a constant tilt angle on another interface (air interface).

In this way, the liquid crystal layer 18 may have a configuration in which the optical axis 30A of the liquid crystal compound 30 has a pretilt angle at one interface among the upper and lower interfaces, or may have a pretilt angle at both of the interfaces. In addition, the pretilt angle may be different between both interfaces.

Since the liquid crystal compound 30 has a tilt angle (is tilted), in a case where light is diffracted, the effective birefringence index of the liquid crystal compound increases, and the diffraction efficiency can be improved. In addition, in a case where light is diffracted, the effective refractive index of the liquid crystal compound increases, and the FOV can be widened, for example, in a case of being used for AR glasses.

An average angle (average tilt angle) between the optical axis 30A of the liquid crystal compound 30 and the main surface (X-Y plane) is preferably 5° to 80° and more preferably 10° to 50°. The average tilt angle can be measured by observing the X-Z plane of the liquid crystal layer 18 with a polarization microscope. In particular, it is preferable that, in the X-Z plane of the liquid crystal layer 18, the optical axis 30A of the liquid crystal compound 30 is aligned to be tilted with respect to the main surface (X-Y plane) in the same direction.

In a case where the cross section of the cholesteric liquid crystal layer is observed with a polarization microscope, the above-described tilt angle is a value obtained by measuring the angle between the optical axis 30A of the liquid crystal compound 30 and the main surface at any five or more positions and obtaining an average value thereof.

Light which is vertically incident into the liquid crystal diffraction element (liquid crystal layer 18) travels obliquely in an oblique direction in the liquid crystal layer 18 along with a deflecting force. In a case where light travels in the liquid crystal layer 18, diffraction loss is originally generated due to a deviation from conditions such as a diffraction period which are set to obtain a desired diffraction angle with respect to the vertically incident light.

In a case where the liquid crystal compound 30 is tilted, an orientation in which a higher birefringence index is generated with respect to an orientation in which the light is diffracted is present, as compared to a case where the liquid crystal compound is not tilted.

In this direction, the effective extraordinary refractive index increases, and thus the birefringence index as a difference between the extraordinary refractive index and the ordinary refractive index increases.

By setting the orientation of the tilt angle according to the desired diffraction orientation, a deviation from the original diffraction conditions in the orientation can be suppressed. As a result, it is considered that, in a case where the liquid crystal compound having a tilt angle is used, a higher diffraction efficiency can be obtained.

In addition, the tilt angle may be controlled by treating the interface of the liquid crystal layer 18. By pre-tilting the alignment film at the interface on the support side, the tilt angle of the liquid crystal compound 30 can be controlled. For example, during the formation of the alignment film, by exposing the alignment film to ultraviolet light from the front and subsequently obliquely exposing the alignment film, the liquid crystal compound 30 in the liquid crystal layer 18 formed on the alignment film can be made to have a pretilt angle. In this case, the liquid crystal compound 30 is pre-tilted in a direction in which a single axis side of the liquid crystal compound 30 can be seen with respect to the second irradiation direction. Since the liquid crystal compound 30 having an orientation in a direction perpendicular to the second irradiation direction is not pre-tilted, a region in which the liquid crystal compound 30 is pre-tilted and a region in which the liquid crystal compound 30 is not pre-tilted are present. This configuration is suitable for improving the diffraction efficiency because it contributes to the most improvement of birefringence in the desired direction in a case where light is diffracted in the direction.

Furthermore, an additive for promoting the pretilt angle can also be added to the liquid crystal layer 18 or to the alignment film. In this case, the additive can be used as a factor for further improving the diffraction efficiency.

The additive can also be used for controlling the pretilt angle at the interface on the air side.

Here, in the cross section of the liquid crystal layer 18 observed with the SEM, the bright portions 42 and the dark portions 44 derived from the cholesteric liquid crystalline phase are tilted with respect to the main surface. In a case where a retardation is measured from a normal direction and a direction inclined with respect to the normal direction, it is preferable that, in the liquid crystal layer 18, a direction in which the retardation is minimum in any of a slow axis plane or a fast axis plane is tilted from the normal direction. Specifically, it is preferable that an absolute value of a measurement angle between the normal line and the direction in which the retardation is minimum is 5° or more. In other words, it is preferable that the liquid crystal compound 30 of the liquid crystal layer 18 is tilted with respect to the main surface, and the tilt direction substantially matches the bright portions 42 and the dark portions 44 of the liquid crystal layer 18. The normal direction means a direction orthogonal to the main surface.

By the configuration of the liquid crystal layer 18, circularly polarized light can be diffracted with a higher diffraction efficiency than the liquid crystal layer in which the liquid crystal compound 30 is parallel to the main surface.

In the configuration in which the liquid crystal compound 30 of the liquid crystal layer 18 is tilted with respect to the main surface and the tilt direction substantially matches with the bright portions 42 and the dark portions 44, bright portions and dark portions corresponding to a reflecting surface match with the optical axis 30A of the liquid crystal compound 30. Therefore, the action of the liquid crystal compound on the reflection (diffraction) of light increases, and thus the diffraction efficiency can be improved. As a result, the light amount of the reflected light with respect to the incident light can be further improved.

In the fast axis plane or the slow axis plane of the liquid crystal layer 18, the absolute value of the tilt angle of the optical axis in the liquid crystal layer 18 is preferably 5° or more, more preferably 15° or more, and still more preferably 20° or more.

From the viewpoint that the direction of the liquid crystal compound 30 matches the bright portions and the dark portions more suitably such that the diffraction efficiency can be improved, it is preferable that the absolute value of the tilt angle of the optical axis is 15° or more.

A typical cholesteric liquid crystal layer formed by immobilizing the cholesteric liquid crystalline phase normally reflects incident light (circularly polarized light) by specular reflection. On the other hand, the cholesteric liquid crystal layer 18 having the above-described liquid crystal alignment pattern reflects incident light in a direction having an angle in the arrow X direction with respect to the specular reflection. For example, the cholesteric liquid crystal layer 18 does not reflect, in the normal direction, the light which has been incident from the normal direction, but reflects the light by inclining the light to the arrow X with respect to the normal direction. The light incident from the normal direction refers to light incident from the front side, that is, light incident to be perpendicular to the main surface. The main surface refers to the maximum surface of the sheet-shaped material.

Hereinafter, the description will be made with reference to FIG. 4.

As described above, the cholesteric liquid crystal layer 18 selectively reflects one circularly polarized light in a selective reflection wavelength. For example, assuming that the selective reflection wavelength of the cholesteric liquid crystal layer 18 is red light and dextrorotatory circularly polarized light is reflected, in a case where a light R_{R} is incident into the cholesteric liquid crystal layer 18, the cholesteric liquid crystal layer 18 reflects only the dextrorotatory circularly polarized red light R_{R} and transmits the other light.

Here, a reflection angle of light from the cholesteric liquid crystal layer, in which the optical axis 30A of the liquid crystal compound 30 continuously rotates in one direction (arrow X direction), varies depending on wavelengths of light to be reflected. Specifically, as the wavelength of light increases, the angle of reflected light with respect to the incident light increases. In addition, a reflection angle of light from the cholesteric liquid crystal layer, in which the optical axis 30A of the liquid crystal compound 30 continuously rotates in the arrow X direction (one direction), varies depending on the length A of the single period of the liquid crystal alignment pattern, over which the optical axis 30A rotates by 180° in the arrow X direction, that is, depending on the single period A. Specifically, as the single period A decreases, the angle of reflected light with respect to the incident light increases.

In the liquid crystal diffraction element 10, the single period A in the alignment pattern of the cholesteric liquid crystal layer is not particularly limited, and may be appropriately set depending on the use of the liquid crystal diffraction element 10, and the like.

Here, the liquid crystal diffraction element 10 can be suitably used as, for example, a diffraction element which reflects light propagated in a light guide plate in AR glasses to be emitted to an observation position by a user from the light guide plate.

In this case, in order to reliably emit the light propagated in the light guide plate, it is necessary to reflect the light at a large angle to some degree with respect to the incident light. In addition, as described above, the reflection angle of light from the cholesteric liquid crystal layer with respect to the incident light can be increased by reducing the single period A in the liquid crystal alignment pattern.

In consideration of this point, the single period A in the liquid crystal alignment pattern of the cholesteric liquid crystal layer is preferably 50 μm or less, more preferably 10 μm or less, and still more preferably 1 μm or less. In consideration of the accuracy of the liquid crystal alignment pattern, and the like, the single period A in the liquid crystal alignment pattern of the cholesteric liquid crystal layer is preferably 0.1 μm or more.

Here, in the present invention, it is preferable that the cholesteric liquid crystal layer has a configuration in which the diffraction efficiency increases from one side to the other side in one direction in which the orientation of the optical axis derived from the liquid crystal compound continuously rotates (hereinafter, referred to as one direction in which the optical axis rotates).

For example, in the cholesteric liquid crystal layer shown in FIGS. 1 and 2, the diffraction efficiency increases from one side to the other side in the X direction.

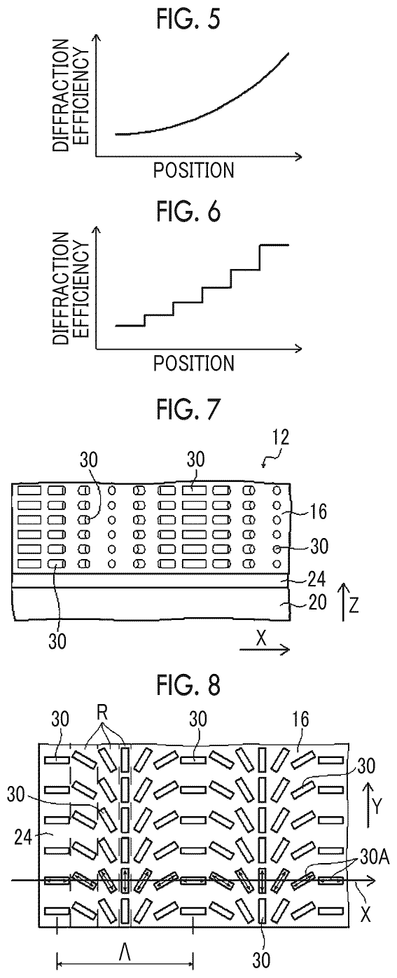

FIGS. 5 and 6 show a relationship between a position of the cholesteric liquid crystal layer 18 in the one direction (X direction) in which the optical axis rotates and a diffraction efficiency at the position as a schematic graph.

In the X direction, the diffraction efficiency of the cholesteric liquid crystal layer 18 may be configured to continuously change as shown in FIG. 5, or may be configured to change stepwise as shown in FIG. 6.

Here, regarding the diffraction efficiency, the cholesteric liquid crystal layer 18 is transferred to a dove prism 110 (refractive index=1.517, slope angle=) 45° as shown in FIG. 14, laser light having a predetermined wavelength is caused to transmit through a linear polarizer 112 and a λ/4 plate 114 to be converted into dextrorotatory circularly polarized light, and the dextrorotatory circularly polarized light is caused to be incident into the surface of the cholesteric liquid crystal layer 18 with an angle set such that diffracted light is emitted vertically from the slope. An emitted light intensity Lr is measured using Power Meter 1918-C manufactured by Newport Corporation, and a ratio (Lr/Li×100[%]) of the emitted light intensity Lr to an incident light intensity Li is obtained as the diffraction efficiency.

It is preferable that the liquid crystal diffraction element has a configuration in which the cholesteric liquid crystal layer has a diffraction efficiency which increases from one side to the other side in the one direction in which the optical axis rotates. That is, it is preferable that the region A and/or the region B of the optically-anisotropic layer, and further a region C described later has a configuration in which the diffraction efficiency increases from one side to the other side in the one direction in which the optical axis rotates. As a result, in a light guide element used in an augmented reality (AR) display device such as AR glasses, in a case where the liquid crystal diffraction element is used as a diffraction element which diffracts light propagated in a light guide plate to be emitted from the light guide plate, even in a case where exit pupil expansion is performed, brightness (light amount) of light emitted from the light guide plate can be made uniform. This point will be described below.

In a case where a direction in which regions where the diffraction efficiency is constant in the cholesteric liquid crystal layer are arranged is defined as a change direction of the diffraction efficiency, the change direction of the diffraction efficiency may coincide with or may not coincide with the one direction in which the optical axis rotates. That is, the change direction of the diffraction efficiency may intersect the one direction in which the optical axis rotates. Even in the configuration in which the change direction of the diffraction efficiency intersects the one direction in which the optical axis rotates, the diffraction efficiency increases from one side to the other side in the one direction in which the optical axis rotates.

The cholesteric liquid crystal layer (at least one of the region A, the region B, or the region C) may have a configuration in which a region in which the diffraction efficiency is different in the in-plane direction is provided, a configuration in which the diffraction efficiency gradually changes in the one in-plane direction, or a configuration in which the diffraction efficiency gradually increases (or gradually decreases) in the one in-plane direction.

The configuration in which the diffraction efficiency of the cholesteric liquid crystal layer increases from one side to the other side in the one in-plane direction in which the orientation of the optical axis derived from the liquid crystal compound continuously rotates can be achieved by a cholesteric liquid crystal layer having any one of the following configurations (i) or (ii), and from the viewpoint that the optically-anisotropic layer is smooth, the configuration (ii) is preferable.
(i) A configuration in which a film thickness increases from one side to the other side in the one direction in which the optical axis rotates.
(ii) A configuration in which a thickness-direction retardation Rth increases from one side to the other side in the one direction in which the optical axis rotates.

In the cholesteric liquid crystal layer, the diffraction efficiency is high in a region where the film thickness is large, and the diffraction efficiency is low in a region where the film thickness is small. Therefore, by adopting the configuration in which the film thickness of the cholesteric liquid crystal layer increases from one side to the other side in the one direction in which the optical axis rotates, the diffraction efficiency can be changed.

As described above, in the cholesteric liquid crystal layer, the liquid crystal compound is arranged in a desired alignment pattern. In a region where the arrangement is not disordered, light can be appropriately diffracted, and thus the diffraction efficiency increases. In addition, in the region where the arrangement of the liquid crystal compound is not disordered, the thickness-direction retardation Rth increases. On the other hand, in a region where the arrangement of the liquid crystal compound is disordered, light is not likely to be appropriately diffracted, and thus the diffraction efficiency decreases. In addition, in the region where the arrangement of the liquid crystal compound is disordered, the thickness-direction retardation Rth decreases. Accordingly, by adopting the configuration in which the thickness-direction retardation Rth of the cholesteric liquid crystal layer increases from one side to the other side in the one direction in which the optical axis rotates, the diffraction efficiency can be changed. Examples of a method of forming such a cholesteric liquid crystal layer include a method described in WO2020/122119A.

A method of detecting that the region where the thickness-direction retardation Rth varies in a plane is provided depending on the position in the plane will be described. Since the oblique-direction retardation Re(40) is in a proportional relationship with the thickness-direction retardation Rth, it is possible to detect the region where the thickness-direction retardation Rth varies in a plane by confirming whether or not having a region where the oblique-direction retardation Re(40) varies in the plane. In addition, by confirming that the oblique-direction retardation Re(40) gradually changes in the plane, it is possible to detect that the thickness-direction retardation Rth gradually changes in the plane.

In addition, the cholesteric liquid crystal layer has a region having a large birefringence index and a region having a small birefringence index in the thickness direction, and has a configuration in which a ratio of a thickness of the region having a large birefringence index to the thickness of the cholesteric liquid crystal layer varies in a plane of the cholesteric liquid crystal layer, so that the diffraction efficiency can be changed. In the thickness direction of the cholesteric liquid crystal layer, as the ratio of the thickness of the region having a high birefringence index is higher, the diffraction efficiency increases, and as the ratio of the thickness of the region having a high birefringence index is lower, the diffraction efficiency decreases. In the thickness direction, a configuration in which the region having a small birefringence index includes an optically-isotropic region can be preferably used.

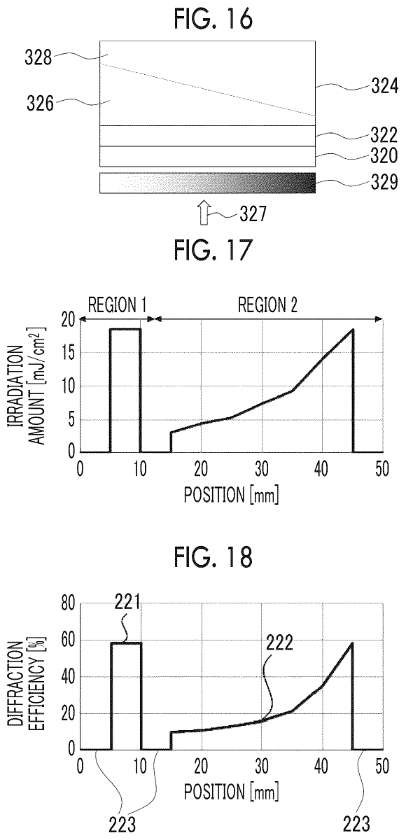

A method of detecting that the birefringence index varies depending on the position in the thickness direction at a certain position in the plane will be described with reference to FIG. 16. In the optically-anisotropic layer in which the liquid crystal compound is cholesterically aligned, in a case where an SEM image of an exposed optically-anisotropic layer 324 is analyzed by cutting an optically-anisotropic layer 324 in the thickness direction, bright portions and dark portions due to the cholesteric alignment of the liquid crystal compound are clearly shown in a region 326 having a high birefringence index. On the other hand, in a region 328 having a low birefringence index, a contrast between the bright portions and the dark portions is low, and particularly, in a case where the region 328 is optically isotropic, the bright portions and the dark portions are not visible. Therefore, by measuring a thickness of a region where the bright portions and the dark portions are clearly shown, the film thickness of the region having a high birefringence index can be obtained.

However, in a case where the liquid crystal compound is not cholesterically aligned and in a case where the birefringence index continuously changes in the thickness direction, it is difficult to measure the thickness of the region having a high birefringence index. In such cases, by etching a part of the optically-anisotropic layer, the ratio of the birefringence index Δn in the thickness direction can be obtained from a difference in oblique-direction retardation Re(40) before and after the etching. For example, a process of obtaining the oblique-direction retardation Re(40) using Axoscan (manufactured by Axometrics, Inc.) and then performing an etching treatment of 100 nm from the surface of the optically-anisotropic layer is repeated until the optically-anisotropic layer is completely etched in the thickness direction. A magnitude of the oblique-direction retardation Re(40) in the etched region is calculated from the difference in oblique-direction retardation Re(40) before and after etching of 100 nm. Since the oblique-direction retardation Re(40) is in a proportional relationship with the birefringence index Δn, the thickness of the region having a high birefringence index of the liquid crystal compound in the thickness direction can be obtained by determining the film thickness of the region having a large oblique-direction retardation Re(40) in the thickness direction.

The configuration in which the diffraction efficiency of the cholesteric liquid crystal layer increases from one side to the other side along at least one in-plane direction of the cholesteric liquid crystal layer can be achieved by having a configuration in which the ratio of the thickness of the region having a high birefringence index to the thickness of the cholesteric liquid crystal layer gradually changes. For example, by gradually increasing the ratio of the thickness of the region having a high birefringence index to the thickness of the cholesteric liquid crystal layer in at least one in-plane direction of the cholesteric liquid crystal layer, the diffraction efficiency of the cholesteric liquid crystal layer can be increased from one side to the other side.

With regard to the cholesteric liquid crystal layer, in the configuration in which the cholesteric liquid crystal layer has the region having a high birefringence index and the region having a low birefringence index in the thickness direction, since the cholesteric liquid crystal layer has regions having different birefringence indices Δn in the thickness direction, in a case where the diffraction efficiency changes in a plane of the cholesteric liquid crystal layer, an average value Ana of the birefringence indices in the thickness direction changes in the plane. That is, in a case where the diffraction efficiency of the cholesteric liquid crystal layer changes from one side to the other side in at least one in-plane direction of the cholesteric liquid crystal layer, the average value Ana of the birefringence indices in the thickness direction gradually changes in the plane. As described above, the configuration in which the birefringence index Δn varies in the thickness direction and the average value Ana of the birefringence indices in the thickness direction gradually changes in the plane can be achieved by, as an example, a configuration in which, in at least a part of the cholesteric liquid crystal layer in the plane, the thickness of the optically-isotropic region gradually decreases and the thickness of the optically-anisotropic region gradually increases from one side to the other side along the at least one in-plane direction in the plane of the cholesteric liquid crystal layer.

In the plane of the cholesteric liquid crystal layer, the maximum value of the thickness of the high-birefringence index region is preferably 0.1 to 10 μm, more preferably 0.3 μm to 8 μm, and still more preferably 0.5 μm to 5 μm.

In the plane of the cholesteric liquid crystal layer, the minimum value of the thickness of the high-birefringence index region is preferably 0.0 to 5 μm, more preferably 0.0 μm to 3 μm, and still more preferably 0.0 μm to 1 μm.

However, the maximum value of the thickness of the high-birefringence index region and the minimum value of the thickness of the high-birefringence index region are preferably appropriately set depending on the performance required for the optically-anisotropic layer and the light guide element, and are not limited to the above.

### Second Embodiment

Here, in the example shown in FIG. 1, the region A and/or the region B (or further the region C) of the optically-anisotropic layer is assumed to be the region in which the liquid crystal compound is cholesterically aligned; but the present invention is not limited thereto, and the liquid crystal compound may not be cholesterically aligned. FIG. 7 conceptually shows an example of a second embodiment of the liquid crystal diffraction element. A liquid crystal diffraction element 12 shown in FIG. 7 diffracts incident light and transmits the incident light. The liquid crystal diffraction element 12 shown in FIG. 7 has a configuration in which a support 20, an alignment film 24, and a liquid crystal diffraction layer 16 are laminated in this order.

Since the support 20 and the alignment film 24 have the same configuration as the support 20 and the alignment film 24 of the liquid crystal diffraction element 10 shown in FIG. 1, the description thereof will not be repeated.

### <Liquid Crystal Diffraction Layer>

The liquid crystal diffraction layer 16 is formed on the surface of the alignment film 24.

The liquid crystal diffraction layer 16 is a layer which is formed of a composition containing a liquid crystal compound, and has a liquid crystal alignment pattern in which an orientation of an optical axis derived from the liquid crystal compound continuously rotates in at least one in-plane direction.

FIG. 8 shows a plan view of the liquid crystal diffraction element shown in FIG. 7. The plan view is a view in a case where the liquid crystal diffraction element is seen from the top in FIG. 7, that is, a view in a case where the liquid crystal diffraction element is seen from the thickness direction (laminating direction of the respective layers (films)). In other words, the drawing is a view of the liquid crystal diffraction layer 16 as seen from a direction perpendicular to the main surface. In addition, in FIG. 8, in order to clarify the configuration of the liquid crystal diffraction element, only a liquid crystal compound 30 on a surface of the alignment film 24 is shown with regard to the liquid crystal compound 30 in the liquid crystal diffraction layer 16. However, in the thickness direction, as shown in FIG. 7, the liquid crystal diffraction layer 16 has a structure in which the liquid crystal compound 30 is stacked on the liquid crystal compound 30 of the surface of the alignment film 24.

As shown in FIG. 8, the liquid crystal diffraction layer 16 has a liquid crystal alignment pattern in which an orientation of an optical axis 30A derived from the liquid crystal compound 30 changes while continuously rotating in one direction indicated by arrow X in a plane of the liquid crystal diffraction layer 16. Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or to θ−180° in the arrow X direction. A difference between the angles of the optical axes 30A of the liquid crystal compounds 30 adjacent to each other in the arrow X direction is preferably 45° or less, more preferably 15° or less, and still more preferably less than 15°.

Meanwhile, regarding the liquid crystal compound 30 forming the liquid crystal diffraction layer 16, the liquid crystal compounds 30 in which the orientations of the optical axes 30A are the same as one another are arranged at equal intervals in the Y direction orthogonal to the arrow X direction, that is, the Y direction orthogonal to one direction in which the optical axes 30A continuously rotate. In other words, regarding the liquid crystal compound 30 forming the liquid crystal diffraction layer 16, in the liquid crystal compounds 30 arranged in the Y direction, angles between the orientations of the optical axes 30A and the arrow X direction are the same. In the liquid crystal alignment pattern of the liquid crystal diffraction layer 16, the length A of the single period in the liquid crystal alignment pattern is repeated in the arrow X direction, that is, in the one direction in which the orientation of the optical axis 30A changes while continuously rotating.

As described above, in the liquid crystal diffraction layer 16, the liquid crystal compounds arranged in the Y direction have the same angle between the optical axis 30A and the arrow X direction (one direction in which the orientation of the optical axis of the liquid crystal compound 30 rotates). A region where the liquid crystal compounds 30 in which the angles between the optical axes 30A and the arrow X direction are the same are arranged in the Y direction will be referred to as a region R. In this case, it is preferable that an in-plane retardation (Re) value of each of the regions R is a half wavelength, that is, λ/2. The in-plane retardation is calculated from a product of a difference in refractive index Δn due to refractive index anisotropy of the region R and a thickness of the liquid crystal diffraction layer 16. Here, the difference in refractive index due to the refractive index anisotropy of the regions R in the liquid crystal diffraction layer 16 is defined by a difference between a refractive index of a direction of an in-plane slow axis of the region R and a refractive index of a direction orthogonal to the direction of the slow axis. That is, the difference Δn in refractive index due to the refractive index anisotropy of the regions R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the above-described difference in refractive index Δn is the same as the difference in refractive index of the liquid crystal compound.

In a case where circularly polarized light is incident into the liquid crystal diffraction layer 16, the light is refracted and a direction of the circularly polarized light is changed.

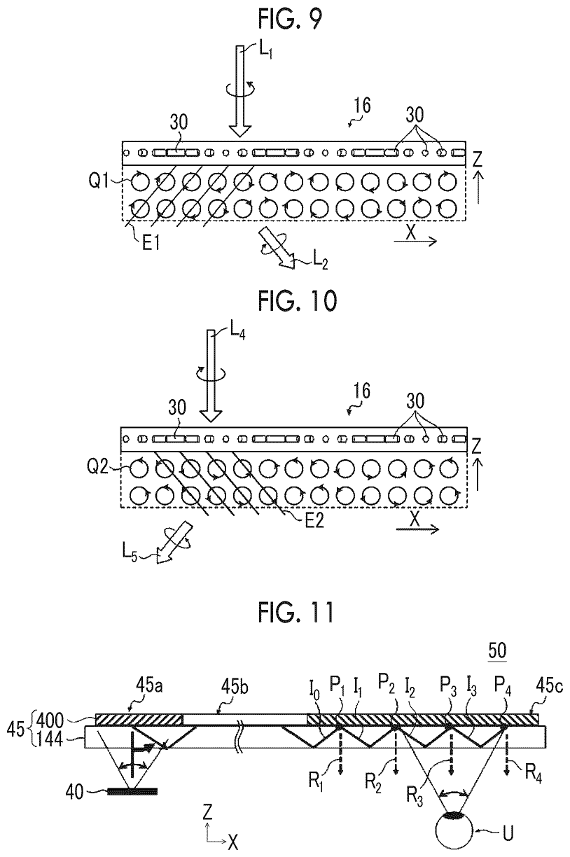

This action is conceptually shown in FIG. 9 using the liquid crystal diffraction layer 16 as an example. As shown in FIG. 9, in a case where an incidence ray L₁ as levorotatory circularly polarized light is incident into the liquid crystal diffraction layer 16, the incidence ray L₁ transmits through the liquid crystal diffraction layer 16 to be imparted with a phase difference of 180°, and a transmitted ray L₂ is converted into dextrorotatory circularly polarized light.

In addition, the liquid crystal alignment pattern formed in the liquid crystal diffraction layer 16 is a pattern which is periodic in the arrow X direction, so that the transmitted ray L₂ is refracted and travels in a direction different from a traveling direction of the incidence ray L₁. In this way, the incidence ray L₁ of the levorotatory circularly polarized light is converted into the transmitted ray L₂ of the dextrorotatory circularly polarized light, which is tilted by a predetermined angle in the arrow X direction with respect to an incidence direction.

On the other hand, as conceptually shown in FIG. 10, in a case where an incidence ray L₄ as dextrorotatory circularly polarized light is incident into the liquid crystal diffraction layer 16, the incidence ray LA transmits through the liquid crystal diffraction layer 16 to be imparted with a phase difference of 180°, and is converted into a transmitted ray L₅ as levorotatory circularly polarized light. In addition, the liquid crystal alignment pattern formed in the liquid crystal diffraction layer 16 is a pattern which is periodic in the arrow X direction, so that the transmitted ray L₅ is refracted (diffracted) and travels in a direction different from a traveling direction of the incidence ray L₄. In this way, the incidence ray L₄ is converted into the transmitted ray L₅ of the levorotatory circularly polarized light, which is tilted by a predetermined angle in the arrow X direction with respect to a direction opposite to the incidence direction.

In the liquid crystal diffraction layer 16, in a case where high diffraction efficiency is obtained, it is preferable that the in-plane retardation values of the plurality of the regions R are half wavelengths. It is preferable that an in-plane retardation Re(550)=Δn550×d of the plurality of the regions R in the liquid crystal diffraction layer 16 with respect to incident light having a wavelength of 550 nm is within a range defined by the following expression (1). Here, Δn550 is a difference in refractive index due to the refractive index anisotropy of the region R in a case where the wavelength of the incident light is 550 nm, and d represents a thickness of the liquid crystal diffraction layer 16.

$$200 nm \leq Δ n 550 \times d \leq 350 nm \qquad ( 1 )$$

That is, in a case where the “in-plane retardation Re(550)=Δn550×d” of the plurality of the regions R of the liquid crystal diffraction layer 16 satisfies the expression (1), a sufficient amount of circularly polarized light components of light which has been incident into the liquid crystal diffraction layer 16 can be converted into circularly polarized light traveling in a direction tilted in a forward or backward direction with respect to the arrow X direction. It is more preferable that the in-plane retardation Re(550)=Δn550×dis 225 nm≤Δn550×d≤340 nm, and it is still more preferable that the in-plane retardation Re(550)=Δn550×d is 250 nm≤Δn550×d≤330 nm. The above expression (1) is a range with respect to the incident light having a wavelength of 550 nm, but an in-plane retardation Re(2)=Δn_{λ}×d of the plurality of the regions R of the liquid crystal diffraction layer 16 with respect to incident light having a wavelength of 2 nm is preferably in a range defined by the following expression (1-2), and can be appropriately set.

$$0.35 \times λ nm \leq Δ n λ \times d \leq 0.65 \times λ nm \qquad ( 1 - 2 )$$

In addition, a value of the in-plane retardation of the plurality of the regions R of the liquid crystal diffraction layer 16 in a range outside the range of the above expression (1) can also be used. Specifically, by adopting Δn550×d<200 nm or 350 nm<Δn550×d, light can be classified into light which travels in the same direction as a traveling direction of the incidence ray and light which travels in a direction different from a traveling direction of the incidence ray. In a case where Δn550×d approaches 0 nm or 550 nm, the light component traveling in the same direction as the traveling direction of the incidence ray increases, and the light component traveling in a direction different from the traveling direction of the incidence ray decreases.

Furthermore, it is preferable that an in-plane retardation Re(450)=Δn450×d of each of the regions R of the liquid crystal diffraction layer 16 with respect to incident light having a wavelength of 450 nm and the in-plane retardation Re(550)=Δn550×d of each of the regions R of the liquid crystal diffraction layer 16 with respect to incident light having a wavelength of 550 nm satisfy the following expression (2). Here, Δn450 represents a difference in refractive index due to the refractive index anisotropy of the region R in a case where the wavelength of the incidence ray is 450 nm.

$$( Δ n 450 \times d ) / ( Δ n 550 \times d ) < 1. \qquad ( 2 )$$

The expression (2) represents that the liquid crystal compound 30 contained in the liquid crystal diffraction layer 16 has reverse dispersibility. That is, by satisfying the expression (2), the liquid crystal diffraction layer 16 can respond to incident light having a wide wavelength range.

Here, by changing the single period Λ of the liquid crystal alignment pattern formed in the liquid crystal diffraction layer 16, refraction angles of the transmitted rays L₂ and L₅ can be adjusted. Specifically, as the single period Λ of the liquid crystal alignment pattern decreases, light transmitted through the liquid crystal compounds 30 adjacent to each other more strongly interfere with each other, so that the transmitted rays L₂ and L₅ can be more largely refracted (diffracted). In addition, the refraction angles of the transmitted rays L₂ and L₅ with respect to the incidence rays L₁ and L₄ vary depending on the wavelengths of the incidence rays L₁ and L₄ (the transmitted rays L₂ and L₅). Specifically, as the wavelength of the incidence ray increases, the transmitted ray is refracted (diffracted) more. That is, in a case where the incident light is red light, green light, and blue light, the red light is refracted (diffracted) most greatly, and the blue light is refracted (diffracted) least. Furthermore, by reversing the rotation direction of the optical axis 30A of the liquid crystal compound 30 which rotates in the arrow X direction, a refraction direction of the transmitted ray can be reversed.

The liquid crystal diffraction layer 16 includes a cured layer of a liquid crystal composition containing a rod-like liquid crystal compound or a disk-like liquid crystal compound, and has a liquid crystal alignment pattern in which an optical axis of the rod-like liquid crystal compound or an optical axis of the disk-like liquid crystal compound is aligned as described above.

The liquid crystal diffraction layer 16 including the cured layer of the liquid crystal composition can be obtained by forming the alignment film 24 on the support 20, coating the alignment film 24 with the liquid crystal composition, and curing the liquid crystal composition. The applying method and curing method of the liquid crystal composition are the same as those for the cholesteric liquid crystal layer described above.

The liquid crystal diffraction layer 16 functions as the optically-anisotropic region, but the present invention includes an aspect in which a laminate including the support 20 and the alignment film 24 integrally functions as the optically-anisotropic region.

The liquid crystal composition for forming the liquid crystal diffraction layer 16 contains a rod-like liquid crystal compound or a disk-like liquid crystal compound, and may further contain other components such as a leveling agent, an alignment control agent, a polymerization initiator, a crosslinking agent, and an alignment assistant. In addition, the liquid crystal composition may contain a solvent. As the rod-like liquid crystal compound, the disk-like liquid crystal compound, and the like, which are contained in the liquid crystal composition for forming the liquid crystal diffraction layer 16, the same ones as the rod-like liquid crystal compound, the disk-like liquid crystal compound, and the like, which are contained in the liquid crystal composition for forming the cholesteric liquid crystal layer 18 described above, can be used. That is, the liquid crystal composition for forming the liquid crystal diffraction layer 16 is the same as the liquid crystal composition for forming the cholesteric liquid crystal layer 18 described above, except that it does not contain a chiral agent.

In addition, the liquid crystal diffraction layer 16 may have a so-called twisted structure in which the orientation of the liquid crystal compound continuously changes from one interface side to the other interface side in the thickness direction. The twisted structure is a configuration in which the liquid crystal compound is twisted and rotated in the thickness direction such that the cholesteric liquid crystalline phase is not formed, and thus the liquid crystal compound does not substantially exhibit selective reflectivity. Specifically, in the twisted structure, a twist of the optical axis in the entire thickness direction is less than one rotation, that is, a twist angle is less than 360°. The twisted structure can be formed by appropriately adding a chiral agent to the liquid crystal composition.

In addition, it is preferable that the liquid crystal diffraction layer 16 has a wide range for the wavelength of incident light, and is formed of a liquid crystal material having a reverse birefringence index dispersion. In addition, from the viewpoint that the effect of the present invention is more excellent and viewpoint that diffracted light having a high diffraction efficiency can be obtained even at a large diffraction angle, refractive index anisotropy Δn of the liquid crystal compound is preferably 0.15 or more, more preferably 0.20 or more, and still more preferably 0.25 or more. The upper limit thereof is not particularly limited, but is usually 1.00 or less. The liquid crystal compound exhibiting such high refractive index anisotropy is usually a compound having a positive dispersibility in which a birefringence index Δn450 with respect to incident light having a wavelength of 450 nm is larger than a birefringence index Δn550 with respect to incident light having a wavelength of 550 nm. In such a case, it is also preferable that the liquid crystal diffraction layer 16 is made to have a substantially wide range with respect to the wavelength of incident light by imparting a twisted component to the liquid crystal composition or by laminating different liquid crystal diffraction layers. For example, in the liquid crystal diffraction layer 16, a method of realizing the optically-anisotropic layer having a wide-range pattern by laminating two liquid crystal layers having different twisted directions is described in, for example, JP2014-089476A and can be preferably used in the present invention.

### [Non-Diffraction Region]

As shown in FIG. 29, the optically-anisotropic layer 400 according to the embodiment of the present invention has a non-diffraction region 45b.

The non-diffraction region 45b does not have the above-described liquid crystal alignment pattern, and is a region which does not have a function of diffracting incident light.

The non-diffraction region 45b may be a non-aligned region in which the liquid crystal compound is not aligned, that is, an optically-isotropic region, or may be a region in which the liquid crystal compound is aligned in one direction in the same plane. In the non-diffraction region 45b, the liquid crystal compound may be uniaxially aligned, twistedly aligned, or cholesterically aligned in the thickness direction, and is preferably uniaxially aligned or twistedly aligned. In the non-diffraction region 45b, a structure in which a region where the liquid crystal compound is uniaxially aligned, twisted aligned, or cholesteric aligned in the thickness direction and an isotropic region are laminated may be provided.

In a case where the non-diffraction region 45b is a region where the liquid crystal compound is aligned in one direction in the same plane, it is preferable that the non-diffraction region 45b functions as a phase difference region. It is preferable that the phase difference region provides a phase difference of λ/8 to light from at least one incidence direction. As a result, for example, in a case where circularly polarized light is guided in a light guide plate, circularly polarized light diffracted in an incidence-side region A45a is converted into elliptically polarized light by transmitting through the non-diffraction region 45b, and is converted into linearly polarized light by total reflection at an interface between the non-diffraction region 45b and air and by transmitting through the non-diffraction region 45b again. While the polarization state of the circularly polarized light is eliminated when guided, the polarization state of the linearly polarized light can be maintained when guided, so that it is possible to make an emitted light intensity in an emission-side region B45c uniform.

Here, in the optically-anisotropic layer according to the embodiment of the present invention, a rotation direction of the optical axis derived from the liquid crystal compound in the one direction of the liquid crystal alignment pattern in the region A may be different from a rotation direction of the optical axis derived from the liquid crystal compound in the one direction of the liquid crystal alignment pattern in the region B.

In addition, the one direction of the liquid crystal alignment pattern in the region A and the one direction of the liquid crystal alignment pattern in the region B may be different from each other.

In addition, a length (length of the single period Λ) over which the orientation of the optical axis derived from the liquid crystal compound rotates by 180° in a plane of the liquid crystal alignment pattern in the region A may be different from a length (length of the single period Λ) over which the orientation of the optical axis derived from the liquid crystal compound rotates by 180° in a plane of the liquid crystal alignment pattern in the region B.

As described later, in a case where the optically-anisotropic layer is used in a light guide element in combination with a light guide plate, for example, the region A acts as an incidence diffraction element for allowing light to be incident into the light guide plate, and the region B acts as an emission diffraction element for allowing light to be emitted from the light guide plate. Therefore, diffraction performance to be obtained is different between the region A and the region B. Accordingly, the region A and the region B may be set according to diffraction performance for obtaining the rotation direction of the orientation of the optical axis derived from the liquid crystal compound, the single period, the orientation in the one direction, and the like in the liquid crystal alignment pattern; and the liquid crystal alignment pattern in the region A and the liquid crystal alignment pattern in the region B may be different from each other.

In addition, in the optically-anisotropic layer according to the embodiment of the present invention, the region A and the region B may each be the cholesteric liquid crystal layer; the region A and the region B may each be the liquid crystal diffraction layer; the region A may be the cholesteric liquid crystal layer and the region B may be the liquid crystal diffraction layer; or the region A may be the liquid crystal diffraction layer and the region B may be the cholesteric liquid crystal layer.

In addition, in the optically-anisotropic layer according to the embodiment of the present invention, in a case where the region A and the region B are the cholesteric liquid crystal layer, a region in which a length of a helical pitch of the cholesteric liquid crystal layer in the region A is different from a length of a helical pitch of the cholesteric liquid crystal layer in the region B is provided.

For example, in a case where the optically-anisotropic layer is used in combination with the light guide plate and the region A is used as the incidence diffraction element and the region B is used as the emission diffraction element, light is incident into the region A from a direction substantially perpendicular to the region A, and light is incident into the region B from an oblique direction. As described above, the cholesteric liquid crystal layer has wavelength-selective reflectivity, but in a case where the light is incident from an oblique direction, a so-called blue shift in which the selective reflection wavelength is shortened occurs. Therefore, even in a case where the region A and the region B diffract light having the same wavelength, it is preferable to appropriately set the length of the helical pitch for each region depending on the incidence angle of light, and the like.

In addition, a helical turning direction of the cholesteric alignment in the region A may be different from a helical turning direction of the cholesteric alignment in the region B. That is, the turning direction of circularly polarized light to be reflected from the region A and the turning direction of circularly polarized light to be reflected from the region B may be different from each other.

For example, in a case where the optically-anisotropic layer is used in combination with the light guide plate, the region A is used as the incidence diffraction element, and the region B is used as the emission diffraction element, even in a case where dextrorotatory circularly polarized light is incident from the region A into the light guide plate, the light may be converted into a levorotatory circularly polarized light component such as unpolarized light and elliptically polarized light as the light is incident into the depolarization region B, after being totally reflected and guided in the light guide plate. Therefore, the circularly polarized light which is reflected and diffracted by the region B may be different from the circularly polarized light which is reflected and diffracted by the region A.

In addition, in the optically-anisotropic layer according to the embodiment of the present invention, in a case where at least one of the region A or the region B is the cholesteric liquid crystal layer, a region in which the length of the helical pitch of the cholesteric liquid crystal layer varies in the in-plane direction of the region may be provided.

As a result, for example, in a case of being used as AR glasses, tint, brightness, and the like in the plane can be adjusted to be uniform. In addition, by adjusting the optically-anisotropic layer such that a desired tint is strongly reflected in a desired direction in the plane, AR glasses having high light utilization efficiency can be obtained.

In addition, in the optically-anisotropic layer according to the embodiment of the present invention, in a case where at least one of the region A or the region B is the cholesteric liquid crystal layer, a region in which the length of the helical pitch of the cholesteric liquid crystal layer changes in the thickness direction may be provided in the region.

As described above, the cholesteric liquid crystal layer reflects a specific wavelength depending on the length of the helical pitch. Accordingly, by adopting the configuration in which the length of the helical pitch of the cholesteric liquid crystal layer changes in the thickness direction, the wavelength range of selective reflection can be widened.

Here, in the examples shown in FIGS. 29 and 30, the optically-anisotropic layer has the configuration in which two regions having the liquid crystal alignment pattern are provided, but the present invention is not limited thereto. The optically-anisotropic layer according to the embodiment of the present invention may have a configuration of further including a region C having a liquid crystal alignment pattern in which an orientation of an optical axis derived from the liquid crystal compound changes while continuously rotating in at least one in-plane direction, in which the region C is also provided in the same in-plane direction of the optically-anisotropic layer.

FIG. 31 is a plan view conceptually showing another example of the optically-anisotropic layer according to the embodiment of the present invention.

An optically-anisotropic layer 450 shown in FIG. 31 includes a region A45a, a region B45c, a region C45d, and a non-diffraction region 45b. As shown in FIG. 31, the region A45a and the region C45d are disposed to be spaced apart from each other in the left-right direction in the drawing; and the region C45d and the region B45c are disposed to be spaced apart from each other in the up-down direction in the drawing. The non-diffraction region 45b is formed between the region A45a and the region C45d and between the region C45d and the region B45c.

The region C45d has the liquid crystal alignment pattern in which the orientation of the optical axis derived from the liquid crystal compound changes while continuously rotating in at least one in-plane direction, as in the region A45a and the region B45c. Similar to the region A45a and the region B45c, the region C45d may be a cholesteric liquid crystal layer or a liquid crystal diffraction layer. In addition, the liquid crystal alignment pattern in the region C45d may be different from the liquid crystal alignment pattern in each of the region A45a and the region B45c.

As described above, the optically-anisotropic layer 450 further including the region C45d has three regions in which light is diffracted. Such an optically-anisotropic layer 450 is used in a light guide element in combination with a light guide plate. In this case, as described later, for example, the region A45a acts as an incidence diffraction element for allowing light to be incident into the light guide plate, the region B45c acts as an emission diffraction element for allowing light to be emitted from the light guide plate, and the region C45d acts as an intermediate diffraction element which diffracts the light incident from the region A45a in the direction of the region B45c. In the region C45d which acts as the intermediate diffraction element, a configuration in which a part of light is diffracted at a plurality of positions to be emitted to the outside of the light guide plate can be adopted to perform exit pupil expansion. In addition, in the region C45d, it is preferable to have a region in which the diffraction efficiency varies in the in-plane direction, and it is more preferable that the diffraction efficiency gradually changes.

### [Laminate]

The laminate according to the embodiment of the present invention is a laminate in which two or more of the above-described optically-anisotropic layers are laminated.

FIG. 32 is a view conceptually showing an example of the laminate according to the embodiment of the present invention.

A laminate 500 shown in FIG. 32 includes a first optically-anisotropic layer 400a and a second optically-anisotropic layer 400b.

The first optically-anisotropic layer 400a has a region A410a and a region B410c having a liquid crystal alignment pattern, and a non-diffraction region 410b. In addition, the second optically-anisotropic layer 400b has a region A420a and a region B420c having a liquid crystal alignment pattern, and a non-diffraction region 420b. Basic configurations of the first optically-anisotropic layer 400a and the second optically-anisotropic layer 400b are the same as those of the optically-anisotropic layer described above.

In FIG. 32, the first optically-anisotropic layer 400a and the second optically-anisotropic layer 400b are disposed such that the region A410a of the first optically-anisotropic layer 400a and the region A420a of the second optically-anisotropic layer 400b overlap with each other, the non-diffraction region 410b not having the liquid crystal alignment pattern of the first optically-anisotropic layer 400a and the non-diffraction region 420b not having the liquid crystal alignment pattern of the second optically-anisotropic layer 400b overlap with each other, and the region B410c of the first optically-anisotropic layer 400a and the region B420c of the second optically-anisotropic layer 400b overlap with each other.

In the example shown in FIG. 32, the laminate has a configuration in which two optically-anisotropic layers are laminated, but the present invention is not limited thereto, and a configuration in which three or more optically-anisotropic layers are laminated may be adopted. Even in the configuration in which three or more optically-anisotropic layers are laminated, it is preferable that the optically-anisotropic layers are laminated at positions where the regions A of the optically-anisotropic layers, the regions B of the optically-anisotropic layers, and the non-diffraction regions of the optically-anisotropic layers overlap with each other.

In addition, the laminate may be a laminate in which two or more optically-anisotropic layers further having the region C as in the example shown in FIG. 31 are laminated. In this case, it is preferable that the optically-anisotropic layers are laminated at positions where the regions C of the optically-anisotropic layers overlap each other.

It is preferable that the laminate 500 shown in FIG. 32 satisfies at least one of a requirement that the region A410a of the first optically-anisotropic layer 400a and the region A420a of the second optically-anisotropic layer 400b are cholesteric liquid crystal layers, and a length of a helical pitch of the cholesteric liquid crystal layer in the region A410a of the first optically-anisotropic layer 400a is different from a length of a helical pitch of the cholesteric liquid crystal layer in the region A420a of the second optically-anisotropic layer 400b, or a requirement that the region B410c of the first optically-anisotropic layer 400a and the region B420c of the second optically-anisotropic layer 400b are cholesteric liquid crystal layers, and a length of a helical pitch of the cholesteric liquid crystal layer in the region B410c of the first optically-anisotropic layer 400a is different from a length of a helical pitch of the cholesteric liquid crystal layer in the region B420c of the second optically-anisotropic layer 400b.

As described above, the cholesteric liquid crystal layer reflects light having a specific wavelength depending on the length of the helical pitch. By making the lengths of the helical pitches of the regions A and/or regions B of the first optically-anisotropic layer 400a and the second optically-anisotropic layer 400b different from each other, the regions A and/or regions B of the first optically-anisotropic layer 400a and the second optically-anisotropic layer 400b reflect light having different wavelengths respectively.

As described later, in a case where a light guide element obtained by combining the laminate 500 with a light guide plate is used for an AR display device or the like, and the AR display device displays a color image, for example, the light guide element needs to guide light having wavelengths of RGB respectively. Accordingly, it is preferable to adopt a configuration in which optically-anisotropic layers having the region A and the region B (further, the region C) where light having these wavelengths is reflected and diffracted are laminated. For example, the region A and the region B of the first optically-anisotropic layer can be configured to be a cholesteric liquid crystal layer having a selective reflection wavelength in a red wavelength range, and the region A and the region B of the second optically-anisotropic layer can be configured to be a cholesteric liquid crystal layer having a selective reflection wavelength in a green wavelength range.

In addition, it is preferable that the laminate 500 shown in FIG. 32 satisfies at least one of a requirement that the region A410a of the first optically-anisotropic layer 400a and the region A420a of the second optically-anisotropic layer 400b are cholesteric liquid crystal layers, and a helical rotation direction of the cholesteric liquid crystal layer in the region A410a of the first optically-anisotropic layer 400a is different from a helical rotation direction of the cholesteric liquid crystal layer in the region A420a of the second optically-anisotropic layer 400b, or a requirement that the region B410c of the first optically-anisotropic layer 400a and the region B420c of the second optically-anisotropic layer 400b are cholesteric liquid crystal layers, and a helical rotation direction of the cholesteric liquid crystal layer in the region B410c of the first optically-anisotropic layer 400a is different from a helical rotation direction of the cholesteric liquid crystal layer in the region B420c of the second optically-anisotropic layer 400b.

As described above, the cholesteric liquid crystal layer has circularly polarized light selectivity depending on the rotation direction of the helix in the helical structure. By making the helical rotation directions of the regions A and/or regions B of the first optically-anisotropic layer 400a and the second optically-anisotropic layer 400b different from each other, for example, a configuration can be adopted in which the region A410a of the first optically-anisotropic layer 400a reflects and diffracts dextrorotatory circularly polarized light having a certain wavelength, the region A420a of the second optically-anisotropic layer 400b reflects and diffracts levorotatory circularly polarized light having the same wavelength; and/or in which the region B410c of the first optically-anisotropic layer 400a reflects and diffracts dextrorotatory circularly polarized light having a certain wavelength, and the region B420c of the second optically-anisotropic layer 400b reflects and diffracts levorotatory circularly polarized light having the same wavelength.

In addition, it is preferable that the laminate 500 shown in FIG. 32 satisfies at least one of a requirement that a length of a single period in the region A410a of the first optically-anisotropic layer 400a, over which the orientation of the optical axis derived from the liquid crystal compound rotates 180° in a plane, is different from a length of a single period in the region A420a of the second optically-anisotropic layer 400b, or a requirement that a length of a single period in the region B410c of the first optically-anisotropic layer 400a, over which the orientation of the optical axis derived from the liquid crystal compound rotates 180° in a plane, is different from a length of a single period in the region B420c of the second optically-anisotropic layer 400b.

As described above, the diffraction angle in the region A and the region B is determined depending on the length of the single period in the liquid crystal alignment pattern. In addition, even in a case where the lengths of the single periods are the same, the diffraction angles vary depending on the wavelengths of light. Therefore, for example, as described above, by making the lengths of the helical pitches of the regions A and/or regions B of the first optically-anisotropic layer 400a and the second optically-anisotropic layer 400b different from each other, in a case where the first optically-anisotropic layer 400a and the second optically-anisotropic layer 400b reflect and diffract light having different wavelengths, as the lengths of the single periods in the liquid crystal alignment patterns are the same, the diffraction angles are different from each other, and thus the light is emitted in different directions. Accordingly, it is preferable that the lengths of the single periods of the liquid crystal alignment patterns in the regions A and/or regions B of the first optically-anisotropic layer 400a and the second optically-anisotropic layer 400b are different from each other such that the diffraction angles of light in the regions A and/or regions B of the first optically-anisotropic layer 400a and the second optically-anisotropic layer 400b are the same.

In addition, the laminate 500 shown in FIG. 32 satisfies at least one of a requirement that the one direction of the liquid crystal alignment pattern in the region A410a of the first optically-anisotropic layer 400a is different from the one direction of the liquid crystal alignment pattern in the region A420a of the second optically-anisotropic layer 400b, or a requirement that the one direction of the liquid crystal alignment pattern in the region B410c of the first optically-anisotropic layer 400a is different from the one direction of the liquid crystal alignment pattern in the region B420c of the second optically-anisotropic layer 400b.

As a result, for example, light diffracted in the region A410a of the first optically-anisotropic layer 400a can be selectively diffracted in the region B410c of the optically-anisotropic layer 400a. In addition, light diffracted in the region A420a of the second optically-anisotropic layer 400b can be selectively diffracted in the region B420c of the second optically-anisotropic layer 400b. That is, in each of the first optically-anisotropic layer 400a and the second optically-anisotropic layer 400b, light can be selectively diffracted. Accordingly, for example, in a case where it is desired to diffract light having different wavelengths in the first optically-anisotropic layer 400a and the second optically-anisotropic layer 400c, color crosstalk can be avoided.

### [Light Guide Element and AR Display Device]

The light guide element using the optically-anisotropic layer according to the embodiment of the present invention includes the above-described optically-anisotropic layer and a light guide plate. The augmented reality (AR) display device according to the embodiment of the present invention includes the light guide element and an image display device.

### First Embodiment

FIG. 11 conceptually shows an example of the AR display device according to a first embodiment of the present invention, including the light guide element according to the embodiment of the present invention.

An AR display device 50 shown in FIG. 11 includes a display (image display device) 40 and a light guide element 45.

The light guide element 45 is the light guide element according to the embodiment of the present invention, and includes the optically-anisotropic layer 400 according to the embodiment of the present invention and a light guide plate 144. The light guide element according to the embodiment of the present invention may have a configuration in which the above-described laminate according to the embodiment of the present invention and the light guide plate are provided, the laminate including a plurality of the optically-anisotropic layers. In other words, the light guide element according to the embodiment of the present invention may include a plurality of the optically-anisotropic layers.

As described above, the optically-anisotropic layer 400 is one optically-anisotropic layer consisting of three regions of the region A45a, the non-diffraction region 45b, and the region B45c. The light guide plate 144 has a rectangular shape which is elongated in one direction, and guides light. As shown in FIG. 11, the region A45a of the optically-anisotropic layer 400 is disposed on a surface (main surface) of the light guide plate 144 on one end part side in a longitudinal direction. In addition, the region B45c of the optically-anisotropic layer 400 is disposed on a surface of the light guide plate 144 on the other end part side. The disposition position of the region A45a of the optically-anisotropic layer 400 corresponds to an incidence position of light of the light guide plate 144; and the disposition position of the region B45c of the optically-anisotropic layer 400 corresponds to an emission position of light of the light guide plate 144. In addition, the optically-isotropic non-diffraction region 45b is formed between the region A45a and the region B45c.

The region A45a of the optically-anisotropic layer 400 is an incidence diffraction element region where light emitted from the display 40 and incident into the light guide plate 144 is diffracted to be totally reflected in the light guide plate 144.

In addition, the region B45c of the optically-anisotropic layer 400 is an emission diffraction element region where light guided in the light guide plate 144 is diffracted to be emitted from the light guide plate 144.

The light guide plate 144 is not particularly limited, and a light guide plate known in the related art, which is used in an image display device or the like, can be used.

As the light guide plate 144, various materials used as a material of a light guide plate in an optical element can be used. Specifically, examples of the material of the light guide plate 144 include glass, acrylic, polycarbonate, polystyrene, urethane, polyolefin, polyvinyl chloride, polyethylene terephthalate (PET), and triacetyl cellulose (TAC).

A thickness of the light guide plate 144 is not limited, and may be appropriately set in consideration of thickness capable of holding the optically-anisotropic layer, lightness of the light guide plate, uniformity of brightness (amount of light) of the light emitted from the light guide plate, and the like. The thickness of the light guide plate 144 is preferably 0.02 to 2.0 mm, more preferably 0.05 to 1.0 mm, and still more preferably 0.1 to 0.5 μm.

In addition, a refractive index of the light guide plate is preferably 1.5 or more, more preferably 1.8 or more, and still more preferably 2.0 or more. In addition, a difference between the extraordinary refractive index of the liquid crystal compound in the optically-anisotropic layer and the refractive index of the light guide plate is preferably 0.5 or less, more preferably 0.3 or less, and still more preferably 0.1 or less.

As shown in FIG. 11, the display 40 is disposed on a surface of one end part of the light guide plate 144 opposite to the surface on which the optically-anisotropic layer 400 is disposed. In addition, a surface side of one end part of the light guide plate 144 opposite to the surface on which the optically-anisotropic layer 400 is disposed is an observation position of a user U. In the following description, a longitudinal direction of the light guide plate 144 will be referred to as “X direction”, and a direction which is perpendicular to the X direction and perpendicular to the surface of the optically-anisotropic layer will be referred to as “Z direction”. The Z direction is also the thickness direction of each layer in the optically-anisotropic layer (refer to FIG. 1). The display 40 is not particularly limited, and for example, various known displays used in an AR display device such as AR glasses can be used. Examples of the display 40 include a laser beam scanning method using a liquid crystal display (including Liquid Crystal On Silicon (LCOS)), an organic electroluminescent display, a digital light processing (DLP), a micro light emitting diode (uLED) display, a micro-electro-mechanical systems (MEMS) mirror, and the like.

The display 40 may display a monochrome image, a two-color image, or a color image.

Since the optically-anisotropic layer according to the embodiment of the present invention has polarization selectivity, a display which emits polarized light is suitably used. For example, a configuration in which, using a display which displays red and blue images by emission of dextrorotatory circularly polarized light and displays a green image by emission of levorotatory circularly polarized light, an optically-anisotropic layer having the regions A and B which diffract the dextrorotatory circularly polarized red light, an optically-anisotropic layer having the regions A and B which diffract the levorotatory circularly polarized green light, and an optically-anisotropic layer having the regions A and B which diffract the dextrorotatory circularly polarized blue light are laminated on the light guide plate may be used. As a result, since the polarization states of red and green having adjacent wavelengths and the polarization states of green and blue having adjacent wavelengths are different from each other, it is possible to avoid occurrence of color crosstalk.

In addition, for example, by using a display which displays an image corresponding to FOV of 0° to 50° by emission of dextrorotatory circularly polarized light and an image corresponding to FOV of −50° to 0° by emission of levorotatory circularly polarized light, and laminating, on the light guide plate, an optically-anisotropic layer having the regions A and B which diffract the dextrorotatory circularly polarized light and an optically-anisotropic layer having the regions A and B which diffract the levorotatory circularly polarized light, the FOV can be expanded to be twice as large as the FOV in a case where the polarization is not used.

Furthermore, the optically-anisotropic layer according to the embodiment of the present invention is also suitably used for a laser beam scanning type display. The laser beam scanning type display scans laser light with the MEMS mirror. In this case, in a case where the optical system is designed to perform scanning with the MEMS mirror after the laser light is folded by a polarization mirror, there is a problem that glare occurs in a case where polarization selectivity of the polarization mirror is insufficient. However, since the optically-anisotropic layer according to the embodiment of the present invention itself has polarization selectivity, the polarization selectivity of the polarizing mirror can be compensated, and thus the glare can be prevented.

In the AR display device 50 having the above-described configuration, as indicated by arrows, light displayed by the display 40 is incident into the light guide plate 144 from the surface of one end part of the light guide plate 144 opposite to the surface on which the optically-anisotropic layer 400 is disposed. The light incident into the light guide plate 144 is reflected from the region A45a of the optically-anisotropic layer 400. In this case, the light is reflected in a direction having an angle different from that of a specular reflection direction due to the diffraction effect of the region A45a without being specularly reflected (regularly reflected). In the example shown in FIG. 11, the light is incident from the direction (Z direction) substantially perpendicular to the region A45a of the optically-anisotropic layer 400, and is reflected in the direction which is tilted at a large angle from the perpendicular direction toward the longitudinal direction (X direction) side of the light guide plate 144.

Since the light reflected from the region A45a of the optically-anisotropic layer 400 is reflected at a large angle with respect to the angle of incident light, an angle of a light traveling direction with respect to the surface of the light guide plate 144 is small. Therefore, the light is totally reflected from the surface of the light guide plate 144 or the surface of the non-diffraction region 45b of the optically-anisotropic layer 400, and guided in the longitudinal direction (X direction) of the light guide plate 144. The guided light is reflected by the region B45c of the optically-anisotropic layer 400 at the other end part of the light guide plate 144 in the longitudinal direction. In this case, the light is reflected in a direction different from the specular reflection direction due to the diffraction effect of the region B45c of the optically-anisotropic layer 400 without being specularly reflected. In the example shown in FIG. 11, the light is incident on the region B45c of the optically-anisotropic layer 400 from an oblique direction, and is reflected in the direction perpendicular to the surface of the region B45c of the optically-anisotropic layer 400.

The light reflected from the region B45c of the optically-anisotropic layer 400 reaches the surface of the light guide plate 144 opposite to the surface on which the optically-anisotropic layer 400 is disposed, but the light is incident substantially perpendicular to the surface and thus is emitted to the outside of the light guide plate 144 without being totally reflected. That is, the light is emitted to the observation position of the user U. In this way, in the AR display device 50, an image displayed by the display 40 is incident into one end of the light guide plate 144, propagates in the light guide plate 144, and is emitted from the other end of the light guide plate 144 such that a virtual image is displayed to be superimposed on a scene that the user U actually sees.

Here, in the region B45c of the optically-anisotropic layer 400, the diffraction efficiency is adjusted, and in a case where the light propagating in the light guide plate 144 is diffracted by the region B45c of the optically-anisotropic layer 400, a part of the light is diffracted at a plurality of positions and emitted to the outside of the light guide plate 144. As a result, a viewing zone is expanded (exit pupil expansion). Specifically, in FIG. 11, light I₀ propagating in the light guide plate 144 reaches the position of the region B45c of the optically-anisotropic layer 400 while being repeatedly reflected from both surfaces (interfaces) of the light guide plate 144. A part of the light I₀ which has reached the position of the region B45c of the optically-anisotropic layer 400 is diffracted at a position P₁ close to the incidence side, and emitted from the light guide plate 144 (emitted light R₁). In addition, the light I₁ which is not diffracted further propagates in the light guide plate 144, and a part of light R₂ is diffracted at a position P₂ in the region B45c of the optically-anisotropic layer 400 again to be emitted from the light guide plate 144. The light I₂ which is not diffracted further propagates in the light guide plate 144, and a part of light R₃ is diffracted at a position P₃ in the region B45c of the optically-anisotropic layer 400 again to be emitted from the light guide plate 144. The light I₃ which is not diffracted further propagates in the light guide plate 144, and a part of light R₄ is diffracted at a position P₄ in the region B45c of the optically-anisotropic layer 400 again to be emitted from the light guide plate 144.

In this way, by adopting the configuration in which the light propagating in the light guide plate 144 is diffracted at a plurality of positions by the region B45c of the optically-anisotropic layer 400 and emitted to the outside of the light guide plate 144, the viewing zone can be expanded (exit pupil expansion).

Here, a configuration of a light guide element in the related art is shown in FIG. 24.

As shown in FIG. 24, in the light guide element in the related art, the liquid crystal diffraction element is not formed by one element, and two liquid crystal diffraction elements including a liquid crystal diffraction element 46 on the incidence side and a liquid crystal diffraction element 47 on the emission side are disposed on the main surface of the light guide plate 144 to be spaced from each other.

In this case, it is found that a part of light which is diffracted by the liquid crystal diffraction element 46 and guided in the light guide plate 144 is scattered by an element edge surface X of the liquid crystal diffraction element 46 and an element edge surface Y of the liquid crystal diffraction element 47, which causes a decrease in clearness of the image.

On the other hand, in the optically-anisotropic layer according to the embodiment of the present invention, since the region A and the region B having the diffraction effect and the non-diffraction region are integrally formed, in a case where the optically-anisotropic layer is combined with the light guide plate, light guided in the light guide plate can be prevented from being scattered from the edge surface of the diffraction element, and a clear image can be emitted from the light guide plate.

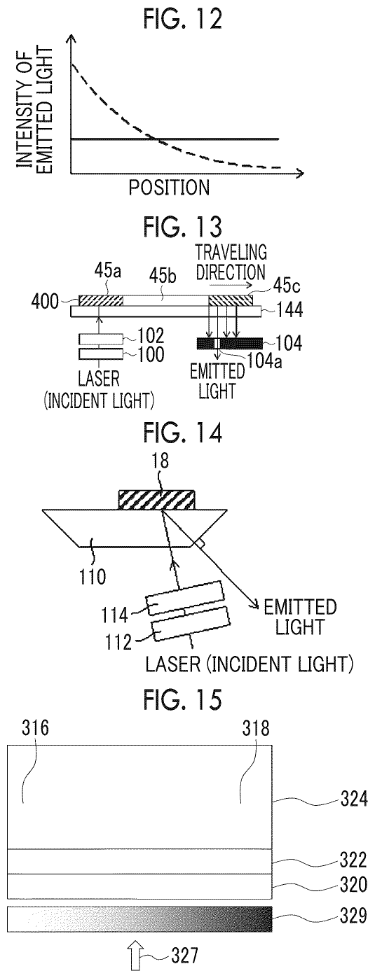

In addition, a case where the diffraction efficiency of the liquid crystal diffraction element 47 is constant in the plane will be considered. In a case where the diffraction efficiency is constant, at the position P₁ close to the incidence side, an intensity (light amount) of the incident light I₀ is high, and thus an intensity of the emitted light R₁ is also high. Next, the light I₁ which is not diffracted propagates in the light guide plate 144 and is diffracted again at the position P₂ of the liquid crystal diffraction element 47 such that a part of the diffracted light R₂ is emitted. However, since the intensity of the light I₁ is lower than that of the light I₀, even in a case where the light components are diffracted with the same diffraction efficiency, the intensity of the diffracted light R₂ is lower than that of the light R₁ reflected from the region close to the incidence side. Similarly, the light I₂ which is not diffracted propagates in the light guide plate 144 and is diffracted again at the position P₃ of the liquid crystal diffraction element 47 such that a part of the diffracted light R₃ is emitted. However, since the intensity of the light I₂ is lower than that of the light I₁, even in a case where the light components are diffracted with the same diffraction efficiency, the intensity of the diffracted light R₃ is lower than that of the light R₂ reflected from the position P₂. Furthermore, the intensity of the light R₄ reflected from the position P₄ distant from the incidence side is lower than that of the light R₃. As described above, in a case where the diffraction efficiency of the liquid crystal diffraction element 47 is constant in the plane, as indicated by a broken line in FIG. 12, light having a high intensity is emitted from a region close to the incidence side, and light having a low intensity is emitted from a region away from the incidence side. Therefore, there is a problem that the intensity of emitted light is non-uniform depending on the positions.

On the other hand, in the region B45c of the optically-anisotropic layer 400 according to the embodiment of the present invention, it is preferable to have a configuration in which the diffraction efficiency increases from one side toward the other side in the one direction in which the optical axis rotates, and to dispose the region B45c of the optically-anisotropic layer 400 such that the diffraction efficiency increases in the traveling direction of the light in the light guide plate 144. That is, in the example shown in FIG. 11, the region B45c of the optically-anisotropic layer 400 has a configuration in which the diffraction efficiency increases from the left side to the right side in FIG. 11.

In this case, at the position P₁ close to the incidence side, the intensity (light amount) of the incident light I₀ is high, but the diffraction efficiency is low, so that the intensity of the emitted light R₁ is high to some extent. Next, the light I₁ which is not diffracted propagates in the light guide plate 144 and is diffracted again at the position P₂ of the region B45c of the optically-anisotropic layer 400, and a part of the diffracted light R₂ is emitted. In this case, the intensity of the light I₁ is lower than that of the light I₀, but the diffraction efficiency at the position P₂ is higher than the diffraction efficiency at the position P₁, so that the intensity of the light R₂ can be made to be the same as that of the light R₁ reflected from the position P₁. Similarly, the light I₂ which is not diffracted propagates in the light guide plate 144 and is diffracted again at the position P₃ of the region B45c of the optically-anisotropic layer 400, and a part of the diffracted light R₃ is emitted. In this case, the intensity of the light I₂ is lower than that of the light I₁, but the diffraction efficiency at the position P₃ is higher than the diffraction efficiency at the position P₂, so that the intensity of the light R₃ can be made to be the same as that of the light R₂ reflected from the position P₂. Furthermore, the diffraction efficiency at the position P₄ distant from the incidence side is higher than that at the position P₃, so that the intensity of the light R₄ can be made to be the same as that of the light R₃ reflected from the position P₃. As described above, since the diffraction efficiency of the region B45c of the optically-anisotropic layer 400 increases from one side to the other side in the one direction in which the optical axis rotates, light having a constant intensity can be emitted from any position of the region B45c of the optically-anisotropic layer 400. Therefore, as indicated by a solid line in FIG. 12, the intensity of emitted light can be made uniform irrespective of positions.

In FIG. 11, the light is indicated by an arrow, but the light emitted from the display 40 may be planar light, and the planar light may be propagated in the light guide plate 144 while maintaining a positional relationship and may be diffracted by the region B45c of the optically-anisotropic layer 400.

In addition, in FIG. 11, the light guide element 45 has been described as having one optically-anisotropic layer, but as described above, the light guide element 45 may have a configuration in which a plurality of the optically-anisotropic layers 400 are provided. That is, a configuration in which the above-described laminate is used may be used. As described above, in a case where the laminate has the configuration in which a plurality of the optically-anisotropic layers are provided, it is preferable to have a configuration in which a plurality of optically-anisotropic layers having different selective reflection wavelengths in the region A and/or the region B are provided. For example, a configuration in which an optically-anisotropic layer having the region A and/or the region B having a selective reflection wavelength of each of red light, green light, and blue light can be adopted. As a result, the optically-anisotropic layer (or the laminate thereof) can diffract red light, green light, and blue light, respectively, and the light guide element can appropriately guide light of the display 40 which displays a color image. In this case, it is preferable that the length of the single period of the liquid crystal alignment pattern is appropriately changed according to the selective reflection wavelength of each layer. In addition, in a case where the region A and/or the region B is the cholesteric liquid crystal layer, it is preferable that the helical pitch is appropriately changed depending on the selective reflection wavelength of each layer. Alternatively, a configuration in which two optically-anisotropic layers having the region A and/or the region B having the same selective reflection wavelength and reflecting circularly polarized light having an opposite turning direction are provided may be used. For example, a configuration that an optically-anisotropic layer which reflects dextrorotatory circularly polarized red light and an optically-anisotropic layer which reflects levorotatory circularly polarized red light are provided can be adopted. As a result, the optically-anisotropic layer (or the laminate thereof) can diffract dextrorotatory circularly polarized light and levorotatory circularly polarized light, respectively, and the light guide element can guide dextrorotatory circularly polarized light and levorotatory circularly polarized light, and thus the light utilization efficiency can be improved. Alternatively, a configuration in which two optically-anisotropic layers having the region A and/or the region B having the same selective reflection wavelength, reflecting circularly polarized light having an opposite turning direction, and having different helical pitches are provided may be used. As a result, the optically-anisotropic layer (or the laminate thereof) can diffract dextrorotatory circularly polarized light and levorotatory circularly polarized light, respectively, and the light guide element can guide dextrorotatory circularly polarized light and levorotatory circularly polarized light incident at different incidence angles and can emit the guided light at different angles, and thus the field of view (FOV) can be increased.

In addition, in the example shown in FIG. 11, the optically-anisotropic layer 400 has the configuration in which the region A45a on the incidence side, the region B45c on the emission side, and the isotropic non-diffraction region 45b are provided. However, the present invention is not limited thereto, and the optically-anisotropic layer 400 may have a configuration in which an intermediate diffraction region, that is, the region C is provided as described above. That is, a configuration may be adopted in which light diffracted by the incidence-side diffraction region (region A) is incident into the light guide plate, the light is diffracted by the intermediate diffraction region (region C) to deflect a traveling direction of the light in the light guide plate, and then the light is diffracted by the diffraction region (region B) on the emission side to be emitted to the outside of the light guide plate. In this case, it is possible to form the incidence-side diffraction region and the intermediate diffraction region in one optically-anisotropic layer (that is, a configuration in which the region A acts as the incidence-side diffraction region and the region B acts as the intermediate diffraction region), to form the intermediate diffraction region and the emission-side diffraction region in one optically-anisotropic layer (that is, a configuration in which the region A acts as the intermediate diffraction region and the region B acts as the emission-side diffraction region), or to form all the diffraction regions in one optically-anisotropic layer (that is, a configuration in which the region A, the region B, and the region C described above are provided). However, from the viewpoint of increasing the clearness of the image, it is preferable to form as many diffraction regions as possible in one optically-anisotropic layer used in the light guide plate. In addition, in the configuration in which the intermediate diffraction region is provided, it is preferable that the efficiency of the intermediate diffraction region increases from one side toward the other side in order to make the emitted light intensity uniform. In addition, in order to make the emitted light intensity uniform, a configuration in which an in-plane distribution of the diffraction efficiency in the intermediate diffraction region and the emission-side diffraction region varies can also be preferably used.

It is preferable that a phase difference plate is laminated on the light guide element 45 in addition to the light guide plate 144 and the optically-anisotropic layer 400. As a result, the non-diffraction region 45b of the optically-anisotropic layer 400 converts the light guided in the light guide plate into linearly polarized light, as in a case where the non-diffraction region 45b of the optically-anisotropic layer 400 functions as a phase difference region, and thus the intensity of emitted light in the region B45c on the emission side can be made uniform. In addition, the polarization state of the linearly polarized light guided in the light guide plate may be eliminated in the region B45c on the emission side. Therefore, it is preferable that the phase difference plate is a phase difference plate in which phase differences different from each other in the in-plane direction are patterned such that a linear polarization state of the light guided in the light guide plate is maintained. Examples of such a phase difference plate include a phase difference plate consisting of a liquid crystal compound, and the phase difference plate can be obtained by, for example, patterning an alignment axis, a twist angle, an alignment degree, and the like of the liquid crystal compound.

In addition, in a case where the optically-anisotropic layer has the intermediate diffraction region (region C), a configuration in which the length of the single period, over which the orientation of the optical axis derived from the liquid crystal compound rotates by 180° in a plane, is shortened with respect to the incidence-side diffraction region can be preferably used. As a result, the light diffracted by the incidence-side diffraction region is diffracted by the intermediate diffraction region, and an angle at which the traveling direction of the light in the light guide plate is deflected can be increased, and thus the size of the light guide plate can be made compact. In addition, in a case where the single period of the intermediate diffraction region is shorter than that of the incidence-side diffraction region, it is preferable that the helical pitch of the cholesteric liquid crystal layer in the intermediate diffraction region is larger than the helical pitch of the cholesteric liquid crystal layer in the incidence-side diffraction region. As a result, in the intermediate diffraction region, the traveling direction of the light in the light guide plate can be efficiently deflected. In addition, in the intermediate diffraction region, a configuration in which the one direction of the liquid crystal alignment pattern in which the orientation of the optical axis derived from the liquid crystal compound rotates by 180° in a plane is different from that of the incidence-side diffraction region can be preferably used. As a result, the light diffracted by the incidence-side diffraction region is diffracted by the intermediate diffraction region, and the direction in which the traveling direction of the light in the light guide plate is deflected can be changed, and thus the light can be appropriately guided to the emission-side diffraction region.

In addition, a plurality of the incidence-side diffraction regions and a plurality of the intermediate diffraction regions may be disposed in the plane. In the plurality of incidence-side diffraction regions, the one direction of the liquid crystal alignment pattern which continuously rotates in the one in-plane direction varies; and light incident into the incidence-side diffraction region is guided in different directions in the light guide plate, is diffracted in the intermediate diffraction region disposed at different in-plane positions, and thus the traveling direction of the light in the light guide plate is deflected. Therefore, the light guided by the emission-side diffraction region can be emitted at different angles, and the field of view (FOV) can be increased. For example, as described in WO2020/122128A, in the incidence-side diffraction region and the intermediate diffraction region, the length of the single period over which the orientation of the optical axis derived from the liquid crystal compound rotates by 180° in a plane, the rotation direction of the optical axis derived from the liquid crystal compound in the liquid crystal alignment pattern which continuously rotates in the one in-plane direction, the length of the helical pitch in a case where the diffraction region is the cholesteric liquid crystal layer, and the direction of the helical twist rotation in the thickness direction can be appropriately set. In the plurality of the incidence-side diffraction regions, the rotation direction of the optical axis derived from the liquid crystal compound in the liquid crystal alignment pattern which continuously rotates in the one in-plane direction can be appropriately set, and the rotation direction of the optical axis derived from the liquid crystal compound in the liquid crystal alignment pattern which continuously rotates in the one in-plane direction may be different in the plurality of the incidence-side diffraction regions. In addition, in a case where the diffraction region is the cholesteric liquid crystal layer, in the plurality of the incidence-side diffraction regions, the direction of the helical twist rotation in the thickness direction (the turning direction of circularly polarized light to be reflected) can be appropriately set. Specifically, the plurality of the incidence-side diffraction regions may be a region where the cholesteric liquid crystal layer is right-handedly cholesterically aligned and a region where the cholesteric liquid crystal layer is left-handedly cholesterically aligned. In addition, as the intermediate diffraction region, a configuration in which the length of the single period, over which the orientation of the optical axis derived from the liquid crystal compound rotates by 180° in a plane, is shortened with respect to the incidence-side diffraction region can be preferably used; and in a case where the single period of the intermediate diffraction region is shorter than that of the incidence-side diffraction region, it is preferable that the helical pitch of the cholesteric liquid crystal layer in the intermediate diffraction region is larger than the helical pitch of the cholesteric liquid crystal layer in the incidence-side diffraction region, as described above. In addition, even in such a configuration, in order to make the emitted light intensity uniform, a configuration in which an in-plane distribution of the diffraction efficiency in the intermediate diffraction region and the emission-side diffraction region varies can also be preferably used.

In addition, different incidence-side diffraction regions, intermediate diffraction regions, and emission-side diffraction regions may be laminated. As described above, in a case where a plurality of the optically-anisotropic layers are laminated, it is also preferable that a plurality of the optically-anisotropic layers having different selective reflection wavelengths (helical pitches) are laminated. As a result, the optically-anisotropic layer (or the laminate thereof) can diffract light having different colors (wavelengths), and the light guide element can appropriately guide light of the display 40 which displays a color image. In this case, it is preferable that the length of the single period of the liquid crystal alignment pattern in each diffraction region is appropriately set according to the selective reflection wavelength of each diffraction region of each layer. Alternatively, a configuration in which two optically-anisotropic layers having a diffraction region having the same selective reflection wavelength and reflecting circularly polarized light having an opposite turning direction are laminated may be used. For example, a configuration that an optically-anisotropic layer having a diffraction region which reflects dextrorotatory circularly polarized red light and an optically-anisotropic layer having a diffraction region which reflects levorotatory circularly polarized red light are laminated can be adopted. As a result, the optically-anisotropic layer (or the laminate thereof) can diffract dextrorotatory circularly polarized light and levorotatory circularly polarized light, respectively, and the light guide element can guide dextrorotatory circularly polarized light and levorotatory circularly polarized light, and thus the light utilization efficiency can be improved. Alternatively, a configuration in which two optically-anisotropic layers having a diffraction region having the same selective reflection wavelength, reflecting circularly polarized light having an opposite turning direction, and having different helical pitches are laminated may be used. As a result, the optically-anisotropic layer (or the laminate thereof) can diffract dextrorotatory circularly polarized light and levorotatory circularly polarized light, respectively, and the light guide element can guide dextrorotatory circularly polarized light and levorotatory circularly polarized light incident at different incidence angles and can emit the guided light at different angles, and thus FOV can be increased. In addition, for example, in a case where a plurality of optically-anisotropic layers are laminated as described in WO2020/122128A, WO2020/075738A, WO2020/226078A, WO2021/060528A, and the like, it is also preferable that, with regard to the diffraction regions (the incidence-side diffraction region, the intermediate diffraction region, and the emission-side diffraction region) of the optically-anisotropic layers, a plurality of optically-anisotropic layers having diffraction regions in which the length of the single period of the liquid crystal alignment pattern, the one direction of the liquid crystal alignment pattern which continuously rotates in the one in-plane direction, and the rotation direction of the optical axis derived from the liquid crystal compound in the liquid crystal alignment pattern which continuously rotates in the one in-plane direction varies are laminated. In a case where the diffraction regions are the cholesteric liquid crystal layer, it is also preferable that a plurality of optically-anisotropic layers having diffraction regions in which the helical pitch and the direction of the helical twist rotation in the thickness direction (the turning direction of circularly polarized light to be reflected) varies are laminated, which can be appropriately set depending on the purpose. In addition, even in the case where a plurality of the optically-anisotropic layers are laminated, in order to make the emitted light intensity uniform, a configuration in which an in-plane distribution of the diffraction efficiency in the intermediate diffraction region and the emission-side diffraction region varies can also be preferably used. In addition, in a case where a plurality of the optically-anisotropic layers are laminated, a configuration in which the intermediate diffraction region in each layer and the emission-side diffraction region in each layer have different in-plane distributions of the diffraction efficiency in the diffraction region can also be preferably used. The disposition of the diffraction regions is not limited, and the diffraction regions can be appropriately disposed in the plane and in the thickness direction (lamination) as necessary.

In addition, the intermediate diffraction region and a diffraction region which serves as the emission-side diffraction region may be laminated. A configuration in which the optically-anisotropic layers are laminated such that, in the intermediate diffraction region and the emission-side diffraction region, the one direction of the liquid crystal alignment pattern which continuously rotates in the one in-plane direction varies can be used. In this case, it is preferable that, as the incidence-side diffraction region, a plurality of incidence-side diffraction regions in which the one direction of the liquid crystal alignment pattern which continuously rotates in the one in-plane direction varies are used, and light incident into the incidence-side diffraction regions is guided in different directions in the light guide plate. The plurality of incidence-side diffraction regions may be disposed at different positions in a plane or may be laminated. The light diffracted by the incidence-side diffraction region is incident into the light guide plate, the light is diffracted by the intermediate diffraction region to deflect the traveling direction of the light in the light guide plate, and then the light is diffracted by the diffraction region on the emission side, which is laminated with the intermediate diffraction region, to be emitted to the outside of the light guide plate. In the light diffracted by another incidence-side diffraction region and incident into the light guide plate, the above-described emission-side diffraction region functions as the intermediate diffraction region, the traveling direction of the light in the light guide plate is deflected, the above-described intermediate diffraction region functions as the emission-side diffraction region, and the light guided can be emitted at different angles. As a result, FOV can be increased in the light guide plate having a compact size, as compared with a case where the intermediate diffraction region and the emission-side diffraction region are disposed at different positions in a plane. For example, in a case where a plurality of optically-anisotropic layers are laminated as described in WO2021/201218A, WO2021/256453A, and the like, it is preferable that, in a case where the intermediate diffraction region and the diffraction region which serves as the emission-side diffraction region are laminated, a plurality of optically-anisotropic layers in which the length of the single period of the liquid crystal alignment pattern, the one direction of the liquid crystal alignment pattern which continuously rotates in the one in-plane direction, and the rotation direction of the optical axis derived from the liquid crystal compound in the liquid crystal alignment pattern which continuously rotates in the one in-plane direction varies are laminated. In a case where the diffraction regions are the cholesteric liquid crystal layer, it is also preferable that a plurality of optically-anisotropic layers in which the helical pitch and the direction of the helical twist rotation in the thickness direction (the turning direction of circularly polarized light to be reflected) varies are laminated, which can be appropriately set depending on the purpose. In addition, even in the configuration in which the intermediate diffraction region and the diffraction region which serves as the emission-side diffraction region are laminated, in order to make the emitted light intensity uniform, a configuration in which an in-plane distribution of the diffraction efficiency in the diffraction regions varies can also be preferably used. The disposition of the diffraction regions is not limited, and the diffraction regions can be appropriately disposed in the plane and in the thickness direction (lamination) as necessary.

In FIG. 11, the optically-anisotropic layer 400 having a reflective type diffraction region is used, but the present invention is not limited thereto, and an optically-anisotropic layer having a transmissive type diffraction region may be used. That is, the optically-anisotropic layer (or the incidence-side diffraction region thereof) may be disposed on the surface of the light guide plate 144 on the display 40 side.

### [Method of Forming Optically-Anisotropic Layer]

A manufacturing method of the optically-anisotropic layer according to the embodiment of the present invention is not particularly limited, but from the viewpoint that the optically-anisotropic layer can be efficiently manufactured, a manufacturing method including a step 1 to a step 3 is preferable.
Step 1: a step of forming a coating film using a composition which contains a liquid crystal compound having a polymerizable group, and aligning the liquid crystal compound in the formed coating film
Step 2: a step of polymerizing the liquid crystal compound such that regions having different polymerization rates of the liquid crystal compound are formed in an in-plane direction of the coating film
Step 3: a step of subjecting the coating film obtained in the step 2 to a heating treatment to change an alignment degree according to the polymerization rate in the step 2, thereby forming regions having different diffraction efficiencies

Hereinafter, the above-described steps 1 to 3 will be described in detail.

### (Step 1)

The step 1 is a step of forming a coating film using a composition which contains a liquid crystal compound having a polymerizable group, and aligning the liquid crystal compound in the formed coating film. By carrying out the present step, the coating film containing the aligned liquid crystal compound is formed.

As one suitable embodiment of the present step, it is preferable that the composition is applied onto an alignment film of a support with an alignment film, which has a support and an alignment film, to form a coating film, and the liquid crystal compound in the coating film is aligned. By carrying out the suitable aspect, a laminate including a support 320, an alignment film 322, and a coating film 324 (which is to be an optically-anisotropic layer in the subsequent step) is formed as shown in FIG. 15.

The composition containing a liquid crystal compound having a polymerizable group, which is used in the present step, is as described above.

As the liquid crystal compound used in the present step, a liquid crystal compound having a radically polymerizable group or a cationically polymerizable group is preferable, and a liquid crystal compound having a radically polymerizable group is more preferable.

For the application of the composition, various known methods used for liquid application, such as bar coating, gravure coating, and spray coating, can be used.

Next, the coating film formed by the application is subjected to an alignment treatment to align the liquid crystal compound. By carrying out the alignment treatment, the liquid crystal compound in the coating film is aligned in a predetermined alignment state according to the alignment pattern of the alignment film.

As the alignment treatment, a heating treatment is preferable. Heating conditions are not particularly limited, and a heating temperature is preferably 50° C. to 140° C. and a heating time is preferably 0.5 to 20 minutes.

### (Step 2)

The step 2 is a step of polymerizing the liquid crystal compound such that regions having different polymerization rates of the liquid crystal compound are formed in an in-plane direction of the coating film. The procedure of the present step is not particularly limited, but by performing the present step, regions where the degree of curing of the liquid crystal compound varies in the in-plane direction of the coating film are formed in at least a part of the plane.

An example of a method of obtaining the above-described configuration will be described with reference to FIG. 15. In a photo mask 329, a white portion represents that a transmittance is high, and a black portion represents that a transmittance is low. In a case where the exposure is performed from a direction indicated by a white arrow of the reference numeral 327, in a region 316 in the coating film 324, the energy of the exposure is strong according to the transmittance of the photo mask 329, and thus the polymerization of the liquid crystal compound sufficiently proceeds. On the other hand, in a region 318 in the coating film 324, the energy of the exposure is low according to the transmittance of the photo mask 329, and thus the polymerization of the liquid crystal compound does not proceed.

Since the alignment degree of the liquid crystal in the region 316 is high and the alignment degree of the liquid crystal in the region 318 is low as in the step 3 described later, a gradient of the alignment degree in both the regions is formed in the in-plane direction, and thus the diffraction efficiency gradually changes in the in-plane direction.

In the step 2, the liquid crystal compound may be polymerized such that regions having different polymerization rate distributions of the liquid crystal compound are formed in the in-plane direction and the thickness direction. Examples of a means for forming the regions having different degrees of curing of the liquid crystal compound in the thickness direction include a method of performing exposure or a heating treatment in an atmosphere containing a component which inhibits polymerization of oxygen, moisture, or the like, and a method of forming the coating film using a composition containing a compound which absorbs ultraviolet rays having an exposure wavelength, such as an ultraviolet absorber, and exposing the formed coating film.

An example of a method of obtaining the above-described configuration will be described with reference to FIG. 16. In the photo mask 329, a white portion represents that a transmittance is high, and a black portion represents that a transmittance is low. In a case where the exposure is performed from a direction indicated by a white arrow of the reference numeral 327, a first region 326 on an alignment film 322 side in the coating film 324 is not in contact with atmosphere, so that the supply of oxygen from the atmosphere is slow and the polymerization proceeds sufficiently. On the other hand, a second region 328 on the side of the coating film 324 opposite to the alignment film 322 side is in contact with the atmosphere, so that the supply of oxygen from the atmosphere is quick and the polymerization does not proceed. In this case, a thickness of the first region 326 gradually changes according to the transmittance of the photo mask 329.

Since the alignment degree of the liquid crystal in the first region 326 is high and the alignment degree of the liquid crystal in the second region 328 is low as in the step 3 described later, a gradient of the thickness in both the regions is formed in the in-plane direction, and thus the diffraction efficiency gradually changes in the in-plane direction.

In particular, in the step 3 described later, by setting the second region 328 to a non-aligned state, only the first region 326 having a high alignment degree can function as the diffraction element. As a result, the effective birefringence index of the liquid crystal compound is increased in a case where light is diffracted, and the diffraction efficiency can be improved. In addition, in a case where the light is diffracted, the effective refractive index of the liquid crystal compound increases, and the FOV can be widened, for example, in a case of being used for AR glasses.

The step 2 may be carried out by other methods.

The determination of whether or not the regions where the degree of curing of the liquid crystal compound varies in the in-plane direction of the coating film are formed can be performed, for example, by analyzing the surface of the coating film by infrared absorption spectroscopy or the like and calculating a residual rate of the polymerizable group in the in-plane direction of the coating film.

In the method of forming the coating film using the above-described composition containing the liquid crystal compound having a polymerizable group and exposing the formed coating film, an ultraviolet irradiating treatment is preferable as the exposure treatment.

Conditions for the ultraviolet irradiating treatment are appropriately selected according to the coating film to be used, and an irradiation amount is preferably 1 to 1,000 mJ/cm² and more preferably 10 to 300 mJ/cm².

### (Step 3)

The step 3 is a step of subjecting the coating film obtained in the step 2 to a heating treatment to form regions having different diffraction efficiencies in the in-plane direction.

The coating film obtained in the step 2 includes the regions having different polymerization rates of the liquid crystal compound in the in-plane direction of the coating film. In a case where the coating film is subjected to a heating treatment, the alignment state of the liquid crystal compound is maintained in a region where the polymerization rate of the liquid crystal compound is high. On the other hand, in a region where the polymerization rate of the liquid crystal compound is low, the alignment state of the liquid crystal compound cannot be maintained by the heating treatment, and thus the alignment degree of the liquid crystal compound decreases. In a case where the alignment degree of the liquid crystal compound decreases, the diffraction efficiency in the region also decreases. That is, by carrying out the present step, the region where the polymerization rate of the liquid crystal compound is high is to be a region where the diffraction efficiency is high, and the region where the polymerization rate of the liquid crystal compound is low is to be a region where the diffraction efficiency is low. In particular, in a region where the polymerization rate is sufficiently low, the liquid crystal is in a non-aligned state, and thus a region having no liquid crystal alignment pattern can be formed.

From the viewpoint that the average refractive indices are substantially the same, it is preferable that the region having the liquid crystal alignment pattern and the region not having the liquid crystal alignment pattern are formed of substantially the same material (liquid crystal composition). As a result, scattering at an interface between the region having the liquid crystal alignment pattern and the region not having the liquid crystal alignment pattern can be avoided. The material forming each region can be confirmed, for example, by analyzing components by secondary ion mass spectrometry (SIMS) analysis.

In this case, the average refractive index of the region having the liquid crystal alignment pattern is preferably within ±10% of the average refractive index of the region not having the liquid crystal alignment pattern.

The method of forming the region not having the liquid crystal alignment pattern is not limited to the present method, and examples thereof include a method of subjecting the alignment film to a non-patterned alignment treatment such as uniaxial alignment.

Conditions for the heating treatment carried out in the present step are not particularly limited, and optimal conditions are selected according to the coating film to be used. A heating temperature during the heating treatment is preferably 50° C. to 300° C. and more preferably 100° C. to 200° C. A heating time at the heating temperature is preferably 0.5 to 30 minutes and more preferably 1 to 5 minutes. In this case, in the region where the polymerization rate of the liquid crystal compound is low, in a case where the heating temperature is sufficiently high with respect to a liquid crystal phase-isotropic phase (Iso) transition temperature of the liquid crystal compound, an optically-isotropic region not have the liquid crystal alignment pattern is formed.

After the step 3 is performed, a step 4 of subjecting the optically-anisotropic layer obtained in the step 3 to an exposure treatment may be performed. By carrying out the exposure treatment, the unreacted polymerizable group can be polymerized. As the exposure treatment, an ultraviolet irradiating treatment is preferable.

Conditions for the ultraviolet irradiating treatment are appropriately selected according to the coating film to be used, and an irradiation amount is preferably 50 to 2,000 mJ/cm² and more preferably 100 to 1,000 mJ/cm².

The ultraviolet irradiating treatment is preferably carried out in an atmosphere with a low oxygen concentration. The ultraviolet irradiating treatment is preferably carried out in a nitrogen atmosphere.

In any of the optically-anisotropic layers as the above-described optically-anisotropic layer according to the embodiment of the present invention, the optical axis 30A of the liquid crystal compound 30 in the liquid crystal alignment pattern of the diffraction region continuously rotates only in the arrow X direction.

However, the present invention is not limited thereto, and various configurations can be used as long as the optical axis 30A of the liquid crystal compound 30 in the diffraction region continuously rotates in one direction.

As described above, the optically-anisotropic layer according to the embodiment of the present invention can also be formed by laminating a plurality of optically-anisotropic layers to form a laminate. The method of lamination includes a method of directly applying a liquid crystal composition to a first optically-anisotropic layer to form a second optically-anisotropic layer; a method of applying an alignment film to the first optically-anisotropic layer, performing an alignment treatment, and then applying a liquid crystal composition; and a method of bonding an optically-anisotropic layer provided on another substrate. The grating pitch, the grating angle, the helical pitch, the change in helical pitch in the thickness direction, the tilt angle, the change in tilt angle in the thickness direction, the change in Δn in the thickness direction, the size of the diffraction region, the shape of the diffraction region, the physical film thickness, the optical thickness, and the reflectivity for each wavelength in the diffraction region of each optically-anisotropic layer can be optionally adjusted. In addition, in one diffraction region, the grating pitch, the grating angle, the helical pitch, the helical pitch change in the thickness direction, the Δn change in the thickness direction, the tilt angle, the tilt angle change in the thickness direction, the physical thickness, the optical thickness, and the reflectivity for each wavelength can be changed in the in-plane direction, and the direction of the change and the inclination of the change can also be optionally adjusted. In addition, diffraction regions in which the above-described parameters are adjusted can be optionally combined.

In the optically-anisotropic layer according to the embodiment of the present invention, in at least one of the above-described region A or the above-described region B, it is preferable that a region in which the length of the helical pitch of the cholesteric liquid crystal layer varies is provided in the region, and it is more preferable that the length of the helical pitch of the cholesteric liquid crystal layer continuously changes in the region. By changing the length of the helical pitch, a diffraction angle of the diffraction region at a certain wavelength can be controlled. Accordingly, as shown in FIG. 11, by designing the helical pitch to have an appropriate diffraction angle at the positions P₁, P₂, P₃, and P₄ of the region B45c, the amount of light reaching eyes is increased, and thus the brightness of the AR glasses can be increased.

In addition, in the present invention, a plurality of units with different alignment regions can be formed in one substrate, in which a region including at least the region A having the liquid crystal alignment pattern in which the orientation of the optical axis derived from the liquid crystal compound continuously rotates in at least one in-plane direction, the region B having the liquid crystal alignment pattern in which the orientation of the optical axis derived from the liquid crystal compound continuously rotates in at least one in-plane direction, and the region not having the liquid crystal alignment pattern is used as one unit. By forming a plurality of the units in one substrate, not only the process of forming the optically-anisotropic layer according to the embodiment of the present invention but also the productivity of downstream process can be improved.

### <Adhesive Layer (Pressure-Sensitive Adhesive Layer) and Adhesive>

The laminate and the light guide element may include an adhesive layer for adhesion between the optically-anisotropic layers and/or between the optically-anisotropic layer and the light guide plate. In the present specification, the “adhesive” is used as a concept including “pressure-sensitive adhesive”.

Examples thereof include a water-soluble adhesive, an ultraviolet curable adhesive, an emulsion type adhesive, a latex type adhesive, a mastic adhesive, a multi-layered adhesive, a paste-like adhesive, a foaming adhesive, a supported film adhesive, a thermoplastic adhesive, a hot-melt adhesive, a thermally solidified adhesive, a thermally activated adhesive, a heat-seal adhesive, a thermosetting adhesive, a contact type adhesive, a pressure-sensitive adhesive, a polymerizable adhesive, a solvent type adhesive, a solvent-activated adhesive, and a ceramic adhesive. Specific examples thereof include a boron compound aqueous solution, a curable adhesive of an epoxy compound not having an aromatic ring in a molecule, as described in JP2004-245925A; an active energy ray-curable adhesive having a molar absorption coefficient of 400 or more at a wavelength of 360 to 450 nm and containing a photopolymerization initiator and an ultraviolet curable compound as essential components, as described in JP2008-174667A; and an active energy ray-curable adhesive containing (a) a (meth)acrylic compound having two or more (meth)acryloyl groups in a molecule, (b) a (meth)acrylic compound having a hydroxyl group and only one polymerizable double bond in a molecule, and (c) a phenol ethylene oxide modified acrylate or a nonyl phenol ethylene oxide modified acrylate with respect to 100 parts by mass of the total amount of the (meth)acrylic compounds, as described in JP2008-174667A. As necessary, various adhesives can be used alone or as a mixture of two or more kinds.

In the laminate and the light guide element, from the viewpoint of reducing unnecessary reflection, it is preferable that a difference in refractive index between the adhesive layer and a layer adjacent thereto is small. Specifically, the difference in refractive index with the adjacent layer is preferably 0.1 or less, more preferably 0.05 or less, and still more preferably 0.01 or less. A method of adjusting the refractive index of the adhesive layer is not particularly limited, and for example, a known method such as a method of adding fine particles of zirconia, silica, acryl, acrylic-styrene, melamine, or the like, a method of adjusting the refractive index by a resin, and a method described in JP1999-223712A (JP-H11-223712A) can be used.

In addition, in a case where the adjacent layer has refractive index anisotropy in the plane, the difference in refractive index with the adjacent layer is preferably 0.2 or less, more preferably 0.1 or less, and still more preferably 0.05 or less in all directions in the plane. Therefore, the adhesive layer may have refractive index anisotropy in a plane.

In a case where the difference in refractive index between adhesion interfaces is large, an interface reflectivity can be reduced by generating a refractive index distribution in the thickness direction of the adhesive layer. Examples of a method of generating the refractive index distribution in the thickness direction include a method of providing a plurality of adhesive layers, a method of mixing interfaces between a plurality of adhesive layers provided, and a method of controlling an uneven distribution state of a material in the adhesive layer to generate the refractive index distribution.

In addition, the adhesive layer can be provided on one member or both members to be bonded using any method such as application, vapor deposition, or transfer, and from the viewpoint of increasing an adhesion strength, a post-treatment such as a heating treatment and ultraviolet irradiation can be performed according to the type of the adhesive. A thickness of the adhesive layer can be optionally adjusted, but is preferably 20 μm or less, more preferably 0.1 μm or less, and still more preferably 0.01 μm or less. Examples of a method of forming the adhesive layer having a thickness of 0.1 μm or less include a method of vapor-depositing a ceramic adhesive such as silicon oxide (SiOx layer) on a bonding surface. For the bonding surface of the bonding member, before the bonding, for example, a surface reforming treatment such as a plasma treatment, a corona treatment, and a saponification treatment can be performed, and a primer layer can be applied. In addition, in a case where a plurality of bonding surfaces are present, the kind and thickness of the adhesive layer can be adjusted for each of the bonding surfaces.

### <Cutting of Optically-Anisotropic Layer and Laminate>

The produced optically-anisotropic layer and/or laminate can be cut into a predetermined size. A method of cutting the optically-anisotropic layer and/or the laminate is not particularly limited, and for example, various known methods such as a method of physically cutting the laminate using a blade such as a Thomson blade and a method of cutting the laminate by laser irradiation can be used. In a case where laser is used, it is preferable to select a pulse width (nanoseconds, picoseconds, or femtoseconds) and a wavelength in consideration of cuttability, damage to a material, and the like. In addition, after processing the optically-anisotropic layer and/or the laminate into a predetermined shape, for example, the edge surface may be polished. From the viewpoint of improving workability during cutting and suppressing dust generation, the optically-anisotropic layer and/or the laminate can also be cut in a state in which a peelable protective film is attached. In addition, for example, by cutting the optically-anisotropic layer and/or the laminate while observing the liquid crystal alignment pattern by a method described in JP2004-141889A, a cutting position can be optionally determined. In this case, in order to make the liquid crystal alignment pattern visible, the liquid crystal alignment pattern can also be observed through a polarizing plate, a phase difference film, or the like. In addition, in a case where a plurality of the units are provided on one substrate, it is preferable to cut and cut out each unit.

### <Other Treatments>

From the viewpoint of accurately installing the optically-anisotropic layer (or the laminate) in various devices (for example, the light guide plate), improving the accuracy of the axis and the cutting position during cutting, and the like, a mark having an optional shape can be provided as necessary. The kind of the mark can be freely selected, and a method of physically forming the mark using a laser, an ink jet method, or the like, a method of partially changing the alignment state of the liquid crystal, a method of forming a region which is partially decolored or colored, or the like can be selected.

In addition, in order to protect the optically-anisotropic layer, optionally, a protective layer (a gas barrier layer, a layer for blocking moisture or the like, an ultraviolet absorbing layer, a scratch resistance layer, a transparent colored layer, or the like) can be provided. The protective layer can be directly formed on the optically-anisotropic layer, or may be provided through another optical film such as a pressure-sensitive adhesive layer. An antireflection layer (a low-reflection (LR) layer, an anti-reflection (AR) layer, a moth-eye layer, or the like) may be provided for the purpose of reducing reflectivity of the surface. Various protective layers can be appropriately selected from known protective layers. In a case where the gas barrier layer is provided, polyvinyl alcohol, glass, or the like is preferable. The polyvinyl alcohol can also have a function as a polarizer. In addition, the ultraviolet absorbing layer is a layer containing an ultraviolet absorber, and as the ultraviolet absorber, from the viewpoint of excellent absorbing capability of ultraviolet light having a wavelength of 370 nm or less and excellent display properties, an ultraviolet absorber having small absorption of visible light having a wavelength of 400 nm or more is preferably used. As the ultraviolet absorber, one kind may be used alone or two or more kinds may be used in combination. Examples thereof include ultraviolet absorbers described in JP2001-072782A and JP2002-543265A. Specific examples of the ultraviolet absorber include an oxybenzophenone-based compound, a benzotriazole-based compound, a salicylic acid ester-based compound, a benzophenone-based compound, a cyanoacrylate-based compound, and a nickel complex salt-based compound. The transparent colored layer is a layer which absorbs or reflects at least a part of visible light. By combining the transparent colored layer with the optically-anisotropic layer, the tint of the optical element including the optically-anisotropic layer can be adjusted. For example, in a case where the optically-anisotropic layer has a tint, the tint can be adjusted to a neutral tint by combining the transparent colored layer.

The optically-anisotropic layer according to the embodiment of the present invention can be used for various applications where light is reflected (diffracted) or transmitted (diffracted) at an angle other than specular reflection, such as an optical path changing member, a light collecting element, a light diffusing element in a predetermined direction, and a diffraction element in an optical device.

In the above-described examples, the optically-anisotropic layer (diffraction region) according to the embodiment of the present invention is used as an optically-anisotropic layer which reflects or transmits visible light. However, the present invention is not limited thereto, and various configurations can be used.

For example, the optically-anisotropic layer (diffraction region) according to the embodiment of the present invention may be configured to reflect or transmit infrared rays or ultraviolet rays, or may be configured to reflect or transmit only light other than the visible light.

In addition, the optically-anisotropic layer according to the embodiment of the present invention can be used in combination with other members. For example, the optically-anisotropic layer according to the embodiment of the present invention can be used in combination with a configuration in which the optically-anisotropic layer is sandwiched between two glass plates, a low reflective layer, an ultraviolet absorbing layer, a polarizing plate, a lens member, and the like.

Hereinabove, the optically-anisotropic layer, the laminate, the light guide element, and the AR display device according to the embodiments of the present invention have been described in detail, but the present invention is not limited to the above-described examples, and various improvements and modifications can be made without departing from the scope of the present invention.

### EXAMPLES

Hereinafter, the characteristics of the present invention will be described in detail by Examples. Materials, chemicals, used amounts, material amounts, ratios, treatment details, treatment procedures, and the like shown in the following examples can be appropriately changed within a range not departing from the scope of the present invention. Therefore, the scope of the present invention should not be construed as being limited to the following specific examples.

### Example 1

### (Formation of Alignment Film)

A glass substrate was used as a support. The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

### Alignment Film-Forming Coating Liquid

| | |
|---|---|
| Material for photo alignment shown below | 1.00 part by mass |
| Water | 16.00 parts by mass |
| Butoxyethanol | 42.00 parts by mass |
| Propylene glycol monomethyl ether | 42.00 parts by mass |

-Material for photo alignment-

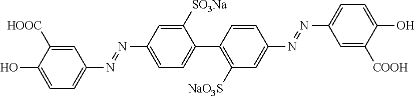

### (Exposure of Alignment Film)

Using an exposure device shown in FIG. 3, a region 1 and a region 2 in a part of the alignment film were exposed to form an alignment film P-1 having an alignment pattern. In this case, by rotating the orientation of the alignment film by 180° and then performing exposure, the alignment pattern of the region 2 was reversed by 180° with respect to the alignment pattern of the region 1. In the exposure device, a laser which emits laser light having a wavelength (325 nm) was used as the laser. An exposure amount of the interference light was set to 300 mJ/cm². A single period Λ (length over which the optical axis rotated by) 180° of the alignment pattern formed by interference of two laser beams was controlled to be 0.44 μm by changing an intersecting angle between the two beams (intersecting angle α).

### (Formation of Optically-Anisotropic Layer)

As a liquid crystal composition forming an optically-anisotropic layer, the following composition LC-1 was prepared.

Composition LC-1

| | | |
|---|---|---|
| Rod-like liquid crystal compound L-1 | 90.00 | parts by mass |
| Rod-like liquid crystal compound L-2 | 10.00 | parts by mass |
| Polymerization initiator (manufactured by BASF SE, Omnirad (registered trademark) 819) | 3.00 | parts by mass |
| Chiral agent Ch-1 | 5.20 | parts by mass |
| Leveling agent T-1 | 0.10 | parts by mass |
| Methyl ethyl ketone | 126.7 | parts by mass |
| Cyclopentanone | 126.7 | parts by mass |

Rod-like liquid crystal compound L-1 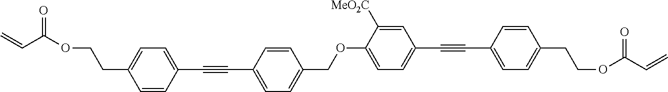 [SMILES: C=CC(=O)OCCc1ccc(C#Cc2ccc(COc3ccc(C#Cc4ccc(CCOC(=O)C=C)cc4)cc3C(=O)OC)cc2)cc1]
Rod-like liquid crystal compound L-2 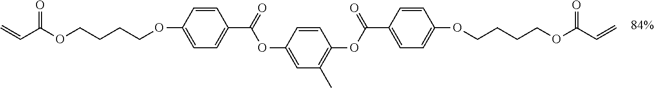 [SMILES: C=CC(=O)OCCCCOc1ccc(C(=O)Oc2ccc(OC(=O)c3ccc(OCCCCOC(=O)C=C)cc3)c(C)c2)cc1] 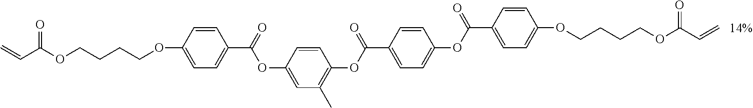 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1] 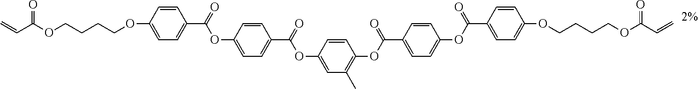 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Chiral agent Ch-1 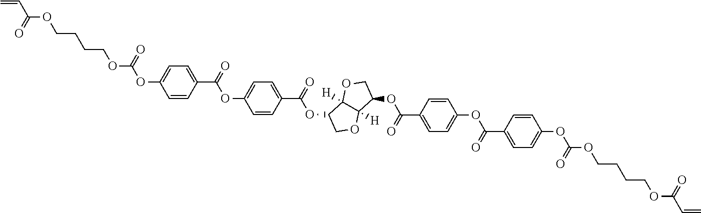
Leveling agent T-1

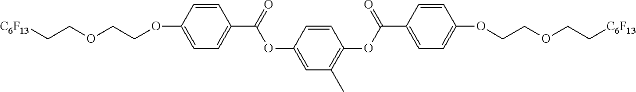

The prepared composition LC-1 was applied onto the alignment film P-1 to form a composition layer. The application was carried out using a spin coater at 1,500 rpm. The support having the composition layer was heated on a hot plate at 120° C. for 1 minute. Subsequently, a mask MK-1 was disposed on the composition layer, and through the mask MK-1, the composition layer was exposed to ultraviolet light having a wavelength of 365 nm at an irradiation amount of 20 mJ/cm² using a 365 nm LED UV exposure machine at 40° C. in a nitrogen atmosphere. The irradiation amount of the ultraviolet light with which the composition layer was irradiated through the mask MK-1 and a positional relationship between the regions of the alignment film were as shown in FIG. 17. Subsequently, a heating treatment was carried out at 200° C. (equal to or higher than liquid crystal phase-isotropic phase (Iso) of the liquid crystal composition) for 1 minute, and the coating film was irradiated with ultraviolet light having a wavelength of 365 nm at an irradiation amount of 300 mJ/cm² using a 365 nm LED UV exposure machine at 200° C. in a nitrogen atmosphere. As a result, the alignment of the liquid crystal compound was immobilized, and an optically-anisotropic layer was formed. The optically-anisotropic layer was produced such that a thickness thereof was 2 μm.

In the optically-anisotropic layer, a non-diffraction region was formed at a position where the irradiation amount shown in FIG. 17 was 0 mJ/cm², a region A (diffraction region) was formed at a position where the irradiation amount of the region 1 was more than 0 mJ/cm², and a region B (diffraction region) was formed at a position where the irradiation amount of the region 2 was more than 0 mJ/cm².

### [Evaluation]

### (Evaluation of Diffraction Efficiency)

As shown in FIG. 14, the optically-anisotropic layer produced above was disposed on a surface of a dove prism 110, and a diffraction efficiency at each position of the optically-anisotropic layer was evaluated. In FIG. 14, a dove prism made of glass and having a refractive index of 1.5 was used as the dove prism 110. In addition, the optically-anisotropic layer was used after being peeled off from the glass substrate. The optically-anisotropic layer and the dove prism were adhered to each other using a heat-sensitive adhesive.

As shown in FIG. 14, the optically-anisotropic layer was disposed on an upper surface of the dove prism 110, a laser was disposed to face an inclined surface of the dove prism 110, and a linear polarizer 112 and a λ/4 plate 114 were disposed between the laser and the dove prism 110.

In a case where light was emitted from the laser, the light transmitted through the linear polarizer 112 and the λ/4 plate 114 to be converted into dextrorotatory circularly polarized light, was incident into the dove prism 110, propagated in the dove prism 110, and was incident into the optically-anisotropic layer. The diffracted light which was reflected and diffracted by the optically-anisotropic layer propagated in the dove prism 110 in a direction opposite to the surface on which the optically-anisotropic layer was disposed. The light propagated through the dove prism 110 reached a lower surface of the dove prism 110 and was emitted.

In FIG. 17, in a case where a position of an end part of the optically-anisotropic layer on a side where the laser light was incident was set to 0 mm, the diffraction efficiency at each position at an interval of 5 mm was measured. A wavelength of the laser light was 532 nm, an incidence angle of the laser light incident into the optically-anisotropic layer was set to 55.6° with respect to a normal direction of the optically-anisotropic layer, and an intensity of light reflected and diffracted by the optically-anisotropic layer and emitted in the normal direction of the optically-anisotropic layer (normal direction of the lower surface of the dove prism 110) was measured.

A diffraction efficiency Deff of the produced optically-anisotropic layer was calculated by the following expression in a case where the intensity of the laser light incident into the dove prism 110 was denoted by Iᵢₙ and the intensity of the light diffracted by the optically-anisotropic layer and emitted from the dove prism 110 was denoted by Iₒᵤₜ.

$$Diffraction efficiency Deff = {I}_{out} / {I}_{in}$$

In a case where the diffraction efficiency was calculated, the diffraction efficiency was calculated except for a loss of the transmittance at the interface during the incidence and emission of the light into and from the dove prism 110.

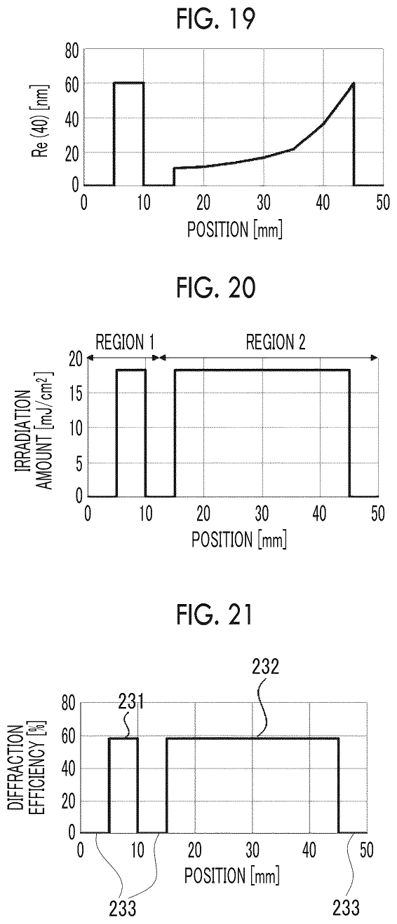

As a result of evaluating the diffraction efficiency of the optically-anisotropic layer produced by the above-described method, the diffraction efficiency at a position of 25 mm was 13%, the diffraction efficiency at a position of 35 mm was 21%, and the diffraction efficiency at a position of 45 mm was 58%. FIG. 18 shows a distribution of the diffraction efficiency. In FIG. 18, the reference numeral 221 corresponds to the region A, the reference numeral 222 corresponds to the region B, and the reference numeral 223 corresponds to the region not having the alignment pattern (non-diffraction region). The region A represented by the reference numeral 221 had a constant diffraction efficiency, and the region B represented by the reference numeral 222 had an increasing diffraction efficiency from one side to the other side. The non-diffraction region of the reference numeral 223 being isotropic could be confirmed from the fact that Re(40) was zero. FIG. 19 shows the measurement results of Re(40) at each position.

### [Evaluation]

### (Evaluation of Distribution of Emitted Light Intensity)

As shown in FIG. 13, the optically-anisotropic layer (reference numeral 400) produced above was disposed on the surface of the light guide plate 144 to produce a light guide element. In FIG. 13, a glass light guide plate having a refractive index of 1.5 and a thickness of 1 mm was used as the light guide plate 144. In addition, the optically-anisotropic layer was used after being peeled off from the glass substrate. The optically-anisotropic layer and the light guide plate 144 were adhered to each other using a heat-sensitive adhesive.

As shown in FIG. 13, a laser was disposed on a surface of an end part of the light guide plate 144 with a region A45a, on a side opposite to a surface on which the optically-anisotropic layer 400 was disposed, and a linear polarizer 100 and a λ/4 plate 102 were disposed between the laser and the light guide plate 144. A power meter (not shown) was disposed on a surface of an end part of the light guide plate 144 with a region B45c, on a side opposite to the surface on which the optically-anisotropic layer 400 was disposed, at a distance of 10 cm from the optically-anisotropic layer 400. A wavelength of the laser light was 532 nm, and a beam diameter of the laser light was 1 mm.

In a case where light was emitted from the laser, the light transmitted through the linear polarizer 100 and the λ/4 plate 102 to be converted into dextrorotatory circularly polarized light, and was incident into the light guide plate 144. The light incident into the light guide plate 144 was incident into the region A45a of the optically-anisotropic layer 400. Due to the diffraction action and the selective reflection action of the region A45a of the optically-anisotropic layer 400, the diffracted light which was reflected and diffracted propagated in the light guide plate 144. The light propagated in the light guide plate 144 was diffracted and reflected from the region B45c of the optically-anisotropic layer 400, and emitted in the direction of the power meter.

In addition, a light screen was disposed between the light guide plate 144 and the power meter on a surface facing the surface opposite to the surface on which the optically-anisotropic layer 400 was disposed. In a light screen 104, a pinhole 104a having a diameter of 2 mm was formed.

An intensity (emitted light intensity) of the light emitted from the light guide plate 144 was measured through the pinhole 104a of the light screen 104. By changing the position of the pinhole 104a, the emitted light intensity was measured for each position of the region B45c. The emitted light intensity was measured using a Power Meter 1918-C manufactured by Newport Corporation.

In a case where the amount of light emitted from the light guide plate 144 was checked, it was confirmed that the emission intensity was uniform.

### [Evaluation]

### (Evaluation of Brightness Uniformity and Image Clearness)

Smart glasses (Vuzix Blade 2) of Vuzix Corporation were disassembled, and the light guide element according to the embodiment of the present invention was installed instead of a light guide plate of the product. Thereafter, uniformity of brightness of the display image and clearness of the image were evaluated. The brightness of the display image was uniform, and the image was clear.

### Example 2

An optically-anisotropic layer was formed by the same method as in Example 1, except that the mask used was changed to a mask MK-2. The irradiation amount of the ultraviolet light with which the composition layer was irradiated through the mask MK-2 and a positional relationship between the regions of the alignment film were as shown in FIG. 20.

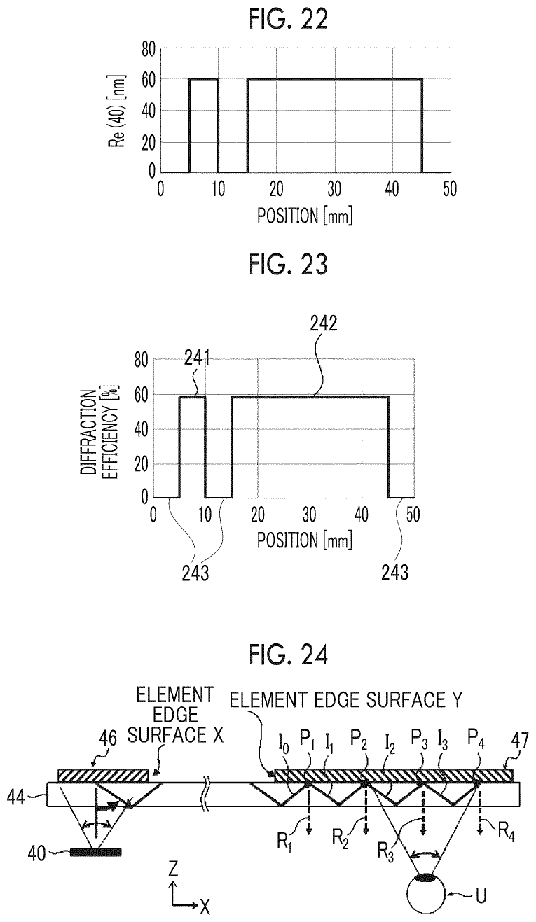

Subsequently, the diffraction efficiency and Re(40) of the optically-anisotropic layer were measured by the same methods as in Example 1. FIG. 21 shows the diffraction efficiency, and FIG. 22 shows the measurement results of Re(40).

Subsequently, the brightness uniformity and the image clearness were evaluated by the same method as in Example 1. The brightness of the display image was non-uniform in a plane, but the image was clear.

### Example 3

An optically-anisotropic layer was formed by the same method as in Example 1, except that the composition used was changed to a composition LC-3.

Composition LC-3

| | | |
|---|---|---|
| Rod-like liquid crystal compound L-3 | 100.00 | parts by mass |
| Polymerization initiator (manufactured by BASF SE, Omnirad (registered trademark) 819) | 3.00 | parts by mass |
| Chiral agent Ch-1 | 5.20 | parts by mass |
| Leveling agent T-1 | 0.10 | parts by mass |
| Methyl ethyl ketone | 210.5 | parts by mass |
| Cyclopentanone | 210.5 | parts by mass |

Rod-like liquid crystal compound L-3

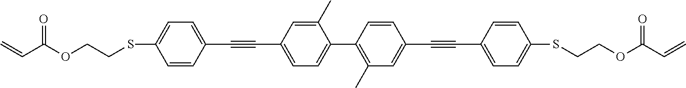 [SMILES: C=CC(=O)OCCSc1ccc(C#Cc2ccc(-c3ccc(C#Cc4ccc(SCCOC(=O)C=C)cc4)cc3C)c(C)c2)cc1]

Subsequently, the diffraction efficiency and Re(40) of the optically-anisotropic layer were measured by the same methods as in Example 1. The diffraction efficiency and Re(40) were substantially the same as those in Example 1. Subsequently, the brightness uniformity and the image clearness were evaluated by the same method as in Example 1. The brightness of the display image was uniform in a plane, and the image was clear.

### Example 4

An optically-anisotropic layer was formed by the same method as in Example 1, except that the composition used was changed to a composition LC-4.

Composition LC-4

| | | |
|---|---|---|
| Rod-like liquid crystal compound L-4 | 100.00 | parts by mass |
| Polymerization initiator (manufactured by BASF SE, Omnirad (registered trademark) 819) | 3.00 | parts by mass |
| Chiral agent Ch-1 | 5.20 | parts by mass |
| Leveling agent T-1 | 0.10 | parts by mass |
| Methyl ethyl ketone | 210.5 | parts by mass |
| Cyclopentanone | 210.5 | parts by mass |

Rod-like liquid crystal compound L-4

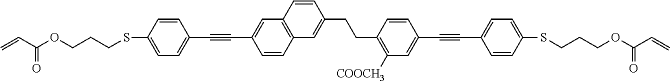 [SMILES: C=CC(=O)OCCCSc1ccc(C#Cc2ccc(CCc3ccc4cc(C#Cc5ccc(SCCCOC(=O)C=C)cc5)ccc4c3)c(C(=O)OC)c2)cc1]

Subsequently, the diffraction efficiency and Re(40) of the optically-anisotropic layer were measured by the same methods as in Example 1. The diffraction efficiency and Re(40) were substantially the same as those in Example 1. Subsequently, the brightness uniformity and the image clearness were evaluated by the same method as in Example 1. The brightness of the display image was uniform in a plane, and the image was clear.

### Example 5

As a liquid crystal composition forming an optically-anisotropic layer, the following composition LC-5 was prepared.

Composition LC-5

| | | |
|---|---|---|
| Rod-like liquid crystal compound L-5 | 100.00 | parts by mass |
| Polymerization initiator (manufactured by BASF SE, Omnirad (registered trademark) 819) | 3.00 | parts by mass |
| Chiral agent Ch-1 | 5.20 | parts by mass |
| Leveling agent T-1 | 0.10 | parts by mass |
| Methyl ethyl ketone | 210.5 | parts by mass |
| Cyclopentanone | 210.5 | parts by mass |

Rod-like liquid crystal compound L-5

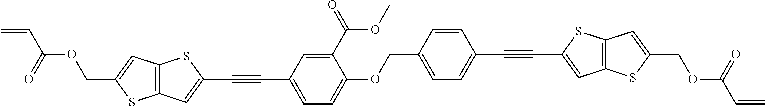 [SMILES: C=CC(=O)OCc1cc2sc(C#Cc3ccc(COc4ccc(C#Cc5cc6sc(COC(=O)C=C)cc6s5)cc4C(=O)OC)cc3)cc2s1]

The prepared composition LC-5 was applied onto the alignment film P-1 to form a composition layer. The application was carried out using a spin coater at 1,500 rpm. The support having the composition layer was heated on a hot plate at 140° C. for 1 minute. Subsequently, a mask MK-1 was disposed on the composition layer, and through the mask MK-1, the composition layer was exposed to ultraviolet light having a wavelength of 365 nm for 10 seconds at an illuminance of 20 mW/cm² using a 365 nm LED UV exposure machine at 120° C. in the atmosphere.

Subsequently, a heating treatment was carried out at 200° C. (equal to or higher than liquid crystal phase-isotropic phase (Iso) of the liquid crystal composition) for 1 minute, and the coating film was irradiated with ultraviolet light having a wavelength of 365 nm at an irradiation amount of 300 mJ/cm² using a 365 nm LED UV exposure machine at 200° C. in a nitrogen atmosphere. As a result, the alignment of the liquid crystal compound was immobilized, and an optically-anisotropic layer was formed.

Subsequently, the diffraction efficiency and Re(40) of the optically-anisotropic layer were measured by the same methods as in Example 1. The diffraction efficiency and Re(40) were substantially the same as those in Example 1. Subsequently, the brightness uniformity and the image clearness were evaluated by the same method as in Example 1. The brightness of the display image was uniform in a plane, the image was clear, and a viewing angle was wider than that of Example 1.

### Example 6

As a liquid crystal composition forming an optically-anisotropic layer, the following composition LC-6 was prepared.

Composition LC-6

| | | |
|---|---|---|
| Rod-like liquid crystal compound L-6 | 100.00 | parts by mass |
| Polymerization initiator (manufactured by BASF SE, Omnirad (registered trademark) 819) | 3.00 | parts by mass |
| Chiral agent Ch-1 | 5.20 | parts by mass |
| Leveling agent T-1 | 0.10 | parts by mass |
| Methyl ethyl ketone | 210.5 | parts by mass |
| Cyclopentanone | 210.5 | parts by mass |

Rod-like liquid crystal compound L-6

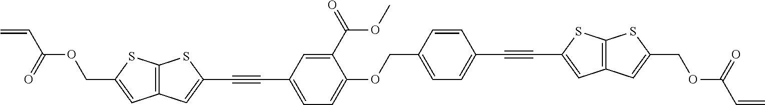 [SMILES: C=CC(=O)OCc1cc2cc(C#Cc3ccc(COc4ccc(C#Cc5cc6cc(COC(=O)C=C)sc6s5)cc4C(=O)OC)cc3)sc2s1]

The prepared composition LC-6 was applied onto the alignment film P-1 to form a composition layer. The application was carried out using a spin coater at 1,500 rpm. The support having the composition layer was heated on a hot plate at 140° C. for 1 minute. Subsequently, a mask MK-1 was disposed on the composition layer, and through the mask MK-1, the composition layer was exposed to ultraviolet light having a wavelength of 365 nm for 10 seconds at an illuminance of 20 mW/cm² using a 365 nm LED UV exposure machine at 120° C. in the atmosphere.

Subsequently, a heating treatment was carried out at 200° C. (equal to or higher than liquid crystal phase-isotropic phase (Iso) of the liquid crystal composition) for 1 minute, and the coating film was irradiated with ultraviolet light having a wavelength of 365 nm at an irradiation amount of 300 mJ/cm² using a 365 nm LED UV exposure machine at 200° C. in a nitrogen atmosphere. As a result, the alignment of the liquid crystal compound was immobilized, and an optically-anisotropic layer was formed.

Subsequently, the diffraction efficiency and Re(40) of the optically-anisotropic layer were measured by the same methods as in Example 1. The diffraction efficiency and Re(40) were substantially the same as those in Example 1. Subsequently, the brightness uniformity and the image clearness were evaluated by the same method as in Example 1. The brightness of the display image was uniform in a plane, the image was clear, and a viewing angle was wider than that of Example 1.

### Comparative Example 1

### (Exposure of Alignment Film)

The alignment film was exposed using the exposure device shown in FIG. 3 to form an alignment film P-2 having a single alignment pattern. In the exposure device, a laser which emits laser light having a wavelength (325 nm) was used as the laser. An exposure amount of the interference light was set to 300 mJ/cm². A single period Λ (length over which the optical axis rotated by) 180° of the alignment pattern formed by interference of two laser beams was controlled to be 0.44 μm by changing an intersecting angle between the two beams (intersecting angle α).

The composition LC-1 was applied onto the alignment film P-2 by the same method as that of Example 1 to form a composition layer. The application was carried out using a spin coater at 1,500 rpm. The support having the composition layer was heated on a hot plate at 90° C. for 1 minute. Subsequently, without using a mask, the coating film was irradiated with ultraviolet light having a wavelength of 365 nm at an irradiation amount of 300 mJ/cm² using a 365 nm LED UV exposure machine at 90° C. in a nitrogen atmosphere. As a result, the alignment of the liquid crystal compound was immobilized, and an optically-anisotropic layer was formed.

Subsequently, the optically-anisotropic layer was cut out and peeled off from the glass substrate, and the optically-anisotropic layer was disposed on the incidence side and the emission side of the surface of the light guide plate such that the diffraction efficiency distribution shown in FIG. 23 was obtained (see FIG. 24). In FIG. 23, the reference numeral 241 represents a region where the optically-anisotropic layer was cut out and disposed. The reference numeral 242 represents a region where the optically-anisotropic layer was cut out and disposed. The optically-anisotropic layer was not disposed at the reference numeral 243, and the optically-anisotropic layers corresponding to the reference numeral 241 and the reference numeral 242 were not continuous. That is, the optically-anisotropic layer on the incidence side and the optically-anisotropic layer on the emission side were not continuous as shown in FIG. 24.

Subsequently, the brightness uniformity and the image clearness were evaluated by the same method as in Example 1. The brightness of the display image was non-uniform in a plane, and the image was also unclear.

The present invention is suitably applicable to various uses in which light is reflected in an optical device, for example, a diffraction element which causes light to be incident into a light guide plate of AR glasses or emits light to the light guide plate.

### EXPLANATION OF REFERENCES

10, 12: liquid crystal diffraction element
16: liquid crystal diffraction layer
18: cholesteric liquid crystal layer
20: support
24: alignment film
30: liquid crystal compound
30A: optical axis
40: display (image display device)
42: bright portion
44: dark portion
45: light guide element
45a: region A
45b: non-diffraction region
45c: region B
45d: region C
50: AR display device
60: exposure device
62: laser
64: light source
68: beam splitter
70A, 70B: mirror
72A, 72B: λ/4 plate
100: linear polarizer
102: λ/4 plate
104: light screen
104a: pinhole
110: dove prism
112: linear polarizer
114: λ/4 plate
144: light guide plate
316, 318: region
320: support
322: alignment film
324: coating film
326: first region
328: second region
329: photo mask
400, 450: optically-anisotropic layer
400a: first optically-anisotropic layer
400b: second optically-anisotropic layer
410a, 420a: region A
410b, 420b: non-diffraction region
410c, 420c: region B
500: laminate
M: laser light
MA, MB: ray
P_{O}: linearly polarized light
P_{R}: dextrorotatory circularly polarized light
P_{L}: levorotatory circularly polarized light
α: intersecting angle
L₁, L₄: incidence ray
L₂, L₅: transmitted ray
R_{R}: dextrorotatory circularly polarized red light
I₀ to I₃: light propagated in light guide plate
P₁ to P₄: position
R₁ to R₄: light

What is claimed is:

1. An optically-anisotropic layer formed of a composition containing a liquid crystal compound, the optically-anisotropic layer comprising:
a region A having a liquid crystal alignment pattern in which an orientation of an optical axis derived from the liquid crystal compound changes while continuously rotating in at least one in-plane direction;
a region B having a liquid crystal alignment pattern in which an orientation of an optical axis derived from the liquid crystal compound changes while continuously rotating in at least one in-plane direction; and
a region not having the liquid crystal alignment pattern,
wherein the region A, the region B, and the region not having the liquid crystal alignment pattern are provided in the same in-plane direction of the optically-anisotropic layer.

2. The optically-anisotropic layer according to claim 1, further comprising:
a region C having a liquid crystal alignment pattern in which an orientation of an optical axis derived from the liquid crystal compound changes while continuously rotating in at least one in-plane direction,
wherein the region C is also provided in the same in-plane direction of the optically-anisotropic layer.

3. The optically-anisotropic layer according to claim 1,
wherein the region not having the liquid crystal alignment pattern is provided between the region A having the liquid crystal alignment pattern and the region B having the liquid crystal alignment pattern, in the same in-plane direction of the optically-anisotropic layer.

4. The optically-anisotropic layer according to claim 1,
wherein at least one region of the region A or the region B has a region in which a diffraction efficiency varies in the in-plane direction.

5. The optically-anisotropic layer according to claim 4,
wherein at least one region of the region A or the region B has a region in which a diffraction efficiency gradually increases in the in-plane direction.

6. The optically-anisotropic layer according to claim 1,
wherein a rotation direction of the optical axis derived from the liquid crystal compound in the one direction of the liquid crystal alignment pattern in the region A is different from a rotation direction of the optical axis derived from the liquid crystal compound in the one direction of the liquid crystal alignment pattern in the region B.

7. The optically-anisotropic layer according to claim 1,
wherein the one direction of the liquid crystal alignment pattern in the region A is different from the one direction of the liquid crystal alignment pattern in the region B.

8. The optically-anisotropic layer according to claim 1,
wherein a length over which the orientation of the optical axis derived from the liquid crystal compound rotates by 180° in a plane of the liquid crystal alignment pattern in the region A is different from a length over which the orientation of the optical axis derived from the liquid crystal compound rotates by 180° in a plane of the liquid crystal alignment pattern in the region B.

9. The optically-anisotropic layer according to claim 1,
wherein at least one region of the region A or the region B is a cholesteric liquid crystal layer in which the liquid crystal compound is cholesterically aligned.

10. The optically-anisotropic layer according to claim 9,
wherein the region A and the region B are the cholesteric liquid crystal layer, and
a region in which a length of a helical pitch of the cholesteric liquid crystal layer in the region A is different from a length of a helical pitch of the cholesteric liquid crystal layer in the region B is provided.

11. The optically-anisotropic layer according to claim 9,
wherein the region A and the region B are the cholesteric liquid crystal layer, and
a helical turning direction of a cholesteric alignment in the region A is different from a helical turning direction of a cholesteric alignment in the region B.

12. The optically-anisotropic layer according to claim 9,
wherein, in at least one region of the region A or the region B, a region in which a length of a helical pitch of the cholesteric liquid crystal layer varies in the in-plane direction of the region is provided.

13. The optically-anisotropic layer according to claim 9,
wherein, in at least one region of the region A or the region B, a region in which a length of a helical pitch of the cholesteric liquid crystal layer changes in a thickness direction of the optically-anisotropic layer is provided.

14. The optically-anisotropic layer according to claim 1,
wherein at least a part in a plane of the region not having the liquid crystal alignment pattern is optically isotropic.

15. The optically-anisotropic layer according to claim 1,
wherein, in at least a part in a plane of the region not having the liquid crystal alignment pattern, the liquid crystal compound is aligned in one direction in the same plane.

16. The optically-anisotropic layer according to claim 1,
wherein at least a part in a plane of the region not having the liquid crystal alignment pattern is a retardation plate in which the liquid crystal compound is uniaxially aligned or twistedly aligned.

17. The optically-anisotropic layer according to claim 1,
wherein an entire layer is smooth and has no uneven structure.

18. The optically-anisotropic layer according to claim 4,
wherein, in at least one region of the region A or the region B, a region in which the diffraction efficiency varies due to a different thickness-direction retardation Rth in the in-plane direction.

19. A laminate comprising:
two or more of the optically-anisotropic layers according to claim 1.

20. The laminate according to claim 19,
wherein the laminate includes two optically-anisotropic layers of a first optically-anisotropic layer and a second optically-anisotropic layer, and
the first optically-anisotropic layer and the second optically-anisotropic layer are disposed such that
the region A of the first optically-anisotropic layer and the region A of the second optically-anisotropic layer overlap with each other,
the region not having the liquid crystal alignment pattern of the first optically-anisotropic layer and the region not having the liquid crystal alignment pattern of the second optically-anisotropic layer overlap with each other, and
the region B of the first optically-anisotropic layer and the region B of the second optically-anisotropic layer overlap with each other.

21. The laminate according to claim 20,
wherein the laminate satisfies at least one of
a requirement that a length of a single period in the region A of the first optically-anisotropic layer, over which the orientation of the optical axis derived from the liquid crystal compound rotates 180° in a plane, is different from a length of a single period in the region A of the second optically-anisotropic layer, or
a requirement that a length of a single period in the region B of the first optically-anisotropic layer, over which the orientation of the optical axis derived from the liquid crystal compound rotates 180° in a plane, is different from a length of a single period in the region B of the second optically-anisotropic layer.

22. The laminate according to claim 20,
wherein the laminate satisfies at least one of
a requirement that the one direction of the liquid crystal alignment pattern in the region A of the first optically-anisotropic layer is different from the one direction of the liquid crystal alignment pattern in the region A of the second optically-anisotropic layer, or
a requirement that the one direction of the liquid crystal alignment pattern in the region B of the first optically-anisotropic layer is different from the one direction of the liquid crystal alignment pattern in the region B of the second optically-anisotropic layer.

23. The laminate according to claim 20,
wherein the laminate satisfies at least one of
a requirement that the region A of the first optically-anisotropic layer and the region A of the second optically-anisotropic layer are cholesteric liquid crystal layers, and a length of a helical pitch of the cholesteric liquid crystal layer in the region A of the first optically-anisotropic layer is different from a length of a helical pitch of the cholesteric liquid crystal layer in the region A of the second optically-anisotropic layer, or
a requirement that the region B of the first optically-anisotropic layer and the region B of the second optically-anisotropic layer are cholesteric liquid crystal layers, and a length of a helical pitch of the cholesteric liquid crystal layer in the region B of the first optically-anisotropic layer is different from a length of a helical pitch of the cholesteric liquid crystal layer in the region B of the second optically-anisotropic layer.

24. The laminate according to claim 20,
wherein the laminate satisfies at least one of
a requirement that the region A of the first optically-anisotropic layer and the region A of the second optically-anisotropic layer are cholesteric liquid crystal layers, and a helical rotation direction of the cholesteric liquid crystal layer in the region A of the first optically-anisotropic layer is different from a helical rotation direction of the cholesteric liquid crystal layer in the region A of the second optically-anisotropic layer, or
a requirement that the region B of the first optically-anisotropic layer and the region B of the second optically-anisotropic layer are cholesteric liquid crystal layers, and a helical rotation direction of the cholesteric liquid crystal layer in the region B of the first optically-anisotropic layer is different from a helical rotation direction of the cholesteric liquid crystal layer in the region B of the second optically-anisotropic layer.

25. A light guide element comprising:
a light guide plate; and
the optically-anisotropic layer according to claim 1, which is disposed on a surface of the light guide plate.

26. The light guide element according to claim 25, further comprising:
a retardation layer.

27. An AR display device comprising:
the light guide element according to claim 25; and
an image display device.

28. The AR display device according to claim 27,
wherein emitted light of the image display device is polarized light.

29. The AR display device according to claim 27,
wherein the image display device is a laser beam scanning type image display device.
